(19) United States
(12) Patent Application Publication
(10) Pub. No.: US 2025/0312652 A1
(43) Pub. Date: Oct. 9, 2025

(54) DEVICES, SYSTEMS, AND METHODS FOR EXERCISE RECOMMENDATIONS

(71) Applicant: iFIT Inc., Logan, UT (US)

(72) Inventors: Chase Brammer, Providence, UT (US); Trevor Dylan Facer, Logan, UT (US)

(21) Appl. No.: 19/090,137

(22) Filed: Mar. 25, 2025

Related U.S. Application Data
(60) Provisional application No. 63/631,279, filed on Apr. 8, 2024.

(51) Int. Cl. A63B 24/00

(52) U.S. Cl. CPC A63B 24/0075; A63B 24/0059; A63B 24/0087

(57) ABSTRACT

Foundation models may be trained or fine-tuned to produce exercise recommendations for a user based on a user input and user exercise information. The foundation models of the present disclosure may be applied to perform many exercise tasks, including generating natural language summaries of exercise programs, natural language stories of the user, generate fitness programs, and prepare emotional responses to emotional input.

### CROSS REFERENCE TO RELATED APPLICATIONS

The present Application for patent claims the benefit of U.S. Provisional Patent Application No. 63/631,279 by BRAMMER et. al., entitled “DEVICES, SYSTEMS, AND METHODS FOR EXERCISE RECOMMENDATIONS,” filed Apr. 8, 2024, which is assigned to the assignee hereof, and which is expressly incorporated by reference in its entirety herein.

### BACKGROUND

Recent years have seen significant advancements and improvements in machine learning, natural language processing, and foundation models (such as large language models (LLMs)). Foundation models are trained on massively large datasets to provide correlations between various datapoints within the dataset. But the size of conventional foundation models may result in outputs that are irrelevant, inaccurate, and may present, as facts, information that is not true and/or not supported by the underlying training dataset (e.g., hallucinations). Such results limit the effectiveness of conventional foundation models.

Foundation models may be fine-tuned to improve the accuracy and/or relevance of particular results. Fine-tuning involves adapting a pre-existing foundation model for a particular task or use case. For example, fine-tuning may involve providing input particular to a subject matter and adjusting one or more parameters of the foundation model. Fine-tuning a model may be a form of training the model on focused material. In some situations, a training and/or fine-tuning dataset may include limited information about a particular topic or subject matter. The foundation model trained with such limited subject matter may not generate accurate and/or relevant results to inputs related to the subject matter.

These along with additional problems and issues exist with regard to conventional exercise foundation model and recommendation systems.

### BRIEF SUMMARY

In some aspects, the techniques described herein relate to a method. A foundation model receives an exercise program. The exercise program includes a control layer including a plurality of exercise device controls configured to adjust at least one operating parameter of an exercise device. The foundation model prepares text descriptions of the plurality of exercise device controls. The foundation model generates a prompt to prepare a natural language description of the exercise program based on the text descriptions. The foundation model inputs the prompt into an exercise summary large language model (LLM) to prepare a natural language summary of the exercise program.

In some aspects, the techniques described herein relate to a method for generating exercise rewards. An exercise reward system generates an exercise recommendation prompt based on exercise information for a user. The exercise reward system provides the exercise recommendation prompt as an input to a recommendation LLM to generate an exercise recommendation. The exercise reward system generates a user preference prompt based on user preference information for the user. The exercise reward system provides the user preference prompt as an input to a user preference LLM to generate a user preference profile. The exercise reward system generates a reward for the user based on the user preference profile and the exercise recommendation.

In some aspects, the techniques described herein relate to a method for training an exercise model. An exercise information system receives exercise information. The exercise information includes text information related to an exercise activity. The exercise information system generates a plurality of text information sets from the text information. The exercise information system applies a detextualization model to the plurality of text information sets. The detextualization model generates a plurality of question-and-answer pairs associated with the exercise information. The exercise information system trains the exercise model by inputting the plurality of question-and-answer pairs into the exercise model.

In some aspects, the techniques described herein relate to a method for generating a fitness program. A fitness program generator retrieves exercise information for a user. The fitness program generator, based on a user goal and the exercise information, generates a first prompt for a first fitness program model. The fitness program generator inputs the first prompt to the first fitness program model to generate a first level of the fitness program. The first level covers a first period of time. Based on the user goal, the exercise information, and the first level of the fitness program, the fitness program generator generates a second prompt for a second fitness program model. The fitness program inputs the second prompt to the second fitness program model to generate a second level of the fitness program. The second level covers a second period of time. The second period of time at least partially overlaps the first period of time.

In some aspects, the techniques described herein relate to a method. A prompt generator generates a story prompt based on user exercise information for a user. The user exercise information includes structured data and unstructured data. The prompt generator provides the story prompt as input to a story LLM. The story LLM generates a natural language story. The natural language story includes the structured data and the unstructured data. A second prompt generator generates a recommendation prompt based on the natural language story. The prompt generator provides the recommendation prompt as input to a recommendation model to generate an exercise recommendation.

In some aspects, the techniques described herein relate to a method for generating an exercise recommendation. An agent router receives an input for the exercise recommendation. The agent router vectorizes the input to a vectorized input. The agent router searches a vector space including vectorized representations of a plurality of exercise agents for a closest match to the vectorized input. The agent router selects an exercise agent based on the closest match. The agent router provides the input to the exercise agent to generate the exercise recommendation.

In some aspects, the techniques described herein relate to a method. An emotional response agent receives a text input from a user. The text input is related to exercise information of the user. The emotional response agent identifies emotional content in the text input. The emotional content includes an input emotion. The emotional response agent generates an emotional response to the emotional content and the exercise information. The emotional response is based on complementary emotions of the input emotion and an output emotion. The output emotion is based on the exercise information for the user. The emotional response agent presents the emotional response to the user.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a representation of an exercise system, according to at least one embodiment of the present disclosure.

FIG. 2 is a representation of an exercise program description system, according to at least one embodiment of the present disclosure.

FIG. 3 is a representation of an exercise program description system, according to at least one embodiment of the present disclosure.

FIG. 4 is a representation of a fitness reward system, according to at least one embodiment of the present disclosure.

FIG. 5 is a representation of a fitness reward system, according to at least one embodiment of the present disclosure.

FIG. 6 is a representation of a fitness reward system, according to at least one embodiment of the present disclosure.

FIG. 7 is a representation of string diagram of a fitness reward system, according to at least one embodiment of the present disclosure.

FIG. 8 is a representation of a string diagram of a fitness reward system, according to at least one embodiment of the present disclosure.

FIG. 9 is a representation of a string diagram of a fitness reward system, according to at least one embodiment of the present disclosure.

FIG. 10 is a representation of an exercise information system including techniques to train a foundation model, according to at least one embodiment of the present disclosure.

FIG. 11 is a representation of an exercise information system, according to at least one embodiment of the present disclosure.

FIG. 12 is a representation of a string diagram of an exercise information system, according to at least one embodiment of the present disclosure.

FIG. 13 is a representation of a fitness program generator, according to at least one embodiment of the present disclosure.

FIG. 14 is a representation of a fitness program generator, according to at least one embodiment of the present disclosure.

FIG. 15 is a representation of a fitness program generator, according to at least one embodiment of the present disclosure.

FIG. 16 is a representation of a fitness program generator, according to at least one embodiment of the present disclosure.

FIG. 17 is a representation of a fitness program generator, according to at least one embodiment of the present disclosure.

FIG. 18 is a representation of a user story generator, according to at least one embodiment of the present disclosure.

FIG. 19 is a representation of a user story generator, according to at least one embodiment of the present disclosure.

FIG. 20 is a representation of a fitness agent router, according to at least one embodiment of the present disclosure.

FIG. 21 is a representation of an agent selection system, according to at least one embodiment of the present disclosure.

FIG. 22 is a representation of an emotional response agent, according to at least one embodiment of the present disclosure.

FIG. 23 is a representation of emotional response system, according to at least one embodiment of the present disclosure.

FIG. 24 is a flowchart of a method for generating a natural language summary of an exercise program, according to at least one embodiment of the present disclosure.

FIG. 25 is a flowchart of a method for generating a customized reward for a user, according to at least one embodiment of the present disclosure.

FIG. 26 is a flowchart of a method for training a foundation model, according to at least one embodiment of the present disclosure.

FIG. 27 is a flowchart of a method for generating a fitness program, according to at least one embodiment of the present disclosure.

FIG. 28 is a flowchart of a method for generating a natural language story of a user, according to at least one embodiment of the present disclosure.

FIG. 29 is a flowchart of a method for selecting an exercise agent, according to at least one embodiment of the present disclosure.

FIG. 30 is a flowchart of a method for generating an emotional response in an exercise recommendation, according to at least one embodiment of the present disclosure.

FIG. 31 illustrates certain components that may be included within a computer system.

### DETAILED DESCRIPTION

This disclosure generally relates to devices, systems, and methods for utilizing one or more foundation models, to prepare improved exercise recommendations for a user. The techniques of the present disclosure receive exercise information and user interactions with an exercise system to prepare natural language summaries of various information sets, generate prompts for the foundation models, train foundation models, select appropriate foundation models, generate user incentives, and so forth. This may, in at least one embodiment, facilitate improved accuracy, relevance, and reproducibility of the results of the foundation models.

In accordance with at least one embodiment of the present disclosure, an exercise program natural language description system (also described and used herein as the “exercise program description system”) may generate a plain language description of an exercise program and/or an exercise activity. The plain language description may include a description of the various elements of the exercise program, including changes in speed, incline, flywheel resistance, weight amount, activity type, exercise equipment type, activity set count, activity repetition count, any other element of an exercise program, and combinations thereof. In some embodiments, the plain language description may integrate portions of an audiovisual program associated and/or synchronized with the exercise program. In some embodiments, the plain language description may integrate qualitative descriptions of the exercise program.

In some embodiments, the exercise program description system may prepare a text description of each portion of the exercise program. For example, the text descriptions may be prepared based on a pre-determined formula, such as “at time [t], the [feature] changes from [state 1] to [state 2],” with the bracketed elements being pulled from the control stream of the exercise program. The exercise program description system may prepare a prompt for an exercise summary large language model (LLM) to prepare the natural language description. The exercise summary LLM may prepare the natural language description, generating a paragraph description of the exercise program. The natural language description may be used for various text input and analysis. For example, the natural language description may be used to train other foundation models or inputted into text or vector search algorithms. In this manner, and in accordance with at least one embodiment of the present disclosure, the natural language description may facilitate improved indexing, searching, and selection processes of one or more natural language models.

In accordance with at least one embodiment of the present disclosure, a fitness reward system may generate personalized rewards for a user based, at least in part, on user information. Users often desire a reward system to encourage or motivate the user to perform additional exercise activities. Rewards may take any form, such as messages, achievements, virtual currency, a skin for a virtual avatar, clothing, exercise equipment, exercise accessories, financial discounts (e.g., shopping discounts, subscription discounts), digital environment features (e.g., avatars, skins, stickers, videos, soundtracks), limited-access programming, exclusive programming, contact with one or more trainers, contact with one or more other athletes, any other reward, and combinations thereof. In some embodiments, the rewards may be unique and/or tailored to the user. For example, a user preference LLM may receive user preference information in a user preference prompt. The user preference LLM may be trained to generate a user preference profile that identifies user preferences and motivations. A reward model may utilize the user preference profile to generate a reward that is tailored for the user. In some embodiments, the reward may be unique to the user. Generating a reward for the user in this manner may, in accordance with at least one embodiment, improve the accuracy and/or representativeness of the reward for the user, thereby improving user engagement and utilization of an exercise or fitness program or schedule.

In accordance with at least one embodiment of the present disclosure, an exercise information system may utilize question-and-answer sets generated from text-based exercise information to train an exercise model (e.g., an exercise LLM). For example, the text information from the exercise information may be inputted into a detextualization model. The detextualization model may generate multiple question-and-answer pairs from the text information. The question-and-answer pairs may be generated with natural language or may be generated to simulate the questions a user may ask about the subject matter of the text information. In some embodiments, the question-and-answer pairs may be directed to the same facts or information from the text information while asked and/or answered using different language or syntax. The question-and-answer pairs may be used to train the exercise model. In accordance with at least one embodiment, training the model in this manner, may improve the responsiveness and/or representativeness of the exercise model to user input related to the exercise information.

In accordance with at least one embodiment of the present disclosure, a fitness program generator may generate a customized fitness program for a user. The fitness program may be a representation of multiple distinct exercise activities performed over an extended period of time. For example, the fitness program may be a representation of exercise activities to be performed on particular days over multiple days, weeks, months, or years. The fitness program may be generated based, at least in part, on a specific user goal. For example, the fitness program may be generated to facilitate the user achieving a particular exercise target, such as a distance for an endurance race, a strength goal, a weight loss goal, a VO2 max goal, a resting heart rate goal, any other goal, and combinations thereof.

The fitness program generator may include multiple agents or LLM models. Each agent may be optimized to a particular task. For example, a first agent may be optimized to generate an overall strategic schedule that outlines the overall structure of the fitness program over a time period. A second agent may be optimized to generate a weekly exercise program schedule that outlines the structure of exercises for a week based on the overall strategic schedule. A third agent may be optimized to generate specific exercise programs based on the weekly schedule. The fitness program may generate a prompt specific to each agent and input the prompt to the agents. In accordance with at least one embodiment, utilizing multiple agents may improve the accuracy and/or relevance of the resulting fitness program, including the associated exercise programs that make up the fitness program.

In accordance with at least one embodiment of the present disclosure, a user story generator may generate a natural language story of the user using user information. For example, a prompt generator may generate a prompt for a story LLM. The prompt may include structured and unstructured data, including user exercise information, demographic information, and so forth. The prompt may be input to the story LLM, and the story LLM may generate the natural language story for the user. The natural language story may then be used as input for other LLMs. In this manner, and in accordance with at least one embodiment, the natural language story may facilitate increased accuracy and/or relevance of any resulting outputs from the relevant LLMs.

In accordance with at least one embodiment of the present disclosure, an agent router may receive input for an exercise recommendation and route the input to the most relevant agent. The input may include any type of input. For example, the input may include a request from a user, an output from an LLM, a prompt generated from an LLM, any other input, and combinations thereof. The agent router may vectorize the input and search a vector space based on the vectorized input. The vector space may include vectorized representations of multiple agents. The agent router may identify a closest match of the search. The agent router may select the agent having the closest match and route the input to the selected agent. In this manner, and in accordance with at least one embodiment, the agent router may route the input to the most relevant agent, thereby improving the accuracy and/or relevance of the response to the input.

One or more embodiments of the present disclosure provide benefits and/or solve one or more of the foregoing or other problems in the art with systems, non-transitory computer-readable media, and methods for foundation models related to exercise systems. For example, foundation models are trained on text-based and/or unstructured data. Indeed, structured data, tables, lists, and so forth may not be easily and/or accurately processed by a foundation model. One or more techniques of the present disclosure may be utilized to transform structured exercise information to a natural language description of the exercise information. This may facilitate improved training, fine-tuning, indexing, searching, and processing of the natural language descriptions by one or more foundation models, thereby, in one or more embodiments, improving the accuracy and/or relevance of foundation model outputs.

In some examples, in accordance with one or more embodiments, generating natural language summaries of users and/or exercise programs may reduce a size of the stored natural language documents. For example, a natural language summary of a user profile that summarizes structured exercise data with unstructured goal and demographic information may be a smaller input to a foundation model than both the structured data and the unstructured data. Further, a natural language summary of an exercise program may be smaller and easier to search than the entire exercise program and associated metadata. In this manner, and in accordance with one or more embodiments, natural language summaries may reduce the data and searching resources used in conjunction with foundation model processing.

In some examples, foundation models of one or more embodiments of the present disclosure may be fine-tuned to generate more accurate and/or relevant exercise rewards that are tailored to a user. Such rewards may be based, at least in part, on a user profile generated by a foundation model. The foundation model may receive a prompt to generate the user profile, and generate the user profile to include user preferences, motivations, reward-cycle mechanisms, and so forth. The resulting profile may improve the speed and/or relevance of generating the rewards for the user. In this manner, and in accordance with one or more embodiments, the relevance of the output of the foundation model may be increased, thereby improving operation of the foundation model.

In some examples, one or more embodiments of the present disclosure may be used to finetune a foundation model. A training document may include text information that is separated into information subsets. The information subsets may be used to generate detextualized question-and-answer pairs related to the subject matter. The question-and-answer pairs may include overlapping subject matter that is phrased with different language and/or syntax. This may increase the number of datapoints used to fine-tune the model based, at least in part, on the same input text information. In accordance with one or more embodiments, fine-tuning the foundation model in this manner may facilitate improved accuracy and/or relevance of the resulting outputs.

In accordance with at least one embodiment of the present disclosure, an emotional response agent may provide emotionally responsive interactions with the user. For example, the emotional response agent may identify emotions or sentiment in a user input. The emotional response agent may further incorporate user profile information, such as user preference information. Based on the emotions or sentiment within the user input, the emotional response agent may identify an emotional response to the user input. The emotional response may induce an emotional response to the user based on the input emotions. The emotional response may include exercise information. For example, the emotional response may include one or more exercise activities that may be responsive to the input emotion. In this manner, emotional response agent may provide exercise recommendations that have improved accuracy and improved relevance to the user input.

As illustrated by the foregoing discussion, the present disclosure utilizes a variety of terms to describe features and advantages of the exercise recommendation system. Additional detail is now provided regarding the meaning of such terms. For example, as used herein, the term “exercise information” (e.g., health information) refers to information related to health and/or exercise. In particular, the term exercise information may include information related to one or more exercise activities (e.g., workouts). For example, exercise information may include information related to the performance of the exercise activity, such as fitness assessment information, exercise activity type, exercise activity day (e.g., date, day of the week), exercise activity time of day, exercise device used, exercise device operating parameters (e.g., resistance, speed, incline level, weight setting), location of exercise device, exercise program duration, training plan information, any other information related to the performance of the exercise activity, and combinations thereof. In some embodiments, exercise information includes user exercise information. For example, the exercise information may include heartrate information, electrocardiogram (EKG) information, blood sugar information, blood oxygen information, any other user exercise information, and combinations thereof. In some embodiments, exercise information includes user lifestyle or habit information. For example, user lifestyle or habit information may include sleep information (e.g., duration, time, quality), diet and nutrition information (e.g., food eaten, supplements taken, time of meals), work details, any other user lifestyle or habit information, goal information, and combinations thereof. In some embodiments, exercise information includes qualitative user exercise information. For example, qualitative user exercise information may include stress levels, pain levels, fatigue levels, attitude levels, motivation levels, any other qualitative user exercise information, and combinations thereof.

As used herein, a “foundation model” refers to an artificial intelligence (AI) or machine learning (ML) model that is trained to generate an output in response to an input based on a large dataset. The present disclosure may interchangeably refer to foundation models as AI models or ML models. A foundation model may be formed using a neural network having a significant number of parameters (e.g., billions of parameters). The foundation model may utilize the parameters to perform a task or otherwise generate an output based on an input. In one or more embodiments described herein, a foundation model is trained to generate a response to a query. In some implementations, a foundation model refers to an LLM. The foundation model be trained in any manner. For example, the foundation model may be trained on pattern recognition and text prediction. For example, the foundation model may be trained to predict the next word of a particular sentence or phrase. In one or more implementations described herein, the foundation model refers specifically to an LLM, though other types of foundation models may be used in generating responses to input queries.

The foundation models of the present disclosure may utilize one or more mechanisms to incorporate information that is external to the training dataset used to train the associated model. For example, the foundation models of the present disclosure may utilize retrieval augmentation generation (RAG) to incorporate external knowledge sources. RAG may provide a way for a foundation model to incorporate new information without extensive retraining of the foundation model. The RAG may include an external database. When a query or prompt is received, the foundation model may retrieve associated information. In some embodiments, the associated information may be identified by context in the prompt to the foundation model. In some embodiments, when the information is retrieved, the foundation model may augment the information using the foundation model's processes. This may help to ensure that the foundation model does not solely rely on the knowledge from the training database. In some embodiments, the foundation model may generate the resulting output based on the foundation, resulting a more reliable, contextually appropriate, and trustworthy response.

As used herein, a chatbot may be a foundation model or an ML model that is trained in natural language algorithms to provide queries to a user and receive responses to the queries. The chatbot may be trained in natural language algorithms that may simulate a human interaction. For example, the chatbot may be trained to generate and present a query using syntax, verbs, nouns, and other grammatical elements to provide information and request information as a human being would. The chatbot may be trained to collect information based on an input dataset, such as the exercise information discussed herein. In some embodiments, the chatbot analyzes the input dataset, identify initial patterns in the input dataset, and request additional information to complete the pattern analysis. In some embodiments, the chatbot receives the pattern analysis from a different ML model, such as an exercise analysis model, health habit model, or other ML model. The chatbot may be interactive. For example, the chatbot may be trained to analyze the received response and generate additional content to provide the user. Such content may include recommendations, additional queries, motivational information, any other content, and combinations thereof.

As used herein, an agent of a foundation model may be a particular implementation of a foundation model trained and fine-tuned to perform a particular task. For example, an agent may receive prompts or queries and generate responses based on the specific fine-tuning of the agent. Utilizing an agent may facilitate improved accuracy and/or relevance of responses from a general foundation model Agents may be trained to perform any particular task. For example, and in accordance with one or more embodiments of the present disclosure, agents may be trained to generate prompts, generate user-specific rewards, create natural language summaries of users, create natural language summaries of exercise programs, create exercise programs, create fitness programs, create schedules of exercise programs and/or fitness programs, create question-and-answer sets, generate health and/or exercise recommendations, perform any other task, and combinations thereof.

As used herein, a recommendation model may refer to a foundation model that is trained to generate health or exercise recommendations based on an input dataset. The input dataset may include exercise information and/or historical exercise information. Historical exercise information may include any exercise information previously collected. In some embodiments, historical exercise information includes exercise information related to exercise activities prior to the most recent exercise activities. In some embodiments, historical exercise information includes daily exercise information for a period of time (e.g., one day, one week, one month, one year, multiple years). The recommendation model may be trained on a recommendation training dataset. The recommendation training dataset may include exercise information from people that exhibit positive exercise habits and/or have met previously set exercise goals or health habit goals. The recommendation model may receive the exercise information for a user and compare the user's exercise information, exercise goals, and health habit goals to the patterns identified by the recommendation model. The recommendation model may provide behavioral changes for the user to implement to meet his or her goals.

As used herein, an exercise recommendation may be used to refer to any recommendation to improve a user's health, including a recommendation to improve health habits and/or exercise consistency. For example, the exercise recommendation may include a change in behavior that may be associated with a user's health habits. In some examples, the exercise recommendation may include a change in environment. In some examples, the exercise recommendation may include any change in time of day for exercise, a change in exercise activity duration, a change in exercise activity intensity, a change in trainer, a change in exercise activity location, any other change in behavior or environment, and combinations thereof.

In some embodiments, the exercise recommendation is an informational recommendation and/or a motivational recommendation. For example, the exercise recommendation may include environmental information, habit stacking, a reward cycle, educational material, a diet and nutrition recommendation, any other information, motivational messages, and combinations thereof. The motivational recommendation may be any type of motivation for a user, such as an exercise program type, a fitness goal, a motivational message, a reward, an incentive, any other motivational recommendation, and combinations thereof. The environmental information may include any type of environmental information, such as locations for exercise, exercise apparel, people to exercise with, music type, music playlists, trainer ID, any other environmental information, and combinations thereof. In some examples, the educational material may include process-oriented education (e.g., changes in a series of activities leading to and/or during an exercise activity). In some examples, the educational material may include consistency education.

As used herein, an exercise program may be a representation of an exercise activity that a user is to perform. The exercise activity may be any type of exercise activity. For example, the exercise activity may be performed in conjunction with exercise equipment. In some examples, the exercise activity may be performed without exercise equipment, such as a body-weight exercise, yoga, running, plyometrics, calisthenics, and so forth. The exercise program may include instructions to perform the exercise activity. The instructions may be any type of instructions. For example, the instructions may include instructions to adjust one or more settings of an exercise device for a period of time. The instructions to adjust the settings of the exercise device may be stored on a control layer having a plurality of exercise device controls. The control layer may be separate from any audiovisual layers in the exercise program. In some examples, the instructions may include instructions, or exercise device controls, to perform the activity without an exercise device, such as number of repetitions, number of sets, distance, speed, route, positions, exercises, any other instructions, and combinations thereof. The control layer may include any number or type of exercise device controls, including exercise device controls related to speed, resistance, incline, and so forth. The exercise device controls may be executable by the exercise device to adjust operation of the exercise device. The exercise program may include audio and/or video information. For example, the exercise program may include audio and/or video of a trainer performing the exercise activity, verbal, video, or pictorial instructional information, music, third-party media (e.g., movies, television shows, streaming audio and/or visual media), any other audio and/or video information, and combinations thereof. The exercise program may synchronize the audio and/or video information with the exercise instructions. In some embodiments, the exercise program may include any combination of settings, exercise devices, exercise activities, and so forth, for any duration of time.

As used herein, a fitness program may be a combination of exercise programs scheduled to be performed at different times and/or different days. For example, a fitness program may include a different exercise program to be performed on different days, different exercise programs to be performed on the same day, the same exercise program to be performed on different days, the same exercise program to be performed multiple times on the same day, and combinations thereof. In some examples, a fitness program may be directed toward a particular fitness goal. The fitness goal may be any fitness goal. For example, the fitness goal may be performance-based, such as performing to a particular performance standard (e.g., speed, time, pace, weight), participating in a particular event (e.g., a race, competition, travel), performing a particular feat (e.g., hiking a mountain, biking a particular route, swimming an open-water swim, yoga poses), any other performance standard, and combinations thereof. In some examples, the fitness goal may be image or body based, such as a clothing size goal, a body-part size goal, muscle definition goal, fat loss goal, fat distribution goal, any other personal image or body-based goal, and combinations thereof. In some examples, the fitness goal may be a physiological goal, such as a particular VO2 max, resting heartrate, blood cholesterol level, blood sugar levels, other blood chemistry, a weight loss goal, a weight gain goal, any other physiological goal, and combinations thereof. The fitness program may include any other health and fitness information. For example, the fitness program may include dietary information, stretching information, meditation information, wellness information, mindfulness information, any other health and fitness information, and combinations thereof.

As used herein, fine-tuning a foundation model may be a process of training a pre-existing model to perform a specific task. In the context of a foundation model, fine-tuning may include training the foundation model based on particular language processing tasks. Examples of fine-tuning include sentiment analysis, question answering, text classification, and so forth. Fine-tuning may include multiple steps or actions. For example, fine-tuning may include pre-training. Pre-training is typically performed by a large company, resulting in generic foundation model that may be utilized by multiple groups or in multiple situations. However, it should be understood that any company may pre-train a foundation model. Fine-tuning may be based on task-specific information, such as subject-matter specific information, labeled information, pre-categorized information, and so forth. The pre-trained model may then be fine-tuned by inputting the task-specific information. The foundation model may adjust the weights of the various parameters.

As used herein, a “prompt” is an input to a foundation model to achieve a requested outcome. A prompt may include a request for information, a request for analysis, context information, a direction to a particular agent of a foundation model, and so forth. A prompt may be generated in any manner. For example, a prompt may be generated by a user asking a question. In some examples, a prompt may be generated by a computing system requesting information from a foundation model or an agent of a foundation model. In some examples, the foundation model identifies the context of the query using the prompt.

As used herein, vectorizing (also called text embedding) is a process that includes converting or transforming text data to numerical vectors. In natural language processing, vectorizing text may be performed to generate numerical representations of words, sentences, paragraphs, sections, chapters, or other groupings of text. The vectorized input may be stored in a vector space, which may be a storage or a database that included the vectorized input and is searchable by foundation models or other AI or ML models. Vectorizing may be applied to any input. For example, any type of text input may be vectorized, including user input, natural language summaries, the output of another foundation model, and so forth.

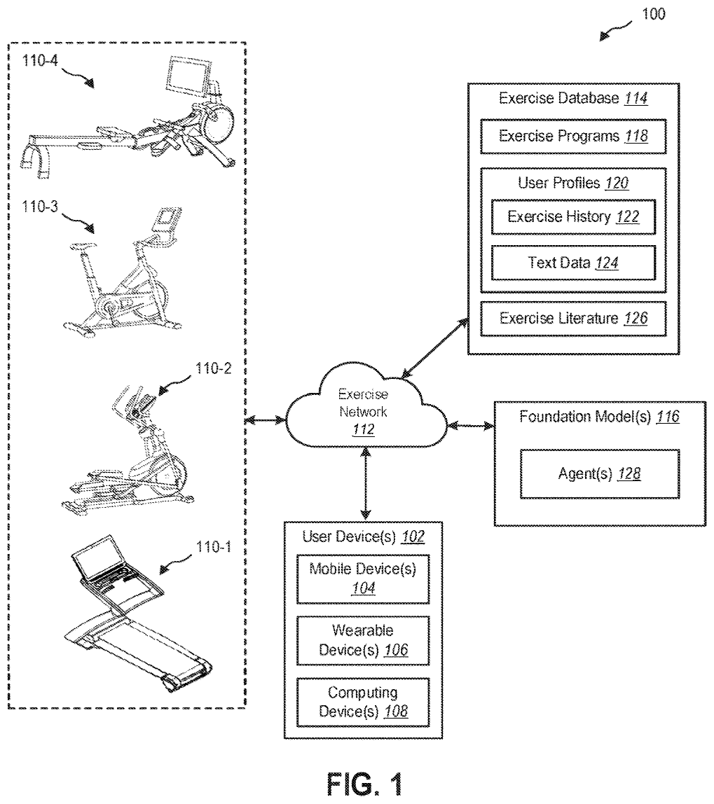

FIG. 1 is a representation of an exercise system 100, according to at least one embodiment of the present disclosure. The exercise system 100 may interact with, generate and provide exercise and health recommendations, prepare summaries of information, prepare rewards, and otherwise interact with the user based on exercise information collected by and from the user. The exercise system 100 may collect exercise and health information from the user using one or more user devices 102. The user devices 102 may include any type of user device. For example, the user devices 102 may include one or more mobile devices 104, such as mobile phones or tablets. In some examples, the user devices 102 may include one or more wearable devices 106. The wearable devices 106 may be any type of wearable device, such as a smartwatch, a smart ring, a sleep monitor, a heartrate monitor, any other type of wearable device 106, and combinations thereof. In some examples, the user devices 102 may include a computing device 108, such as a laptop computer, a desktop computer, a server computer, any other computing device 108, and combinations thereof. In some embodiments, the user devices 102 include any other type of device, such as medical devices, GPS trackers, pedometers, any other user devices 102, and combinations thereof.

In some embodiments, the exercise system 100 collects exercise and health information from one or more exercise devices (collectively 110). The exercise devices 110 may include any type of exercise device. For example, the exercise devices 110 may include a treadmill 110-1, elliptical machines 110-2, stationary bicycles 110-3, rowers 110-4, cable exercise devices, weight devices, any other exercise device 110, and combinations thereof. The exercise devices 110 may implement exercise programs. For example, the exercise devices 110 may include a display that displays a video and adjust one or more operating parameters of the exercise device that are synchronized with the video. In some embodiments, the exercise devices 110 integrate or include one or more user devices 102. For example, the exercise devices 110 may be in communication with the user devices 102 to receive exercise programs. In some examples, the user devices 102 may implement a portion of the exercise program, such as a display of a user device 102 providing the display for the exercise device 110.

The user devices 102 may be in communication with the exercise devices 110, an exercise database 114, and one or more foundation models 116 over an exercise network 112. The exercise network 112 may be any type of network. For example, the exercise network 112 may be a local area network (LAN), a wide area network (WAN), a Wi-Fi network, a cellular network, any other network, and combinations thereof. The exercise network 112 may include any type of connection between the various devices and elements of the exercise system 100, including Wi-Fi connections, Bluetooth connections, Zigbee protocol connections, near field communication (NFC) connections, any other type of wireless connection, and combinations thereof.

The exercise system 100 may include an exercise database 114. The exercise database 114 may include information related to various aspects of the exercise system 100. For example, the exercise database 114 may include exercise programs 118, including the audiovisual content of the exercise programs 118, control stream information of the exercise programs 118, summaries of the exercise programs 118, titles of the exercise programs 118, descriptions of the exercise programs 118, and so forth.

The exercise database 114 may further include user profiles 120 of one or more users. The user profile 120 may include any user information. For example, the user profiles 120 may include an exercise history 122 of the user. The exercise history 122 may include exercise information related to the user, including historical exercise activities performed, historical exercise activities started but not completed (e.g., completion information for the user), physiological parameters of the user, including physiological parameters related to the previously performed exercise activities (e.g., heart rate, VO2 max), any other exercise information, and combinations thereof. The user profiles 120 may further include text data 124 related to the user. The text data 124 may include any type of text data. For example, the text data 124 may include historical interactions with a chatbot, a chat history, questions asked and answered from a trainer, user goal information, demographic information for the user, user profile information, physical information, any other user information, and combinations thereof. In some embodiments, the user profiles 120 may include any other user information, including image information, exercise program rating information, correlations between exercise program ratings and exercise program features, correlations between completed exercise programs and exercise program features, friend information, social media information, marketing information, user recommendations to other users, any other user information, and combinations thereof.

The exercise database 114 may include other exercise information. For example, the exercise database 114 may include exercise literature 126. The exercise literature 126 may include information related to the performance of exercise activities or exercise programs. For example, the exercise literature 126 may include instructional information on how to perform a particular exercise activity. In some examples, the exercise literature 126 may include nutrition information. In some examples, the exercise literature 126 may include training strategies. In some examples, the exercise literature 126 may include academic literature, such as academic articles from peer-reviewed academic journals. In some examples, the exercise literature 126 may include digital representations of print publications (e.g., books, magazines). In some examples, the exercise literature 126 may include internet publications, such as blog posts (text, image, and video), websites, social media accounts, exercise schedules, trainer information, trainer identity, any other exercise literature 126, and combinations thereof.

The exercise system 100 may include one or more foundation models 116. The foundation models 116 may include any type of foundation model, LLM, AI model, ML model, or any other model discussed herein. The foundation models 116 may receive and/or retrieve information from any source. For example, the foundation models 116 may receive and/or retrieve information from the exercise database 114. In some examples, the foundation models 116 may receive and/or retrieve information from the user devices 102. In some examples, the foundation models 116 may receive and/or retrieve information from the exercise devices 110.

As discussed herein, the foundation models 116 may include one or more agents 128. The agents 128 may be fine-tuned or specialized to perform a particular function or to generate a particular output. As discussed in further detail herein, the foundation models 116 and/or agents 128 may include any type of model trained, optimized, and/or fine-tuned to perform any function. In particular, the foundation models 116 and/or agent 128 discussed herein may be trained and/or fine-tuned to provide an output related to exercise, health, and fitness. For example, at least one foundation model 116 and/or agent 128 of the present disclosure may be trained and/or fine-tuned to generate natural language descriptions of a user profile and/or exercise programs. In some examples, at least one foundation model 116 and/or agent 128 of the present disclosure may generate unique or customized rewards for the user. In some examples, at least one foundation model 116 and/or agent 128 may generate detextualized question-and-answer pairs from text information associated with exercise information, such as the exercise literature 126. In some examples, at least one foundation model 116 may generate a fitness program for the user.

Each of the components of the systems described herein can include software, hardware, or both. For example, the components can include one or more instructions stored on a computer-readable storage medium and executable by one or more processors, individually or collectively, of one or more computing devices, such as a client device or server device. When executed by the one or more processors, the computer-executable instructions of the systems described herein can cause the computing device(s) to perform the methods described herein. Alternatively, the components can include hardware, such as a special-purpose processing device to perform a certain function or group of functions. Alternatively, the components can include a combination of computer-executable instructions and hardware.

Furthermore, the components of the systems described herein may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

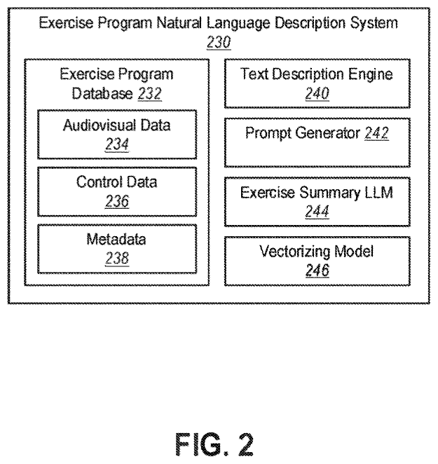

FIG. 2 is a representation of an exercise program description system 230, according to at least one embodiment of the present disclosure. The exercise program description system 230 may include an exercise program database 232. The exercise program database 232 may include a storage of one or more exercise programs. The exercise program database 232 may include audiovisual data 234. The audiovisual data 234 may be a representation of video stream of the exercise program, including the trainer video, trainer instructions, music, media, and so forth.

The exercise program database 232 may further include control data 236. The control data 236 may be located in a separate control stream from the audiovisual data 234. The control data 236 may include exercise controls for the exercise program, including adjustments to one or more operating parameters of an exercise device. Such exercise controls may include changes to a motor speed, flywheel resistance, deck incline, weight, any other operating parameter, and combinations thereof. As discussed herein, the exercise controls may be synchronized with the audiovisual data 234.

In some embodiments, the exercise program database 232 may include metadata 238. The metadata 238 may include other information associated with the exercise program. For example, the metadata 238 may include a title, a brief description, a trainer identification, an exercise type, an exercise device type, a simulated location, a simulated event, an exercise program intensity, any other exercise information, and combinations thereof.

Conventionally, an exercise program from the exercise program database 232 is selected based on the metadata 238. But such selections may not identify all the desired features that the user would like in an exercise program. In accordance with at least one embodiment of the present disclosure, the exercise program description system 230 may generate a natural language description of the exercise program. The natural language description may be accessed by one or more searching algorithms to more readily identify exercise program features desired by the user.

To generate the natural language description, a text description engine 240 may generate text descriptions of the features of the exercise program. For example, the text description engine 240 may generate text descriptions of the control data 236 and/or the metadata 238. Such descriptions may be based on a pre-determined template. The pre-determined template may generate a sentence for each change in operating parameters from the control layer. For example, the pre-determined template may take the form of “at time [t], the [feature] changes from [state 1] to [state 2].” In this pre-determined template, [t] may be a time component or representation of the time location within the exercise program of the change in the operating parameter, [feature] may be a control component or representation of the operating parameter, and [state 1] and [state 2] may be control component representations of the state from which the operating parameter may be changed and to which the operating parameter may change. The text description engine 240 may prepare a text description for each operating parameter in the control layer. In some embodiments, the text description engine 240 may prepare a text description for various portions of the metadata 238. For example, the text description engine may extract the workout metadata from the exercise program. The text descriptions may form unstructured data from structured data. Put another way, the text descriptions may be a word-based description of structured data; as discussed herein, text-based data may be more easily and accurately processed by a foundation model.

A prompt generator 242 may generate a prompt for an exercise summary LLM 244 to prepare a natural language description of an exercise program based on the information in the exercise program database 232 and the text descriptions. For example, the prompt generator 242 may generate a prompt including the metadata 238 and the text descriptions. The resulting prompt may be formed in natural language for input into the exercise summary LLM 244. The prompt may provide context for the exercise summary LLM 244, including information about the point of view of the exercise summary LLM 244 and the desired output. An exemplary, non-limiting, prompt may take the form of: “You are an expert personal trainer. You are helping a client select a workout. When telling the user about a workout, give them a summary of the control changes identified in the associated workout text descriptions and use the metadata to tell them about it.” As may be seen, the prompt may incorporate or reference the text descriptions of the control changes and the metadata to request a description of a particular workout.

The prompt may be provided as input to the exercise summary LLM 244. The exercise summary LLM 244 may then generate a natural language summary of the exercise program. The natural language summary of the exercise program may include a description of a particular workout using familiar language and references. For example, the natural language summary may include qualitative descriptions of the exercise program, such as “the exercise program starts with a moderate intensity,” “the exercise program incorporates a large hill in the middle,” or “the exercise program is well suited to your current marathon training schedule.” The qualitative descriptions may cover multiple exercise program control changes represented by the text descriptions, such as a summary of changes in incline over a period of time (e.g., “the slope of the hill gradually increases,” “the workout takes you through rolling hills”). In some embodiments, the qualitative descriptions may include a scenic description of the scene and/or background illustrated in the audiovisual data 234 of the exercise program. In some embodiments, the qualitative description includes a difficulty description. In some embodiments, the qualitative description may include a summary of user ratings. In some embodiments, the qualitative description may include a summary of user reviews (e.g., “users liked the unique challenge of this program”). In some embodiments, the qualitative description may include a trainer attitude (e.g., “the trainer is motivational,” “the trainer is tough and treats you like recruits in a boot camp”).

In accordance with at least one embodiment of the present disclosure, the exercise program description system 230 may include a vectorizing model 246. The vectorizing model 246 may vectorize the natural language description of the exercise program for storage in a vector database. The vectorizing model 246 may generate vectors, or numerical representations of one or more elements identified in the natural language description. The vectorizing model 246 may generate, based on the natural language description, vectors that are more representative of the elements of the exercise program that are of interest to the user. The vectorizing model 246 may store the resulting vectors in a vector database, which may be readily searched by recommendation models.

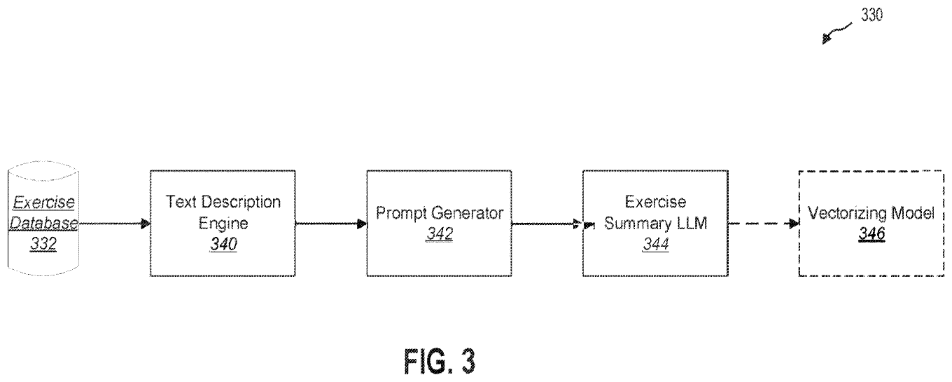

FIG. 3 is a representation of an exercise program description system 330, according to at least one embodiment of the present disclosure. The exercise program description system 330 may generate natural language descriptions of one or more exercise programs stored in an exercise program database 332. For example, as discussed herein, a text description engine 340 may receive exercise information from the exercise program database 332, including exercise controls from a control layer of an exercise program, exercise program information from the metadata of the exercise program, and so forth. The text description engine 340 may generate text descriptions of the exercise information. A prompt generator 342 may generate a prompt based on the text descriptions and/or the metadata. An exercise summary LLM 344 may generate a natural language summary of the exercise program.

As discussed herein, in some embodiments, a vectorizing model 346 may optionally vectorize the natural language description of the exercise program. For example, the vectorizing model 346 may generate vectors of the elements of the natural language model. The vectors may include numerical representations of a subject or a concept. The vectors may be stored in a vector database. Vectorizing the natural language description may facilitate improved searching or identifying of various features of a particular exercise program.

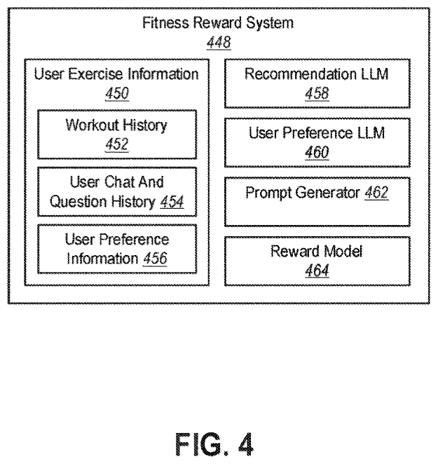

FIG. 4 is a representation of a fitness reward system 448, according to at least one embodiment of the present disclosure. The fitness reward system 448 may generate customized rewards and/or incentives for a future reward for a user. For example, the fitness reward system 448 may review user exercise information 450 and generate a user preference profile. The user exercise information 450 may include any type of user information. For example, the user exercise information 450 may include a user's workout history 452. The workout history 452 may include completion information for the user.

For example, the workout history 452 may include a historical record of exercise programs completed and uncompleted exercise programs (e.g., exercise programs that are not completed and/or exercise programs started but not completed), dates of completed and/or uncompleted exercise programs (e.g., when a user misses an exercise activity, based on a user missing an exercise activity), time of day of completed and/or uncompleted exercise programs, any other exercise program information, and combinations thereof. In some examples, the workout history 452 may include physiological information for the user that is associated with the exercise program. Such physiological information may include heartrate information, VO2 max information, breathing information, calories burned, any other physiological information, and combinations thereof. In some examples, the workout history 452 may include a record of the operating parameters of the exercise device, difficulty settings, manual changes to the exercise program, speed information, pace information, any other operating parameters, and combinations thereof.

The user exercise information 450 may include communication information for the user. For example, the user exercise information 450 may include user chat history 454. The user chat history 454 may include a record of exercise questions asked and associated interactions with an exercise system. For example, an exercise system may include one or chatbots, question and answer services, trainer interactions, frequently asked questions (FAQs), publications, and so forth. The user's interactions with these informational elements, including access to information, questions asked, answers received, information posted, and so forth, may form the user chat history 454.

The user exercise information 450 may further include user preference information 456. The user preference information 456 may include a record of user preferences. User preference information 456 may include information related to user likes, dislikes, motivations, incentives, disincentives, and so forth. The user preference information 456 may be collected in any manner. For example, the user preference information 456 may be collected based, at least in part, on user input from direct questions, analysis of the user chat history 454, tracking trends in the workout history 452, previous rewards, the user's social media profile(s), user gaming history, user entertainment history, historical user preference information, user media content preference, user entertainment information, preferred workout frequency, preferred workout duration, preferred workout intensity, preferred workout variety, any other user information, user rating information for historical exercise information, and combinations thereof. In some embodiments, the user preference information 456, including ratings and/or rating information, may be organized based on any parameter, such as exercise program parameters of historical exercise programs, including such exercise program parameters such as exercise device type, trainer identify, visual information, audio information, exercise program length, or exercise program intensity.

The fitness reward system 448 may include a recommendation LLM 458. The recommendation LLM 458 may generate exercise recommendations for the user. For example, the recommendation LLM 458 may generate exercise recommendations based on any input, including user requests, a request from another LLM, and so forth. In accordance with at least one embodiment of the present disclosure, the recommendation LLM 458 may search exercise programs using a vector database from vectorized natural language descriptions of an exercise program, as discussed herein. The recommended exercise programs maybe generated with an associated reward. The recommendation LLM 458 may receive an exercise recommendation prompt based on the exercise information for the user.

A user preference LLM 460 may generate a user preference profile for the user. For example, a prompt generator 462 may generate a user preference prompt for the user preference LLM 460 based on the user exercise information 450. The user preference LLM 460 may generate the user preference profile based on the user preference prompt input from the prompt generator 462. The user preference profile may be a representation of the motivational preferences of the user.

In accordance with at least one embodiment of the present disclosure, a reward model 464 may be applied to the user preference profile. The reward model 464 may generate rewards based on the user preference profile that are tailored or customized to the user. Different users may be motivated by and/or respond to different reward structures. Rewards may include any type of reward, such as messages, achievements, virtual currency, a skin for a virtual avatar, clothing, exercise equipment, exercise accessories, financial discounts (e.g., shopping discounts, subscription discounts), digital environment features (e.g., avatars, skins, stickers, videos, soundtracks), a customized image, a customized video, limited-access programming, exclusive programming, contact with one or more trainers, contact with one or more other athletes, any other reward, and combinations thereof. The particular reward may be based on the user preference profile.

In some examples, the reward model 464 may generate the customized reward for the user by selecting a particular type of reward. In some examples, the reward model 464 may adjust the details of the type of reward to be customized for the user. For example, the reward model 464 may generate an achievement that includes language that is specific or unique to the user. In some examples, the details of any reward from the reward model 464 may be customized to the user.

In some embodiments, the reward model 464 may generate the customized reward for the user based on customized circumstances and/or frequency specific to the user. For example, the reward model 464 may identify the circumstances tied to the administration of the reward (e.g., completion of a particular exercise program, reaching of a target or goal, consistency). In some examples, the reward model 464 may identify the frequency with which rewards are provided to the user. For example, the reward model 464 may identify that a user may prefer regular rewards for completion of exercise activities and provide frequent rewards. In some examples, a different user may prefer milestone rewards based on the completion of milestones. In some examples, the reward model 464 may generate reward frequency that is customized for each user. As may be understood, the reward generated by the reward model 464 may be, at least partially, based on the completion information.

The reward model 464 may be any type of reward model. For example, the reward model 464 may include a direct program optimization (DPO) model. In some examples, the reward model 464 may include a reinforcement learning from human feedback (RLHF) model. In some examples the reward model may include any model that incorporates human feedback and/or psychological principles to identify rewards and reward structures for a particular user.

In accordance with at least one embodiment of the present disclosure, the fitness reward system 448 may update the user preference profile based on updated user preference information and/or updated user exercise information. Over time, the user's health and fitness status may change. For example, the user may complete exercise programs and/or fitness programs and improve his or her health and fitness status, the user may fail to complete exercise and/or fitness programs and reduce his or her health and fitness status, the user may become injured, sick, or otherwise unable to complete one or more exercise activities, or otherwise change his or her health and fitness status. This may result in updated user exercise information representative of the change in the health and fitness status.

In some embodiments, the user preference information may change. For example, the user's interests may change, the user may complete a goal and desire to achieve a new goal, the user may fail to complete a goal and desire to achieve a different goal, the user may try something and decide he or she does not like it, the user may otherwise experience a change in his or her preferences, and combinations thereof. In some embodiments, the updated user preference information and/or updated exercise information may be based, at least in part, on one or more exercise programs performed by the user. The fitness reward system 448 may receive the updated user preference information. The prompt generator 462 may generate an updated user preference prompt based on the updated user preference information. The fitness reward system 448 may provide the updated user preference prompt to the user preference LLM to generate an updated user preference profile. The reward model 464 may generate an updated reward for the user based on the updated user preference profile.

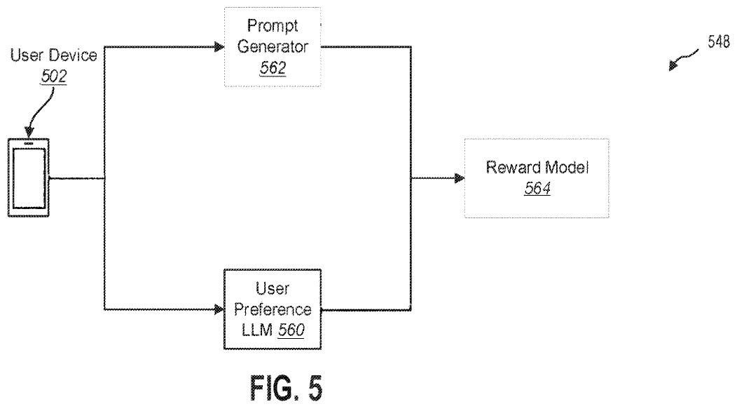

FIG. 5 is a representation of a fitness reward system 548, according to at least one embodiment of the present disclosure. The fitness reward system 548 may include a reward model 564 that generates customized rewards for a particular user. The reward model 564 may receive a prompt from a prompt generator 562 to generate a reward from a user. The reward model 564 may receive a user preference profile and/or reward information from a user preference LLM 560. Using the prompt and the user preference profile information, the reward model 564 may generate a customized reward for the user. In some embodiments, the prompt generator 562 and/or the user preference LLM 560 may receive information from a user device 502. For example, the user may enter, into the user device 502, a request for an exercise program, user preference information, and so forth.

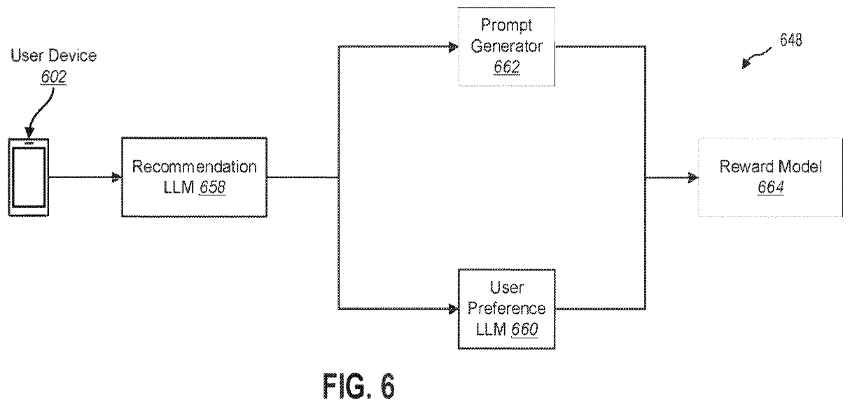

FIG. 6 is a representation of a fitness reward system 648, according to at least one embodiment of the present disclosure. In some embodiments, a recommendation LLM 658 may receive a request for an exercise recommendation.

For example, the recommendation LLM 658 may receive the request for the exercise recommendation from a user device 602. The recommendation LLM 658 may generate the exercise recommendation. As discussed herein, the exercise recommendation may include any recommendation, such as a recommendation for an exercise program, a recommendation for a fitness program, a recommendation for health information, dietary information, any other exercise recommendation, and combinations thereof.

In accordance with at least one embodiment of the present disclosure, a reward model 664 may generate a reward based on the exercise recommendation. For example, the reward model 664 may receive the exercise recommendation and generate a reward customized for the user based on the exercise recommendation. The customized reward may be different for different exercise recommendations and/or exercise programs.

As discussed herein, to generate the reward, the reward model 664 may receive a prompt to generate the reward from a prompt generator 662 and a user preference profile for the user from a user preference LLM 660. The reward model 664 may utilize the prompt and the user preference profile to determine the reward that should be associated with the exercise program.

In some embodiments, the user may implement the exercise program on an exercise device, and upon completion of the exercise program, the fitness reward system 648 may present the user with the reward. In some embodiments, the reward may be presented to the user as a potential reward pending completion of the exercise program from the exercise recommendation and may be provided to the user after completion. In some embodiments, the reward may be hidden from the user until the user completes the exercise program, making the reward a surprise reward.

While embodiments of the present disclosure have discussed the reward being generated prior to transmission of the exercise activity to the user and/or completion of the exercise activity by the user, it should be understood that the reward may be generated during and/or after completion of the exercise program. For example, when the user completes the exercise program, the reward model 664 may generate the reward for the user based on the completion of the exercise program. In some examples, when the user completes the exercise program, the reward model 664 may generate the reward for the user based on how the user completed the exercise program, such as the speed, heartrate, pace, distance, weight lifted, or other completion parameter of the exercise program.

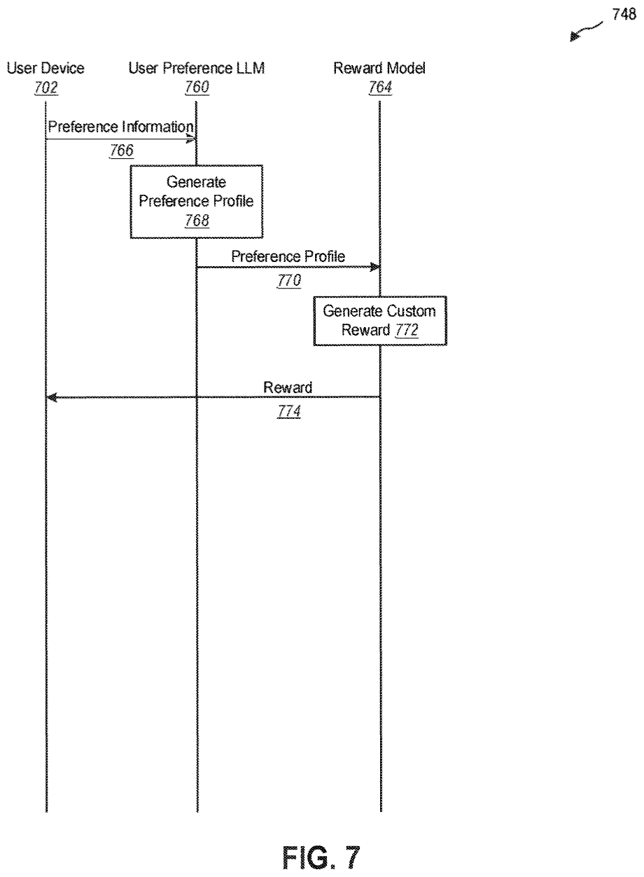

FIG. 7 is a representation of string diagram of a fitness reward system 748, according to at least one embodiment of the present disclosure. A user device 702 may send preference information 766 to a user preference LLM 760. The user preference LLM 760 may generate 768 a user preference profile and transmit the user preference profile 770 to a reward model 764. The reward model 764 may generate 772 a custom reward. The reward model 764 may transmit the custom reward 774 to the user device 702.

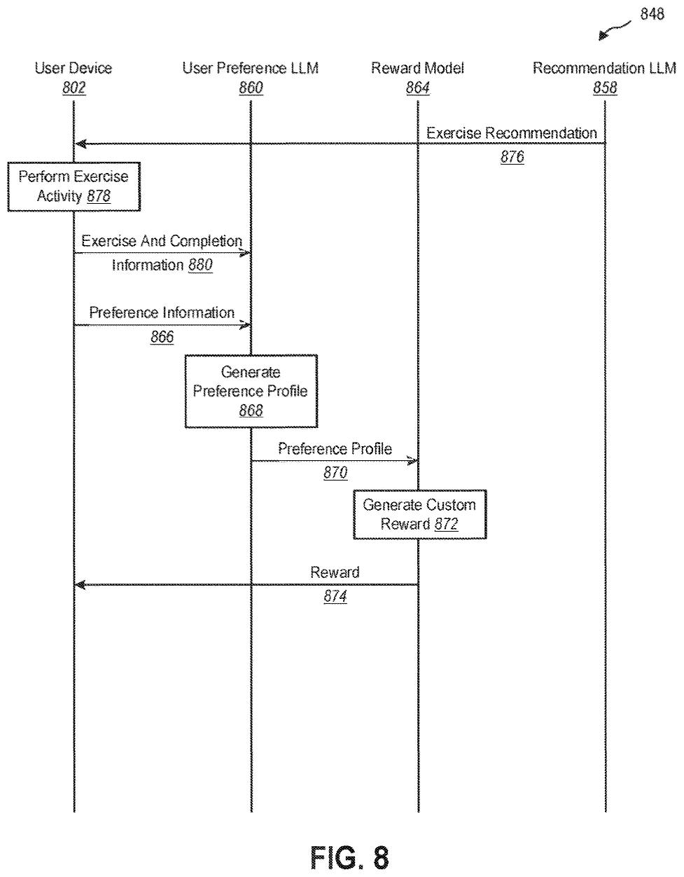

FIG. 8 is a representation of a string diagram of a fitness reward system 848, according to at least one embodiment of the present disclosure. A recommendation LLM 858 may send an exercise recommendation 876 to a user device 802. The user may perform 878 the exercise program or exercise activity associated with the exercise recommendation.

The user device 802 may provide exercise and completion information 880 and user preference information 866 to a user preference LLM 860. The user preference LLM 860 may generate 868 a user preference profile and transmit the user preference profile 870 to a reward model 864. The reward model 864 may generate 872 a custom reward. The reward model 864 may transmit the custom reward 874 to the user device 802.

As discussed herein, in some embodiments, the reward may be generated after the user performs the exercise activity. In some embodiments, the exercise recommendation may include the reward, and the reward model 864 may generate the reward based on confirmation of completion of the exercise recommendation.

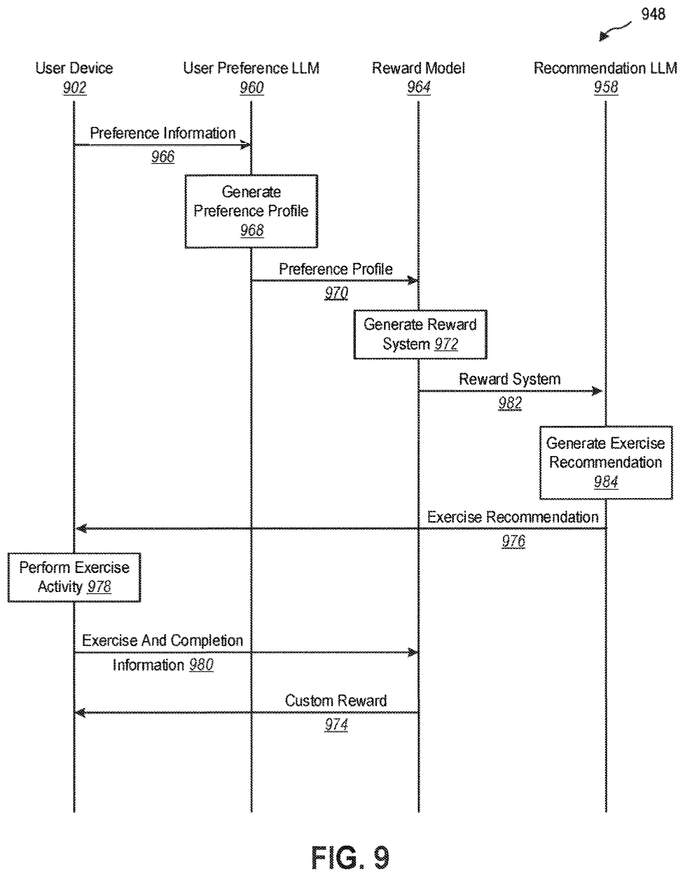

FIG. 9 is a representation of a string diagram of a fitness reward system 948, according to at least one embodiment of the present disclosure. As discussed herein, a user device 902 may send preference information 966 to a user preference LLM 960. The user preference LLM 960 may generate 968 a user preference profile and transmit the user preference profile 970 to a reward model 964. The reward model 964 may generate 972 a custom reward system. The custom reward system may include a series of rules or guidelines based on which to generate rewards. For example, the custom reward system may identify the timing and type of reward to be given for a particular exercise activity. In some examples, the custom reward system may include rankings of rewards associated with different exercise programs, which may be an indication of which types of exercise programs may provide better rewards for the user, or rewards that may be more motivating or encouraging for the user. The reward model 964 may transmit the custom reward system 974 to a recommendation LLM 958.

The recommendation LLM 958 may generate 984 an exercise recommendation for the user. In some embodiments, the recommendation LLM 958 may generate 984 the exercise recommendation based on the custom reward system 982. For example, the recommendation LLM 958 may identify exercise programs that may provide a better reward and prepare those recommendations for the user. A better reward may be considered a reward that may provide a positive emotion for the user. In some embodiments, a better reward may result in increased user engagement with an exercise system, including returning to perform additional exercise programs.

The recommendation LLM 958 may send the exercise recommendation 976 to the user device 902. The user may perform 978 the exercise activity. When the user performs 978 the exercise activity, the user device 902 may send exercise and completion information 980 to the reward model 964. The exercise and completion information 980 may be a representation of the completion status and the exercise metrics measured while performing the exercise activity. The reward model 964 may generate the reward based on the exercise and completion information 980 and send the custom reward system 974 to the user device 902.

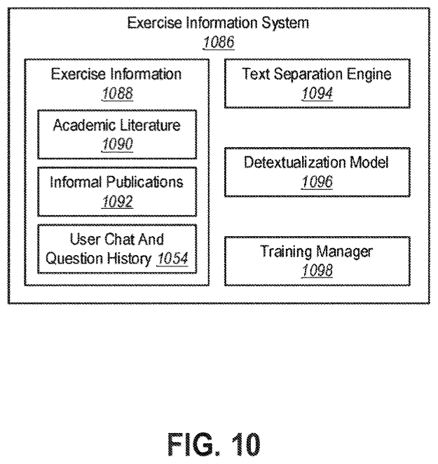

FIG. 10 is a representation of an exercise information system 1086 including techniques to train a foundation model, such as an exercise model, according to at least one embodiment of the present disclosure. The exercise information system 1086 may include a database of exercise information 1088. The exercise information 1088 may include any type of exercise information. In some embodiments, the exercise information 1088 includes educational information. For example, the exercise information 1088 may include information that may be used to educate or information a user about exercise topics. In some embodiments, the exercise information 1088 includes text information, such as text descriptions of exercise information. In some embodiments, the exercise information 1088 includes audio and/or visual information. In some embodiments, the text information includes a text description of the audio and/or visual information. The text information may include any type of information, including instruction information on how to perform a particular exercise activity.

The exercise information 1088 may include academic literature 1090. The academic literature 1090 may include any type of academic literature, such as articles from academic journals and scholarly publications. The academic literature 1090 may be a representation of the state of the art for a particular exercise activity or exercise. In some embodiments, the academic literature 1090 may include print publications, such as books, magazines, and so forth.

The exercise information 1088 may further include informal publications 1092. Informal publications 1092 may include non-traditional media, or non-print media. For example, the informal publications 1092 may include online publications, such as blog posts, website posts, serial publications, social media posts, and so forth. In some embodiments, the informal publications 1092 may be vetted for accuracy, safety, and/or representation of the associated subject matter. In some embodiments, the informal publications 1092 may include transcripts of exercise programs, including transcripts of the instructional and/or encouraging words used by the trainer in the exercise program.

In some embodiments, the exercise information 1088 may include user chat history 1054. The user chat history 1054 may include a record of exercise questions asked and associated interactions with an exercise system. For example, an exercise system may include one or chatbots, question and answer services, trainer interactions, frequently asked questions (FAQs), publications, and so forth. The user's interactions with these informational elements, including access to information, questions asked, answers received, information posted, and so forth, may form the user chat history 1054.

The exercise information system 1086 may further include a text separation engine 1094. The text separation engine 1094 may separate the text information of the exercise information 1088 into discrete text information sets. The text information sets may be chunks or sections of the text information that are related to the same subject matter. In some embodiments, the text information sets may be sections of the text information that are directed to a subset of the text information. As a specific, non-limiting example, the exercise information 1088 may include an article related to the proper form to use when performing a squat. The text information may include descriptions sub-actions, the sub-actions including one or more of feet placement, feet orientation, head orientation, knee placement, knee angle at full compression, knee angle at full extension, arm placement, and so forth. The text separation engine 1094 may separate the text information into text information related to the descriptions of the sub-actions. For example, the text separation engine 1094 may generate a text information set for each of the sub-actions identified in the exercise information 1088. The text separation engine 1094 may include any type of model. As a specific, non-limiting example, the text separation engine 1094 may include a recursive model.

The text separation engine 1094 may generate the text information sets in any manner. For example, the text separation engine 1094 may generate the text information sets based on subject matter. In some examples, the text separation engine 1094 may generate the text information sets based on a maximum length of the text information set. In some examples, the text separation engine 1094 may generate the text information sets based on a word count of the text information set. In some examples, the text separation engine 1094 may generate the text information sets based on a sentence count and/or a sentence start and end of the text information set. In some examples, the text separation engine 1094 may generate the text information sets based on a paragraph count and/or a paragraph start and end of the text information set. In some examples, the text separation engine 1094 may generate the text information set based on a combination of factors discussed herein and other factors.

The exercise information system 1086 may further include a detextualization model 1096. The detextualization model 1096 may receive the text information sets and generate detextualized question-and-answer sets. The questions of the question-and-answer sets may ask about a particular aspect of the text information set. The answer to the question-and-answer set may provide a response to the question. In some embodiments, the detextualization model 1096 may generate multiple question-and-answer sets related to the same text information set. In some embodiments, the multiple questions may be directed to the same sub-action or aspect of the text information set. For example, two different question-and-answer sets may be directed to the same aspect or sub-action of the text information set while using different question and/or answer language, including different vocabulary, syntax, grammatical constructions, synonyms of technical terms, or other differences in questions and answers. In some examples, the question-and-answer sets may be generated using natural language to simulate different question structures that may be utilized by a particular user. For example, the detextualization model 1096 may include an analysis of different question structures, language patterns, vocabulary patterns, and so forth for different users from different demographic groups. The detextualization model 1096 may generate different question-and-answer sets based on the identified patterns. For example, the different question-and-answer pairs may include different language. The different language may be any type of different language, such as a synonym of a technical term, a different grammatical form, a different syntactical structure, any other different language, and combinations thereof. In some embodiments, the detextualization model 1096 may generate question-and-answer pairs using only information from the text information sets. In some embodiments, the detextualization model 1096 may generate a plurality of question-and-answer pairs where each question-and-answer pair is related to a different subject.

The detextualization model 1096 may be any type of model. For example, the detextualization model 1096 may be a foundation model trained or fine-tuned to analyze information and generate a natural language question based on the information. In some examples, the detextualization model 1096 may be a foundation model trained or fine-tuned to analyze information and generate an answer to a question based on the information. In some examples, the detextualization model 1096 may include any other type of model.

In some embodiments, to generate the question-and-answer sets, a prompt generator may generate a prompt requesting the question-and-answer sets from the detextualization model 1096. The prompt may include context relevant to the question-and-answer sets. For example, the prompt may include an identification of the particular exercise information 1088, the text information set, the question quantity of desired question-and-answer sets, a particular question and/or answer type, any other context, and combinations thereof. In some embodiments, the prompt may include context information. The context information may include any context information, such as third-party exercise information, third-party databases, and so forth.

In accordance with at least one embodiment of the present disclosure, the exercise information system 1086 may use the question-and-answer sets to train or fine-tune a foundation model, such as an exercise model or other foundation model discussed herein. For example, a training manager 1098 may input the question-and-answer sets into the foundation model or exercise model during a training or fine-tuning cycle of the foundation model. As discussed herein, generating the question-and-answer sets may increase the amount of training information. In this manner, and in accordance with at least one embodiment, utilizing the question-and-answer sets for training or fine-tuning may increase the amount of information used to train the foundation model. This may increase the number of connections the foundation model may make, thereby increasing the accuracy and/or relevance of the results of the foundation model. In some embodiments, training the foundation model with the question-and-answer sets may facilitate an improved responsiveness to factual questions from a user.

The foundation model trained by the question-and-answer sets may be any type of foundation model. For example, the foundation model may include a recommendation model that prepare recommendation recommendations of exercise activities, exercise programs, and fitness programs. In some examples, the foundation model may include a chatbot that holds conversations with a user, including answering questions. In some examples, the foundation model may include a fitness program or exercise program generator. In some examples, the foundation model may include an exercise information model trained to answer informational questions about the user. In some examples, the foundation model may include an agent router that is trained to identify a user input and route the input to an appropriate agent.

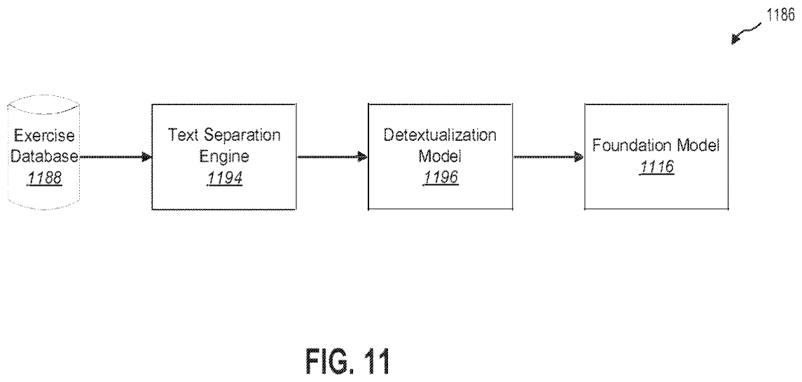

FIG. 11 is a representation of an exercise information system 1186, according to at least one embodiment of the present disclosure. A text separation engine 1194 may receive exercise information including text information from an exercise database 1188. As discussed herein, the text separation engine 1194 may separate the text information from the exercise database 1188 into text information sets.

A detextualization model 1196 may receive the text information sets from the text separation engine 1194. The detextualization model 1196 may generate a plurality of question-and-answer sets for the text information sets. As discussed herein, the question-and-answer sets may be used to train a foundation model 1116. This may help to improve the accuracy and/or relevance of outputs of the foundation model 1116.

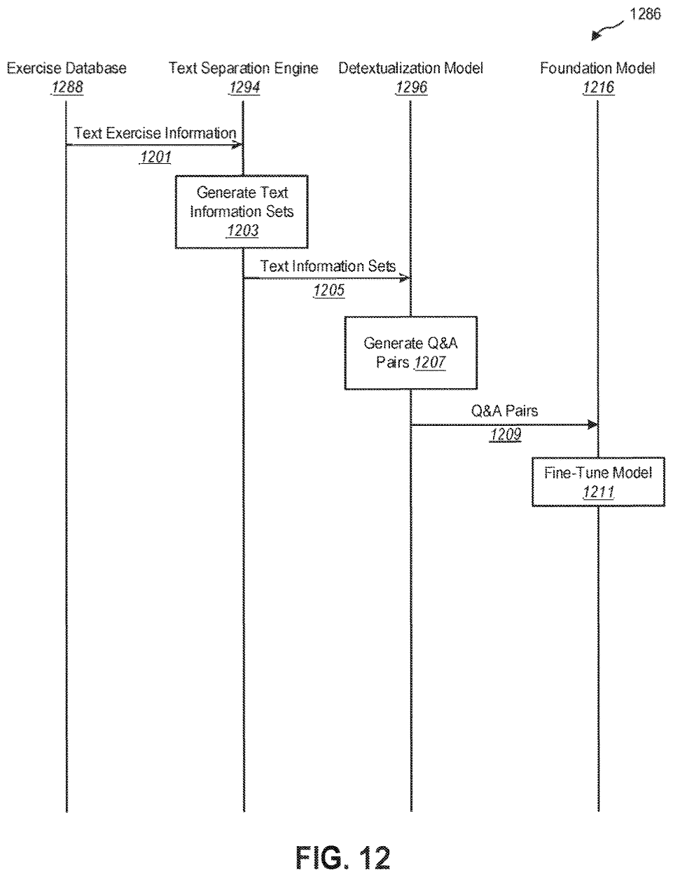

FIG. 12 is a representation of a string diagram of an exercise information system 1286, according to at least one embodiment of the present disclosure. A text separation engine 1294 may receive text exercise information 1201 from an exercise database 1288. The text separation engine 1294 may generate 1203 one or more text information sets. The text separation engine 1294 may send the text information sets 1205 to a detextualization model 1296.

As discussed herein, the detextualization model 1296 may be trained to generate 1207 question-and-answer pairs. The detextualization model 1296 may send the question-and-answer pairs 1209 to a foundation model 1216. The foundation model 1216 may utilize the pairs 1209 to fine-tune 1211 the foundation model 1216.

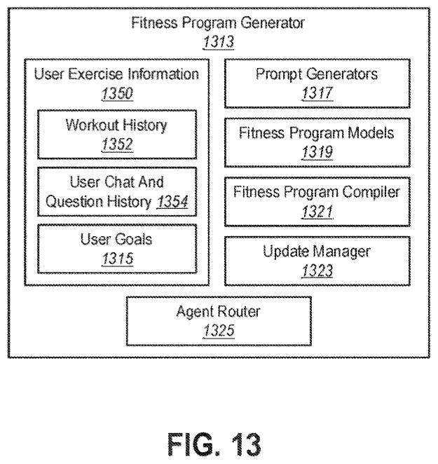

FIG. 13 is a representation of a fitness program generator 1313, according to at least one embodiment of the present disclosure. The fitness program generator 1313 includes user exercise information 1350. The user exercise information 1350 may include any type of user information. For example, the user exercise information 1350 may include a user's workout history 1352. The workout history 1352 may include completion information for the user. For example, the workout history 1352 may include a record of exercise programs completed and/or exercise programs started but not completed, dates of completed and/or uncompleted exercise programs, time of day of completed and/or uncompleted exercise programs, any other exercise program information, and combinations thereof. In some examples, the workout history 1352 may include physiological information for the user that is associated with the exercise program. Such physiological information may include heartrate information, VO2 max information, breathing information, calories burned, any other physiological information, and combinations thereof. In some examples, the workout history 1352 may include a record of the operating parameters of the exercise device, difficulty settings, manual changes to the exercise program, speed information, pace information, any other operating parameters, and combinations thereof.

The user exercise information 1350 may include communication information for the user. For example, the user exercise information 1350 may include user chat history 1354. The user chat history 1354 may include a record of exercise questions asked and associated interactions with an exercise system. For example, an exercise system may include one or chatbots, question and answer services, trainer interactions, frequently asked questions (FAQs), publications, and so forth. The user's interactions with these informational elements, including access to information, questions asked, answers received, information posted, and so forth, may form the user chat history 1354.

The user exercise information 1350 may further include user goals 1315. The user goals 1315 may include any goal for the user. For example, the user goals 1315 may include explicitly stated user goals. For example, the user may input the user goals 1315 into an input field of an application and/or provide the user goals 1315 in response to a prompt or from a chatbot or other user system interaction. The user goals 1315 may include any type of goal. For example, the user goals 1315 may include event-based goals (e.g., participate in a particular event), fitness goals (e.g., weight lifted, speed, pace, distance), health goals, weight loss goals, weight gain goals, body image goals (e.g., waist size, muscle mass), any other user goal, and combinations thereof. In some embodiments, the user goals 1315 may include goals related to the completion of a fitness program. For example, the user may input user goals 1315 that relate to a particular fitness program he or she would like to complete.

In accordance with at least one embodiment of the present disclosure, the fitness program generator 1313 may include one or more prompt generators 1317 that may generate prompts for one or more fitness program models 1319. The fitness program models 1319 may collectively generate a fitness program for the user. As discussed herein, the fitness program may include a series of exercise programs that may be performed at different times and/or on different days. The fitness program may cover a period of time. The period of time for the fitness program may include any period of time, such as 1 day, 2 days, 3 days, 4 days, 5 days, 6 days, 1 week, 2 weeks, 3 weeks, 1 month, 2 months, 3 months, 4 months, 5 months, 6 months, 7 months, 8 months, 9 months, 10 months, 11 months, 1 year, 2 years, 5 years, or any amount of time therebetween. The fitness program may include exercise programs to be completed during the fitness program. The fitness program may include any number of exercise programs, performed with any frequency, and performed at any time of day.

In some embodiments, each exercise program of the fitness program may be different. For example, different exercise programs may have different durations, exercise activities, intensities, operating parameters, exercise devices, exercise equipment, any other different parameter, and combinations thereof. In some embodiments, two or more of the exercise programs of the fitness program may be the same. For example, two or more of the exercise programs of the fitness program may have the same duration, exercise activity, intensity, operating parameter, exercise device, exercise equipment, any other parameter, and combinations thereof.

Conventional models to generate fitness programs may experience difficulty in generating entire exercise programs. For example, the amount of information used by a foundation model to generate a fitness program may be very large. This may result in the foundation model utilizing large amount of processing resources to generate the fitness program and/or not be trained to perform all tasks of generating the fitness program. The resulting fitness program may not be representative of the user's desired exercise program and/or may include inaccurate details regarding the exercise program.

The fitness program models 1319 may include a plurality of fitness agents. The fitness agents may be trained on or fine-tuned on different aspects of a fitness program. For example, the fitness agents may be trained on or fine-tuned to generate different levels of granularity of a fitness program. A first level of the fitness program, covering a first period of time, may include the overall structure or overall schedule of the fitness program. A second level of the fitness program, covering a second period of time, the second period of time shorter than the first period of time, may include a single exercise program. In some embodiments, the second period of time is encompassed by the first period of time. In some embodiments, the first period of time is greater than the second period of time. In this manner, and in accordance with at least one embodiment, the quality of the fitness program may be improved by creating a more representative overall structure while improving the selection of exercise programs in the fitness program. For example, the overall schedule of the fitness program may be better suited to help the user reach his or her goals, with the selected exercise programs more consistent with the generated schedule.

In some embodiments, the fitness agents may generate progress milestones. For example, the overall schedule agent may generate progress milestones that are representative of anticipated progress toward the user's goal. The progress may be any type of progress, including progress directly related to the user's goal, progress unrelated to the user's goal, completion milestones, and so forth.

While two levels of granularity are discussed herein, it should be understood that the fitness program models 1319 may generate more than two levels of granularity. The levels of granularity may include any number of levels of granularity pr periods of time. For example, the levels of granularity may include an exercise program level of granularity, a daily level of granularity, a weekly level of granularity, a bi-weekly level of granularity, a monthly level of granularity, a bi-monthly level of granularity, a quarter-annual level of granularity, a bi-annual level of granularity, an annual level of granularity, any other level of granularity, and combinations thereof.

The agents of the fitness program models 1319 may be fine-tuned based on any other factor. For example, the agents of the fitness program models 1319 may be fine-tuned for particular exercise devices, exercise activities, exercise duration, exercise type, any other factor, and combinations thereof. In some embodiments, a different agent may generate the exercise program for different days. This may further facilitate improved relevance and accuracy of the resulting fitness program.

The agents of the fitness program models 1319 may be selected at a particular point in the fitness program process by an agent router 1325. The agent router 1325 may receive an input, such as the prompt generated by the prompt generators 1317, and identify to which agent to send the prompt, as discussed in further detail herein. The agent router 1325 may then send the input to the selected agent, and the selected agent may process the input.

In some embodiments, a fitness program complier 1321 may compile the various aspects of the fitness program into a single fitness program. For example, the fitness program complier 1321 may receive the different levels of the fitness program, including the schedule and individual exercise programs, and compile the exercise programs into a complete fitness program. This may result in a complete exercise program generated from multiple agents of the fitness program models 1319.

In accordance with at least one embodiment of the present disclosure, an update manager 1323 may update the fitness program based on the user progress. For example, the update manager 1323 may receive updated user exercise information 1350 from the user. The updated user exercise information 1350 may include user information collected while performing the exercise program, user completion information, newly generated user chat history 1354, newly generated and/or updated user goals 1315. Updating the fitness program may facilitate an improved, more accurate, or more relevant fitness program for the user.

To update the fitness program, the update manager 1323 may analyze the updated user information. The update manager 1323 may determine whether the user's exercise information has varied from the fitness program. Variations from the fitness program may include any type of variation. For example, a variation from the fitness program may include identifying whether the user has met, failed to reach, or exceed a progress milestone. If the user has met the progress milestone, the update manager 1323 may determine that the fitness program may not be modified. If the user has not met the progress milestone, the update manager 1323 may determine that the fitness program should be modified. For example, if the progress milestone is exceeded, then the update manager 1323 may increase a difficulty level or intensity of the fitness program. If the progress milestone is not met, then the update manager 1323 may decrease the difficulty level or intensity of the fitness program.

In some examples, the update manager 1323 may determine that the fitness program should be updated based on user input. For example, the user may provide input that he or she is not enjoying the exercise programs, and the update manager 1323 may update the fitness program to change the exercise program types. In some examples, the user may provide input that he or she is feeling pain that may be a result of injury, and the update manager 1323 may update the fitness program based on the user's pain to prevent or reduce the severity of the injury.

The update manager 1323 may update the fitness program at any point during the fitness program. For example, the update manager 1323 may update the fitness program periodically or episodically. The update manager 1323 may update the fitness program periodically with an update period, which may be daily, weekly, bi-weekly, monthly, bi-monthly, any other update period, and combinations thereof. In some examples, the update manager 1323 may update the fitness program episodically based on the completion of certain exercise programs, based on the completion of a percentage of the fitness program, based on user input, based on trainer input, any other episodic update, and combinations thereof.

The update manager 1323 may update the fitness program in any manner. For example, the update manager 1323 may provide the update to the prompt generators 1317, and the prompt generators 1317 may generate the associated prompts for the fitness program models 1319. In some examples, the update manager 1323 may regenerate the entire remaining fitness program. In some examples, the update manager 1323 may update individual portions of the fitness program. For example, the update manager 1323 may cause the prompt generator 1317 for a particular agent to update that portion of the fitness program, such as an individual exercise program, multiple exercise programs, a period of time in the fitness program, or the entire fitness program. As discussed herein, updating the fitness program may result in a responsive, live fitness program that accurately and with improved relevance responds to the user's situation.

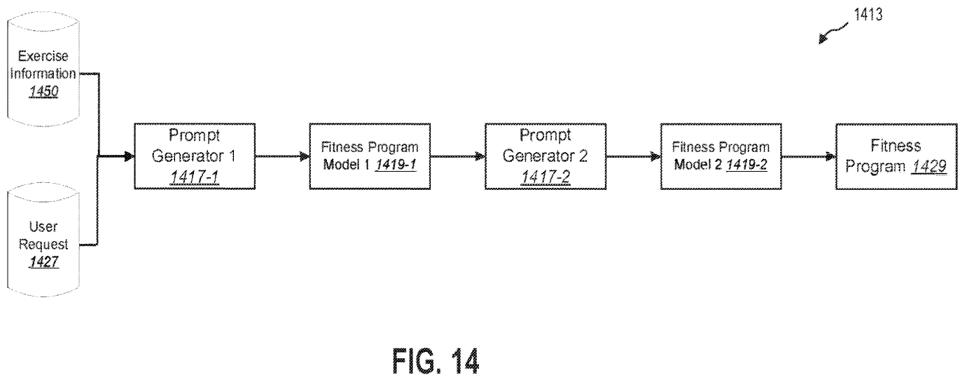

FIG. 14 is a representation of a fitness program generator 1413, according to at least one embodiment of the present disclosure. A first prompt generator 1417-1 may receive exercise information 1450 about a user. The first prompt generator 1417-1 may further receive a user request 1427. The user request 1427 may include any request. For example, the user may input the user request 1427 into a computing system explicitly requesting the fitness program. In some examples, the user request 1427 may be identified in a chat history or other history of the user. In some examples, the user request 1427 may be input by a trainer or other third party in communication with the user. In some examples, the user request 1427 may be automatically generated by a recommendation system to provide a fitness program recommendation to the user.

The first prompt generator 1417-1 may generate a first prompt for a first fitness program model 1419-1 to generate a first level of the fitness program. As discussed herein, the first level of the fitness program may include a lower level of granularity (e.g., less detail) than other levels of the fitness program. In some examples, the prompt may include and/or reference the exercise information 1450 and/or the user request 1427. The first prompt generator 1417-1 may generate the prompt tailored to the first fitness program model 1419-1. For example, the prompt may be based on the focus of the first fitness program model 1419-1 or the agent associated with the first fitness program model 1419-1. For example, if the first fitness program model 1419-1 provides a fitness program schedule based on a particular user goal, the first prompt generator 1417-1 may generate the prompt to request that the first fitness program model 1419-1 generates the fitness program schedule based on the exercise information 1450 and the user request 1427. The prompt may include context information, such as the point of view of the first fitness program model 1419-1 (e.g., the point of view of a personal trainer).

As discussed herein, the fitness program schedule may include any schedule information. For example, the fitness program schedule may include an outline of exercise activities to perform on particular days. In some embodiments, the fitness program schedule may include outlines of duration, distance, speed, weight, intensity, any other aspect, and combinations thereof. In some embodiments, the fitness program schedule may include daily, weekly, and/or monthly targets of for these factors. By identifying the schedule or outline of exercise activities for the fitness program, the fitness program may generate long-term plans to allow the user to reach his or her goals.

In some embodiments, a second prompt generator 1417-2 may generate a second prompt for a second fitness program model 1419-2 to generate a second level of the fitness program. As discussed herein, the second level of the fitness program may have a higher level of granularity (e.g., more detail) than the first level of the fitness program. The second prompt may include and/or reference the exercise information 1450 and/or the user request 1427. The first prompt generator 1417-1 may generate the second prompt tailored to the second fitness program model 1419-2. For example, the prompt may be based on the focus of the second fitness program model 1419-2 or the agent associated with the second fitness program model 1419-2. For example, if the second fitness program model 1419-2 provides exercise activities, the second prompt generator 1417-2 may generate the second prompt to request that the second fitness program model 1419-2 generates exercise activities based on the exercise information 1450 and the user request 1427. In some embodiments, the second prompt may include schedule information from the fitness program schedule generated by the first fitness program model 1419-1. For example, as discussed herein, the second prompt may include the schedule guidelines for particular days or weeks, including exercise activity type, duration, intensity, and so forth. Using these high-level details (e.g., lower granularity details) from the first level of the fitness program, the second fitness program model 1419-2 may generate exercise programs that fit or match the exercise program.

As may be understood, the first fitness program model 1419-1 and the second fitness program model 1419-2 may be trained or fine-tuned on different datasets. The different datasets may be focused on the particular aspect of the fitness program model 1419. In some embodiments, the different datasets may include at least some overlapping material. For example, a first dataset may be related to training schedules, and a second dataset may be related to a type of exercise activities. The first dataset may include information related to different types of exercise activities, including the type of exercise activity from the second dataset. In this manner, the different datasets may include at least some overlapping material.

The exercise programs from the second fitness program model 1419-2 may be compiled into the first level of the fitness program to form the completed fitness program 1429. The fitness program generator 1413 may send the completed fitness program to the user. The user may implement the various exercise programs from the fitness program, such as by implementing the exercise programs on one or more exercise devices.

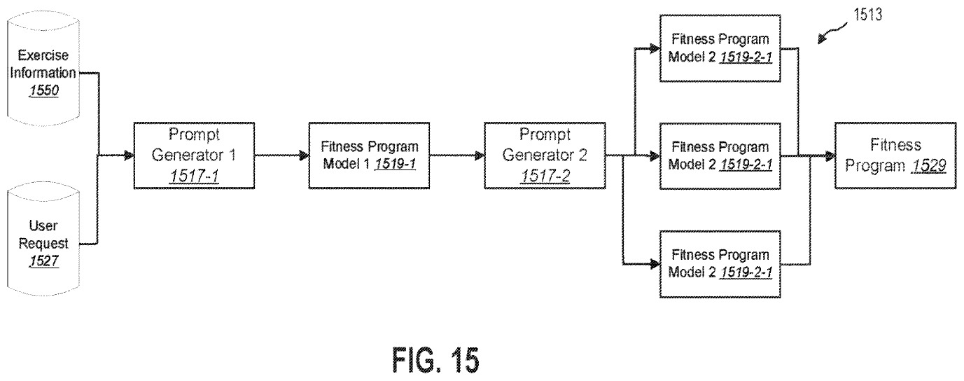

FIG. 15 is a representation of a fitness program generator 1513, according to at least one embodiment of the present disclosure. A first prompt generator 1517-1 may receive exercise information 1550 about a user. The first prompt generator 1517-1 may further receive a user request 1527. The first prompt generator 1517-1 may generate a first prompt for a first fitness program model 1519-1 to generate a first level of the fitness program using the exercise information 1550 and the user request 1527. A second prompt generator 1517-2 may generate a prompt for one or more second fitness program models (collectively 1519).

In the embodiment shown, the fitness program generator 1513 include multiple fitness program models 1519. The different multiple fitness program models 1519 may be fine-tuned to generate exercise programs based on the schedule outlined in the first level of the fitness program. For example, a primary second fitness model 15192-1 may generate exercise programs for a first exercise activity, a secondary second fitness model 15192-2 may generate exercise programs for a second exercise activity, and a tertiary second fitness model 15192-3 may generate exercise programs for a third exercise activity. In some embodiments, the second fitness models 1519-2 may generate different exercise programs that are directed to different exercise programs, such as different exercise types, different activity types, different informational types, any other different exercise, and combinations thereof. The resulting exercise programs may be compiled into the first layer of the fitness program to generate the completed fitness program 1529.

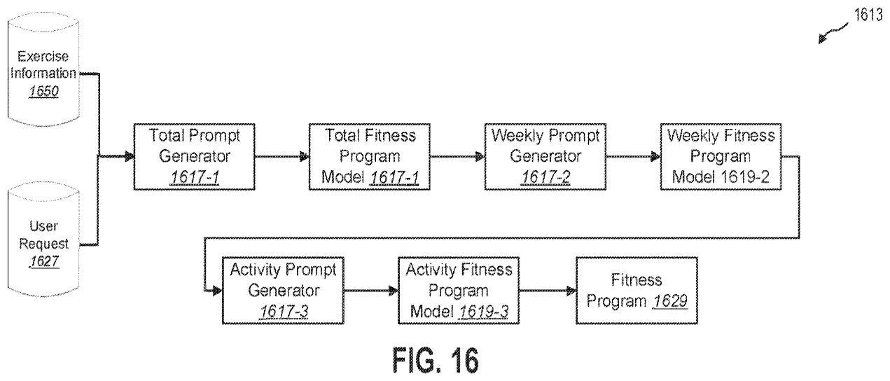

FIG. 16 is a representation of a fitness program generator 1613, according to at least one embodiment of the present disclosure. A total prompt generator 1617-1 may receive exercise information 1650 about a user. The first prompt generator 1617-1 may further receive a user request 1627. The total prompt generator 1617-1 may generate a total prompt for a total fitness program model 1619-1 to generate a first level of the fitness program using the exercise information 1650 and the user request 1627. The first level of the fitness program may be a representation of the overall schedule or total schedule of the fitness program.

A weekly prompt generator 1617-2 may generate a weekly prompt for a weekly fitness program model 1619-2. The weekly fitness program model 1619-2 may utilize the first level of the fitness program to generate second level representing a weekly outline or a weekly schedule for each week of the fitness program.

An activity prompt generator 1617-3 may generate an activity prompt for an activity fitness program model 1619-3. The activity fitness program model 1619-3 may generate exercise programs based on the exercise activities identified in the weekly schedule generated by the weekly fitness program model 1619-2. The exercise programs may be compiled into the weekly schedules, and the weekly schedules may be compiled into the total schedule, resulting in the completed fitness program 1629.

In this manner, and in accordance with at least one embodiment of the present disclosure, the different fitness program models 1619 may generate different portions of the fitness program. For example, the total prompt generator 1617-1 may generate overall schedule over a training period to reach the user goal, including an outline of exercise goals for the training period. The weekly prompt generator 1617-2 may generate the weekly schedules within the training period, and the activity fitness program model 1619-3 may generate the daily exercise programs for each day for each weekly schedule of the plurality of weekly schedules. This may result in a fitness program including multiple exercise programs scheduled over a period of time.

While the embodiment illustrated in FIG. 16 is described with respect to three levels of the fitness program, with each level generated by a single fitness program, it should be understood that the techniques of the present disclosure may be applied to any number of levels of a fitness program. Each level of the fitness program may include any number of fitness models or agents, as may be see with respect to the embodiment described in FIG. 15. This may result in a fitness program that is customized for a user and tailored to his or her circumstances.

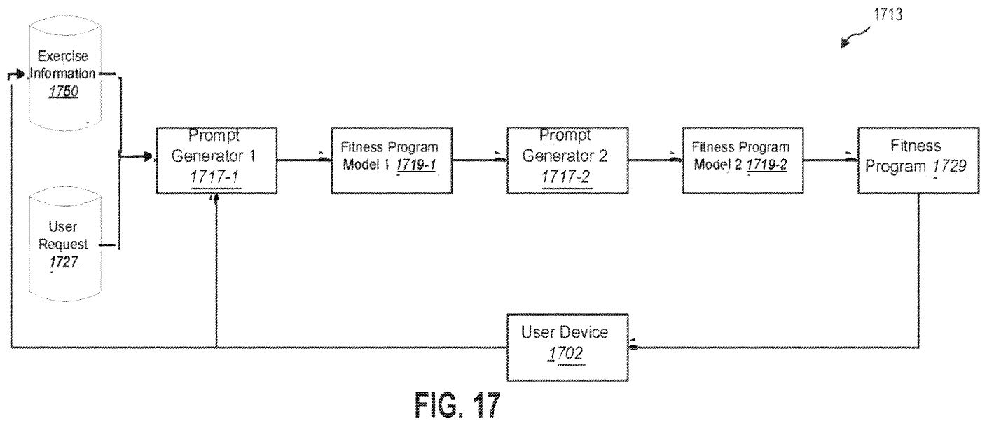

FIG. 17 is a representation of a fitness program generator 1713, according to at least one embodiment of the present disclosure. A first prompt generator 1717-1 may receive exercise information 1750 about a user. The first prompt generator 1717-1 may further receive a user request 1727. The first prompt generator 1717-1 may generate a first prompt for a first fitness program model 1719-1 to generate a first level of the fitness program using the exercise information 1750 and the user request 1727.

A second prompt generator 1717-2 may generate a prompt for a second fitness program model 1719-2. The second fitness program model 1719-2 may generate the second level of the fitness program. The second level of the fitness program may be compiled into the first level of the fitness program, resulting in a completed fitness program 1729. The fitness program generator 1713 may transmit the fitness program 1729 to a user device 1702.

As discussed herein, the user may implement the fitness program. In some embodiments, the user device 1702 may collect information related to the implementation of the fitness program 1729. In some embodiments, based on the information associated with implementation of the fitness program 1729, the fitness program generator 1713 may generate an updated fitness program. For example, the user device 1702 may request a new fitness program from the second prompt generator 1717-2. In some examples, the user device 1702 may transmit the updated or additional exercise information to the exercise information 1750 storage. Based on the updated or additional exercise information, the first prompt generator 1717-1 may generate a new or updated first prompt, the first fitness program model 1719-1 may generate a new or updated first level of the fitness program, the second prompt generator 1717-2 may generate a new or updated second prompt, the second fitness program model 1719-2 may generate a new or updated second level of the fitness program, and the levels of the fitness program may be compiled to form a new completed fitness program 1729. In this manner, the fitness program may be updated based on completion information from the user device 1702.

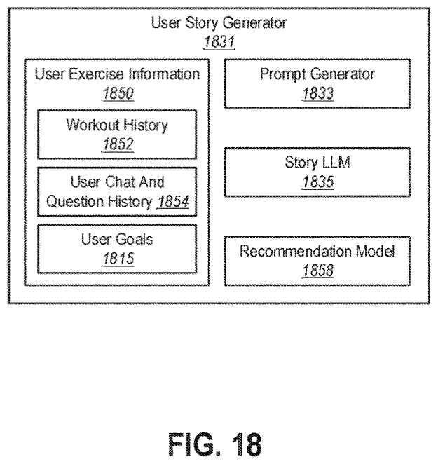

FIG. 18 is a representation of a user story generator 1831, according to at least one embodiment of the present disclosure. The user story generator 1831 may user exercise information 1850. As discussed herein, the user exercise information 1850 may include any type of user information. For example, the user exercise information 1850 may include a user's workout history 1852. The workout history 1852 may include completion information for the user. For example, the workout history 1852 may include a record of exercise programs completed and/or exercise programs started but not completed, dates of completed and/or uncompleted exercise programs, time of day of completed and/or uncompleted exercise programs, any other exercise program information, and combinations thereof. In some examples, the workout history 1852 may include physiological information for the user that is associated with the exercise program. Such physiological information may include heartrate information, VO2 max information, breathing information, calories burned, any other physiological information, and combinations thereof. In some examples, the workout history 1852 may include a record of the operating parameters of the exercise device, difficulty settings, manual changes to the exercise program, speed information, pace information, any other operating parameters, and combinations thereof.

The user exercise information 1850 may include communication information for the user. For example, the user exercise information 1850 may include user chat history 1854. The user chat history 1854 may include a record of exercise questions asked and associated interactions with an exercise system. For example, an exercise system may include one or chatbots, question and answer services, trainer interactions, frequently asked questions (FAQs), publications, and so forth. The user's interactions with these informational elements, including access to information, questions asked, answers received, information posted, and so forth, may form the user chat history 1854.

The user exercise information 1850 may further include user goals 1815. The user goals 1815 may include any goal for the user. For example, the user goals 1815 may include explicitly stated user goals. For example, the user may input the user goals 1815 into an input field of an application and/or provide the user goals 1815 in response to a prompt or from a chatbot or other user system interaction. The user goals 1815 may include any type of goal. For example, the user goals 1815 may include event-based goals (e.g., participate in a particular event), fitness goals (e.g., weight lifted, speed, pace, distance), health goals, weight loss goals, weight gain goals, body image goals (e.g., waist size, muscle mass), any other user goal, and combinations thereof. In some embodiments, the user goals 1815 may include goals related to the completion of a fitness program. For example, the user may input user goals 1815 that relate to a particular fitness program he or she would like to complete.

As discussed herein, the user exercise information 1850 may include structured data and unstructured data. The structured data may be data that is organized and/or quantitative data. Organized data has definable attributes for all values. Structured data may have relationships between datapoints. The user exercise information 1850 may further include unstructured data. Unstructured data may include unorganized or qualitative data. Unstructured data may include facts or other elements that may be organized in a structured data file, but the facts may not be organized as in structured data. Unstructured data may include text, videos, reports, email, images, or other unstructured data. Foundation models are often trained in text analysis, and therefore are trained on unstructured data. Based on the training on text analysis, foundation models may not be optimized to analyze structured data.

The user story generator 1831 may utilize the user exercise information 1850 to generate a natural language story for the user. The natural language story may be a natural language representation of the user exercise information 1850. Generating a natural language description of the story of the user may increase the accuracy and/or representation of foundation model analysis of a user. For example, many of the foundation models discussed herein may utilize user information to generate outputs. Foundation models are trained and optimized to process text-based information. Preparing a natural language summary of the user may provide the foundation models with text-based information for analysis and processing. In this manner, the foundation models may produce results that are more accurate and/or more relevant based on the user input.

The user story generator 1831 may generate the natural language story to incorporate structured and unstructured data. For example, the natural language story may include a natural language description of structured data. As a specific, non-limiting example, the natural language story may include a description of user heart rate (e.g., structured data) over the course of an exercise program. Other examples of structured data may include at least one of exercise frequency, exercise intensity, exercise duration, user heartrate, user VO2 max, user biometric data, completed exercise programs, uncompleted exercise programs, demographic information, age, weight, height, gender, neighborhood, employment, or household income. The natural language description may describe the user heart rate using natural language, such as “the user's heart rate was in zone 3 for over half of the exercise program.” In some embodiments, the natural language description may summarize structured data. In some embodiments, the natural language description may describe structured data.

In some embodiments, the natural language description may include unstructured data, including data that was originally unstructured in the user exercise information 1850. In some embodiments, unstructured data may include at least one of user goals, user updates, user questions, healthcare provider notes, or fitness level.

To generate the natural language story, a story prompt generator 1833 may generate a story prompt. The story prompt may request a natural language story based on the user exercise information 1850. The story prompt may be input into a story LLM 1835. The story LLM may receive the prompt and, based on the user exercise information 1850 generate the natural language user story. In some embodiments, the natural language story may be vectorized to provide vector elements for searching.

A recommendation model 1858 may receive the natural language story and prepare recommendations based on the natural language story. For example, the recommendation model 1858 may prepare exercise recommendations based on the information in the natural language story. As discussed herein, the recommendation model 1858 may be trained or optimized in language processing. As a specific, non-limiting example, the recommendation model 1858 may identify the vectorized elements from the natural language story. The recommendation model 1858 may then search for the vectorized elements in a vector database including vectorized descriptions of exercise programs. This may result in an exercise program that is more representative of the user's interests and/or goals.

In accordance with at least one embodiment of the present disclosure, the user story generator 1831 may receive additional user exercise information. The additional user exercise information may include updates to the user exercise information 1850 discussed herein. In some embodiments, the additional user exercise information may include new user exercise information 1850 not previously collected. In some embodiments, the additional user exercise information may include user feedback. The user feedback may be based on presenting the natural language story to the user. For example, the user may read the natural language story and provide the user feedback based on new information, inaccuracies, clarifications, or other information the user would like added or changed to the natural language story. In some embodiments, based on the additional user exercise information, the story prompt generator 1833 may generate an updated story prompt. The updated story prompt may be applied to the story LLM to generate an updated natural language story. This cycle or loop may be repeated any number of times.

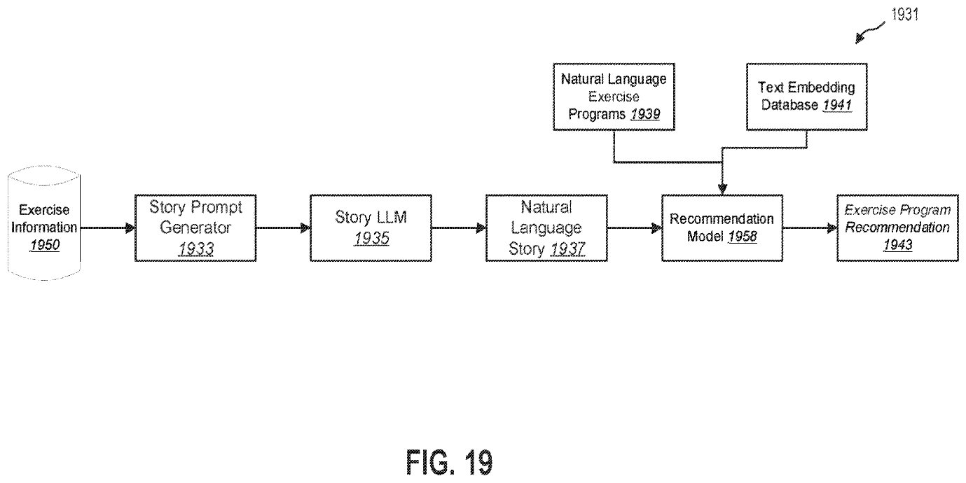

FIG. 19 is a representation of a user story generator 1931, according to at least one embodiment of the present disclosure. The user story generator 1931 may generate a user story for user exercise information 1950. A story prompt generator 1933 may receive the user exercise information 1950 and generate a story prompt. The story prompt may be input to a story LLM 1935. The story LLM may generate the natural language story 1937 based on the story prompt and the user exercise information 1950.

A recommendation model 1958 may receive the natural language story 1937 to prepare an exercise recommendation. As discussed herein, the recommendation model 1958 may be trained in natural language processing, resulting in improved analysis of the natural language story 1937. The recommendation model 1958 may further receive natural language descriptions of exercise programs 1939. In some embodiments, at least a portion of the natural language descriptions of the exercise programs 1939 may be stored or vectorized and stored in a text embedding database 1941. The recommendation model 1958 may reference the exercise programs 1939 and search the database 1941 based on the natural language story 1937 to generate an exercise program recommendation 1943. As discussed herein, the resulting exercise program recommendation 1943 may be more representative of the user exercise information 1950.

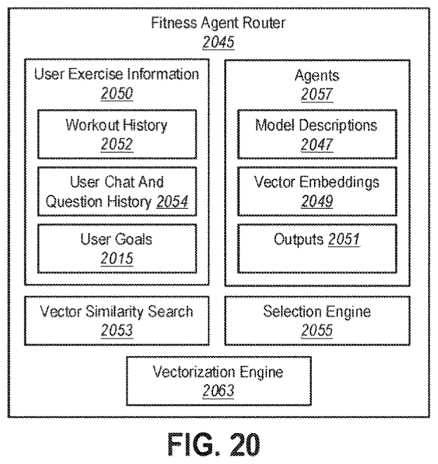

FIG. 20 is a representation of a fitness agent router 2045, according to at least one embodiment of the present disclosure. The fitness agent router 2045 may include user exercise information 2050. As discussed in further detail herein, the user exercise information 2050 may include any exercise information, including a workout history 2052, a user chat history 2054, and user goals 2015.

The fitness agent router 2045 may include or be in communication with a plurality of different foundation models or exercise agents 2057. The exercise agents 2057 may be agents of a foundation model or LLM that are trained or fine-tuned based on a particular focus or task, as discussed in further detail herein. Each of the exercise agents 2057 may include a model description 2047. The model description 2047 may be a description of which aspect the agent is specialized in or fine-tuned for. In some embodiments, the model description 2047 may be man-made. For example, a human operator may prepare and input the model description 2047 for the exercise agent 2057. In some examples, the model description 2047 may be prepared by a natural language summary agent or LLM, as discussed herein. The exercise agent 2057 may include a vector embeddings 2049 database. The vector embeddings 2049 may be vector representations of the focus or fine-tuned aspect of the exercise agent 2057. In some embodiments, the exercise agent 2057 may include a description of the outputs 2051 of the agent. For example, the exercise agents 2057 may include a description of the output 2051, a sample of the output 2051, or any other aspect or portion of the output 2051.

The fitness agent router 2045 may include a selection engine 2055. The selection engine 2055 may receive a request for an output from an agent of an LLM. The selection engine 2055 may search the exercise agents 2057 for a relevant agent. As a specific, non-limiting example, the selection engine 2055 may perform a vector similarity search 2053. The vector similarity search 2053 may search the vector embeddings 2049 of the exercise agents 2057 for similarities to the desired results. The selection engine 2055 may select a best match from the vector similarity search 2053. In some embodiments, the selection engine 2055 may select a plurality of agents based on the vector similarity search 2053. In some embodiments, the selection engine 2055 may provide the agent selections to the user and allow the user to select the desired agent.

In some embodiments, the vector embeddings 2049 may be generated by the fitness agent router 2045. For example, the fitness agent router 2045 may include a vectorization engine 2063. The vectorization engine 2063 may vectorize, or generate text representations of the text, from the model description 2047 and/or the output 2051. The vectorization engine 2063 may then store the resulting vector embeddings 2049 in a vector space. The vector space may include vectorized information for each of the exercise agents 2057.

In some embodiments, the vector similarity search 2053 may receive the vectorized input from the vectorization engine 2063. The vector similarity search 2053 may search the vector space, including the vectorized representations of the exercise agents 2057, for a closest match to the vectorized input. For example, the vector similarity search 2053 may search the vector space for which vectorized representations are closest to the vectorized input. Finding the closest match from the vectorized representations may facilitate improved accuracy and/or representation of the exercise agents 2057 associated with the closest match vectorized representations.

The vector similarity search 2053 may and select the exercise agent 2057 based on the closest match and provide the user input to the selected exercise agent 2057. In some embodiments, the vector similarity search 2053 may identify a plurality of closest matches. In some embodiments, the plurality of closest matches may all have the same search score. In some embodiments, the plurality of closest matches may have a search score that is within a search threshold.

In some embodiments, each of the exercise agents 2057 associated with the plurality of closest matches may be applied to the input. In some embodiments, the fitness agent router 2045 may present the plurality of exercise agents 2057 associated with the closest matches to the user. The user may provide a user selection of a selected exercise agent from the present exercise agents. The fitness agent router 2045 may then provide the input to the selected exercise agent.

In some embodiments, when the vector similarity search 2053 receives a request for an exercise agent, the vectorization engine 2063 may vectorize the request and any associated user exercise information 2050 into a vectorized input.

The fitness agent router 2045 may facilitate the selection of an agent that is trained or fine-tuned to prepare the best response based on the user input. This may help to improve the accuracy and/or relevance of the provided outputs and recommendations.

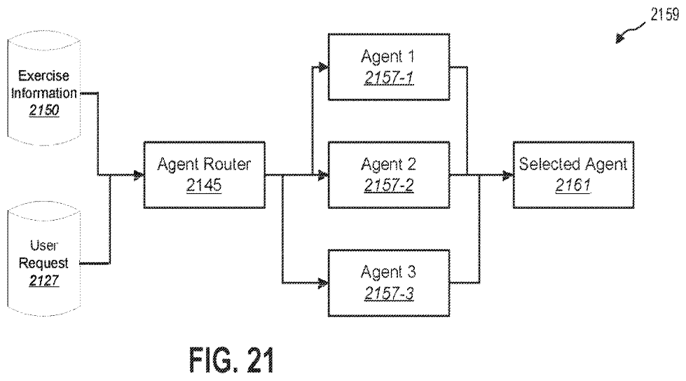

FIG. 21 is a representation of an agent selection system 2159, according to at least one embodiment of the present disclosure. An agent router 2145 may receive exercise information 2150 and a user request 2127. The exercise information 2150 may be exercise information that is relevant to the requested outcome from the LLM, based on the user request 2127. As discussed herein, the user request 2127 may include a request submitted directly by a user and/or may include requests submitted by other systems that may request an output from an agent of an LLM.

The agent router 2145 may select one or more of a plurality of LLM agents (collectively 2157). The exercise agents 2157 may be fine-tuned based on an aspect to produce a particular result or outcome. For example, in the embodiment shown, a first exercise agent 2157-1 may be fine-tuned based on a first aspect to generate a first result, a second exercise agent 2157-2 may be fine-tuned based on a second aspect to generate a second result, and a third exercise agent 2157-3 may be fine-tuned based on a third aspect to generate a third result. While three exercise agents 2157 are described herein, it should be understood that the agent router 2145 may identify and select an agent 2157 from any number of agents, including 2, 3, 4, 5, 6, 7, 8, 9, 10, 15, 20, 30, 40, 50, 100, 200, 500, 1,000, 5,000, or any number therebetween.

The agent router 2145 may select one of the exercise agents 2157, resulting in a selected agent 2161. When the agent router 2145 selects the selected agent 2161, the agent router 2145 may forward a prompt and/or the exercise information 2150 and the user request 2127 to the selected agent 2161. In this manner, the selected agent may generate an output that is more accurate and/or more relevant to the user's request.

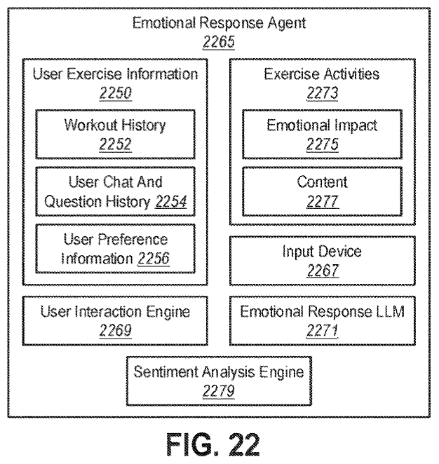

FIG. 22 is a representation of an emotional response agent 2265, according to at least one embodiment of the present disclosure. The emotional response agent 2265 may receive user input, identify emotional content and/or sentiment in the user input, and provide an output that is emotionally responsive to the user's input emotions. In this manner, the emotional response agent 2265 may generate improved accuracy and/or responsiveness to the user's input.

The user may enter an input to an input device 2267. The input may be any type of input. For example, the input may include text input, video input, image input, exercise information, any other type of input, and combinations thereof. In some embodiments, the input device 2267 may include any type of input device, such as a user device (e.g., a mobile device, computing device), a wearable device, an exercise device, any other input device, and combinations thereof.

In some embodiments, the user may enter the input to a user interaction engine 2269. The user interaction engine 2269 may interact with the user. For example, the user interaction engine 2269 may include a chatbot that may engage in a natural language conversation with the user. The user may input text input and the user interaction engine 2269 may provide an output in the chatbot. The text input may include any type of text input, including written words, emojis, sentences, paragraphs, images, gifs, videos, speech-to-text text input, any other text input, and combinations thereof.

A sentiment analysis engine 2279 may analyze the text input and identify emotional content in the text input. The emotional content may include an input emotion. The sentiment analysis engine 2279 may include any system to identify the emotional content or sentiment of the text input. For example, the sentiment analysis engine 2279 may identify the emotional content and/or the input emotion using an emotional trigger. The emotional trigger may include any emotional trigger, such as a word, an emoji, an image, a word combination, a user picture, a user video, user dialog, any other emotional trigger, and combinations thereof. In some embodiments, the sentiment analysis engine 2279 may include a foundation model trained in emotional content recognition. In some embodiments, the sentiment analysis engine 2279 may vectorize the text input to a vectorized text input and identify the emotional content based on the vectorized text input.

The sentiment analysis engine 2279 may provide the emotional content, including the input emotion, to an emotional response LLM 2271. The emotional response LLM 2271 may analyze the text input, the emotional content, and the input emotion, and generate an exercise recommendation based on the emotional content and the input emotion.

In some embodiments, the emotional response LLM 2271 may receive and/or retrieve context information to prepare the exercise recommendation. The context information may include any context information. For example, the context information may include user exercise information 2250. As discussed in further detail herein, the user exercise information 2250 may include any type of user exercise information, include user workout history 2252, user chat history 2254, user preference information 2256, any other user information, and combinations thereof. Receiving context information at the emotional response LLM 2271 may facilitate more accurate and/or more representative exercise recommendations tailored to the user by the emotional response LLM 2271.

In some embodiments, the emotional response LLM 2271 may reference exercise activities 2273 for the exercise recommendation. The exercise activities 2273 may include exercise activity information. For example, the exercise activities 2273 may include an emotional impact 2275 of the exercise activity. The emotional impact 2275 may be based on any information. For example, the emotional impact 2275 may be based on content 2277 of the exercise activities 2273. The content 2277 of the exercise activities 2273 may be any type of content 2277, including exercise type, exercise intensity, trainer identify, exercise program transcript, any other content, and combinations thereof. In some embodiments, the emotional impact 2275 may be at least partially based on user reviews of the exercise activities 2273. In some embodiments, the emotional impact 2275 may be based on the language from other users from the user reviews. For example, emotional impact 2275 of the user reviews may be based on how users reported the exercise activities 2273 made them feel.

The emotional response LLM 2271 may identify complementary emotions for the exercise activity. The exercise recommendation may be selected based on the complementary emotions. For example, the exercise recommendation may be selected to incorporate an output emotion that is complementary to the identified input emotion. The output emotion may be the emotion that is induced by the exercise activity in the exercise recommendation. In some embodiments, the output emotion may be identified based on the emotions that people typically experience and/or the emotions that are intentionally induced in the exercise activities 2273.

The emotional response LLM 2271 may provide the exercise recommendation having the output emotion that is complementary to the input emotion. In some embodiments, the output emotion may be responsive to the input emotion. For example, if the sentiment analysis engine 2279 identifies the input emotion as sad or depressed, the output emotion may be uplifting, happy, or upbeat. In some examples, if the sentiment analysis engine 2279 identifies the input emotion as unmotivated, the output emotion may be motivating. In some examples, if the sentiment analysis engine 2279 identifies the input emotion as angry, the output emotion may be energetic. In some embodiments, the output emotion may be an emotion inducing activity. For example, the emotion inducing activity include a topic of conversation by the trainer in the exercise activity.

While specific complementary emotions have been discussed herein, it should be understood that any output emotion or emotion inducing activity may be paired with any input emotion. For example, different users may have different emotional reactions to different content, desire different emotional pairings, or have otherwise different emotional experiences. Using the context gained from the user exercise information 2250, the emotional response LLM 2271 may identify complementary emotions that are tailored to the user.

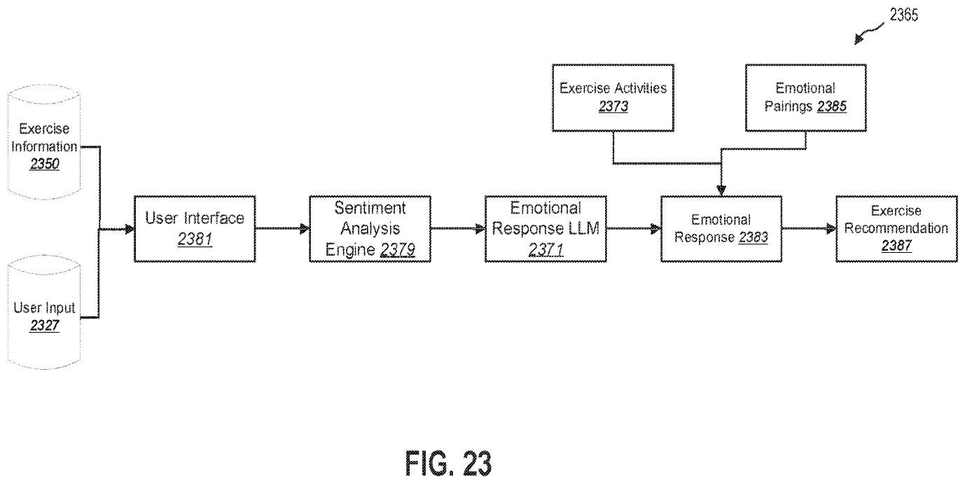

FIG. 23 is a representation of emotional response system 2365, according to at least one embodiment of the present disclosure. A user may enter, into a user interface 2381, user input 2327 and exercise information 2350. As discussed herein, the user input 2327 may include text input. A sentiment analysis engine 2379 may identify emotional content, including an input emotion, in the text input.

An emotional response LLM 2371 may receive the text input and the input emotion and prepare an emotional response 2383 based on the user input. The emotional response 2383 may include a complementary emotion to the input emotion. The emotional response 2383 may be based on one or more exercise activities 2373. In some embodiments, the emotional response 2383 may be based on pre-determined emotional pairings 2385. The pre-determined emotional pairings 2385 may include complementary emotions and/or complementary emotional responses. Using the emotional response 2383, the emotional response LLM 2371 may generate the exercise recommendation 2387 to send to the user, with the exercise recommendation 2387 including and/or inducing the emotional response in the user.

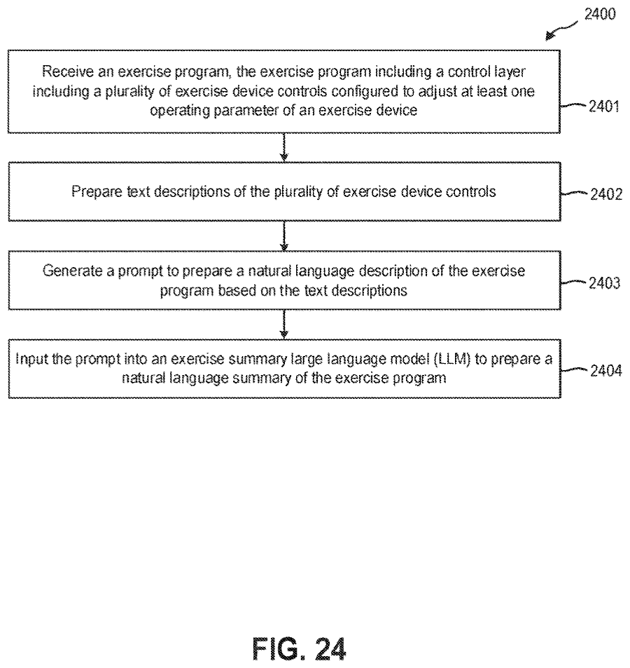

FIG. 24-30, the corresponding text, and the examples provide a number of different methods, systems, devices, and computer-readable media of the systems discussed herein. In addition to the foregoing, one or more embodiments can also be described in terms of flowcharts comprising acts for accomplishing a particular result, as shown in FIG. 24-30. FIG. 24-30 may be performed with more or fewer acts. Further, the acts may be performed in differing orders. Additionally, the acts described herein may be repeated or performed in parallel with one another or parallel with different instances of the same or similar acts.

As mentioned, FIG. 24 illustrates a flowchart of a series of acts or a method 2400 for generating exercise program summaries, according to at least one embodiment of the present disclosure. While FIG. 24 illustrates acts according to one embodiment, alternative embodiments may omit, add to, reorder, and/or modify any of the acts shown in FIG. 24. The acts of FIG. 24 can be performed as part of a method. Alternatively, a computer-readable medium can comprise instructions that, when executed by one or more processors, cause a computing device to perform the acts of FIG. 24. In some embodiments, a system can perform the acts of FIG. 24.

A foundation model may receive an exercise program at 2401. The exercise program may include a control layer including a plurality of exercise device controls configured to adjust at least one operating parameter of an exercise device. The foundation model may prepare text descriptions of the plurality of exercise device controls at 2402. The foundation model may generate a prompt to prepare a natural language description of the exercise program based on the text descriptions at 2403. The foundation model may input the prompt into an exercise summary LLM to prepare a natural language summary of the exercise program at 2404. As discussed in further detail herein, generating the natural language summaries of the exercise programs may facilitate the vectorization of the natural language summary to improve searchability and applicability of the exercise programs by other large language models.

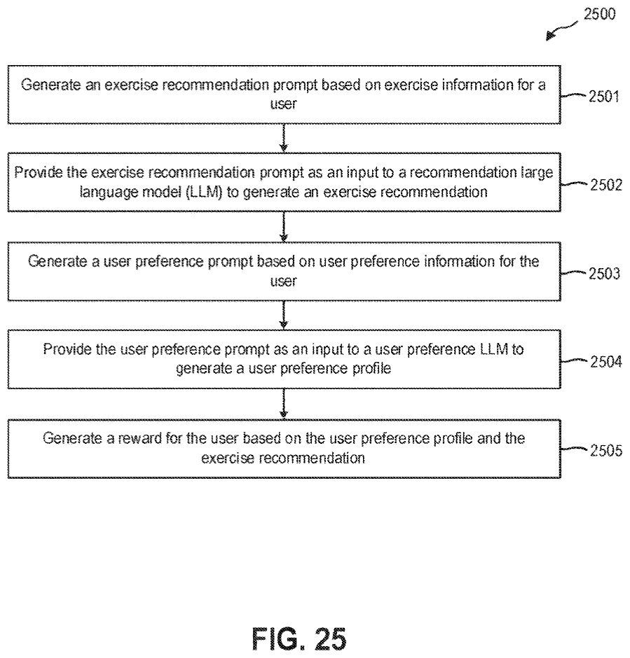

As mentioned, FIG. 25 illustrates a flowchart of a series of acts or a method 2500 for generating a customized reward for a user, according to at least one embodiment of the present disclosure. While FIG. 25 illustrates acts according to one embodiment, alternative embodiments may omit, add to, reorder, and/or modify any of the acts shown in FIG. 25. The acts of FIG. 25 can be performed as part of a method. Alternatively, a computer-readable medium can comprise instructions that, when executed by one or more processors, cause a computing device to perform the acts of FIG. 25. In some embodiments, a system can perform the acts of FIG. 25.

A prompt generator may generate an exercise recommendation prompt based on exercise information for a user at 2501. The exercise recommendation prompt may be provided as an input to a recommendation LLM to generate an exercise recommendation at 2502. A prompt generator may generate a user preference prompt based on user preference information for the user at 2503. The user preference prompt may be proved as an input to a user preference LLM to generate a user preference profile at 2504. A reward model may generate a reward for the user based on the user preference profile and the exercise recommendation at 2505. As discussed herein, this may improve the engagement of the user in exercise programs.

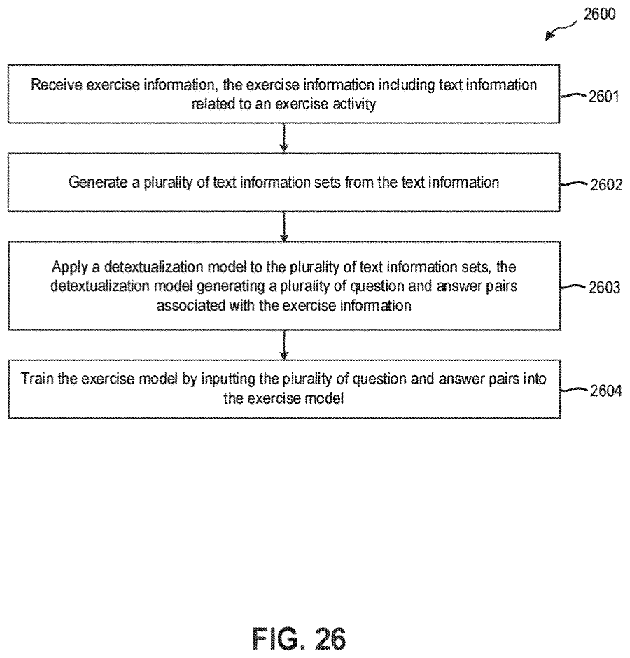

As mentioned, FIG. 26 illustrates a flowchart of a series of acts or a method 2600 for training a foundation model, according to at least one embodiment of the present disclosure. While FIG. 26 illustrates acts according to one embodiment, alternative embodiments may omit, add to, reorder, and/or modify any of the acts shown in FIG. 26. The acts of FIG. 26 can be performed as part of a method. Alternatively, a computer-readable medium can comprise instructions that, when executed by one or more processors, cause a computing device to perform the acts of FIG. 26. In some embodiments, a system can perform the acts of FIG. 26.

An exercise information system may receive exercise information at 2601. The exercise information may include text information related to an exercise activity. A text separation engine may generate a plurality of text information sets from the text information at 2602. A detextualization model may be applied to the text information sets at 2603. The detextualization model may generate a plurality of question-and-answer pairs associated with the exercise information. A training manager may train the exercise model by inputting the plurality of question-and-answer pairs into the exercise model at 2604. This fine-tuning of the exercise model may increase the accuracy and/or relevance of the exercise model.

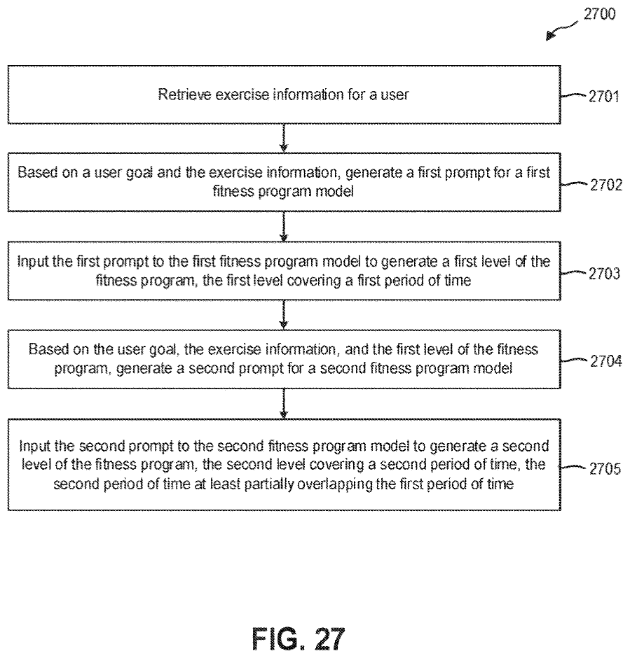

As mentioned, FIG. 27 illustrates a flowchart of a series of acts or a method 2700 for generating a fitness program, according to at least one embodiment of the present disclosure. While FIG. 27 illustrates acts according to one embodiment, alternative embodiments may omit, add to, reorder, and/or modify any of the acts shown in FIG. 27. The acts of FIG. 27 can be performed as part of a method. Alternatively, a computer-readable medium can comprise instructions that, when executed by one or more processors, cause a computing device to perform the acts of FIG. 27. In some embodiments, a system can perform the acts of FIG. 27.

A fitness program generator may retrieve exercise information for a user at 2701. Based on a user goal and the fitness information, a first prompt generator may generate a first prompt for a first fitness program at 2702. The first prompt may be input to the first fitness program model to generate a first level of the fitness program at 2703. The first level covers a first period of time. Based on the user goal, the exercise information, and the first level of the fitness program, a second prompt generator may generate a second prompt for a second fitness program model at 2704. The prompt generator may input the second prompt to the second fitness program model to generate a second level of the fitness program at 2705. The second level may cover a second period of time. The second period of time may at least partially overlap the first period of time. The resulting fitness program may be customized to the user and the user's goals.

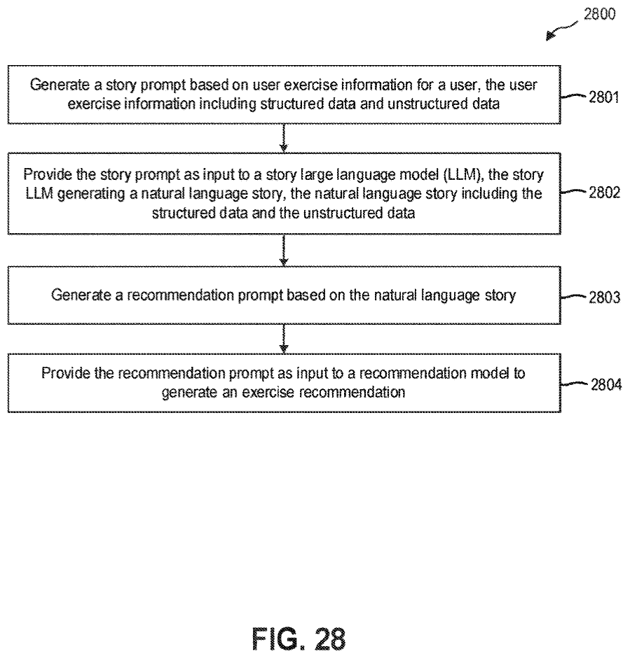

As mentioned, FIG. 28 illustrates a flowchart of a series of acts or a method 2800 for generating a natural language story of a user, according to at least one embodiment of the present disclosure. While FIG. 28 illustrates acts according to one embodiment, alternative embodiments may omit, add to, reorder, and/or modify any of the acts shown in FIG. 28. The acts of FIG. 28 can be performed as part of a method. Alternatively, a computer-readable medium can comprise instructions that, when executed by one or more processors, cause a computing device to perform the acts of FIG. 28. In some embodiments, a system can perform the acts of FIG. 28.

A prompt generator may generate a story prompt based on user exercise information for a user at 2801. The user exercise information may include structured and unstructured data. The prompt generator may provide the story prompt as input to a story LLM at 2802. The story LLM may generate a natural language story. The natural language story includes the structured and unstructured data. A second prompt generator may generate a recommendation prompt based on the natural language story at 2803. The second prompt generator may provide the recommendation prompt as input to a recommendation model to generate an exercise recommendation at 2804.

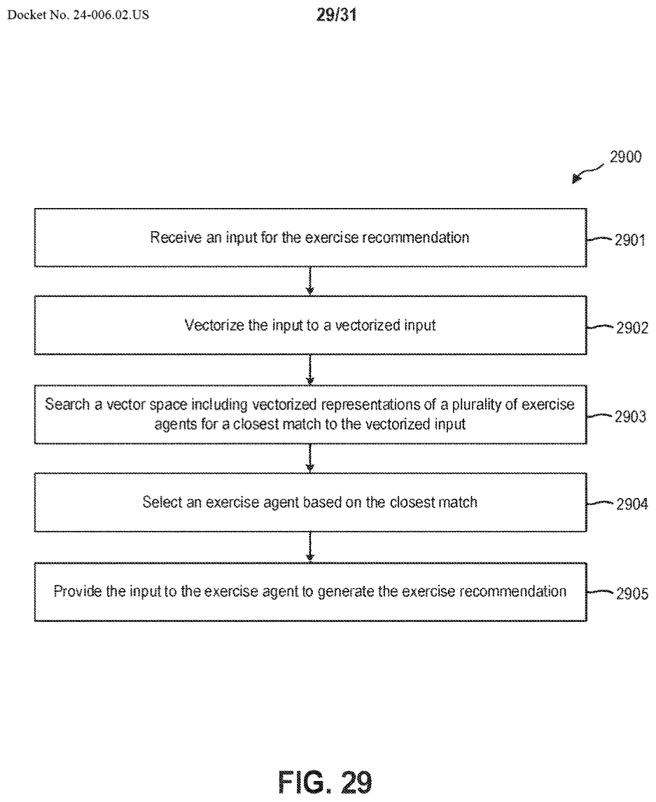

As mentioned, FIG. 29 illustrates a flowchart of a series of acts or a method 2900 for selecting an exercise agent, according to at least one embodiment of the present disclosure. While FIG. 29 illustrates acts according to one embodiment, alternative embodiments may omit, add to, reorder, and/or modify any of the acts shown in FIG. 29. The acts of FIG. 29 can be performed as part of a method. Alternatively, a computer-readable medium can comprise instructions that, when executed by one or more processors, cause a computing device to perform the acts of FIG. 29. In some embodiments, a system can perform the acts of FIG. 29.

An agent router may receive an input for an exercise recommendation at 2901. The agent router may vectorize the input to a vectorized input at 2902. The agent router may search a vector space including vectorized representations of a plurality of agents for a closest match to the vectorized input at 2903. The agent router may select an exercise agent based on the closest match at 2904. The agent router may provide the input to the selected exercise agent to generate the exercise recommendation at 2905.

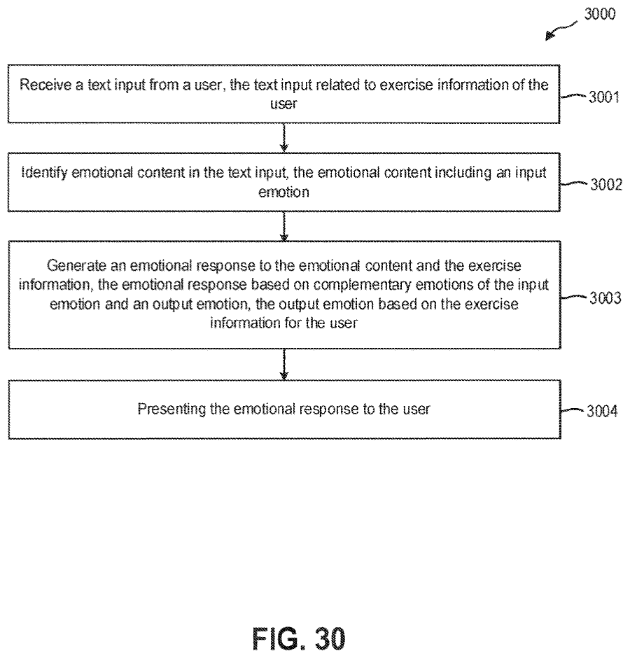

As mentioned, FIG. 30 illustrates a flowchart of a series of acts or a method 3000 for generating an emotional response in an exercise recommendation, according to at least one embodiment of the present disclosure. While FIG. 30 illustrates acts according to one embodiment, alternative embodiments may omit, add to, reorder, and/or modify any of the acts shown in FIG. 30. The acts of FIG. 30 can be performed as part of a method. Alternatively, a computer-readable medium can comprise instructions that, when executed by one or more processors, cause a computing device to perform the acts of FIG. 30. In some embodiments, a system can perform the acts of FIG. 30.

An emotional response agent may receive a text input from a user at 3001. The text input is related to exercise information for the user. The emotional response agent may identify emotional content in the text input at 3002. The emotional content includes an input emotion. The emotional response agent may generate an emotional response to the emotional content and the exercise input at 3003. The emotional response is based on complementary emotions of the input emotion and an output emotion. The output emotion is based on exercise information for the user. The emotional response agent may present the emotional response to the user at 3004.

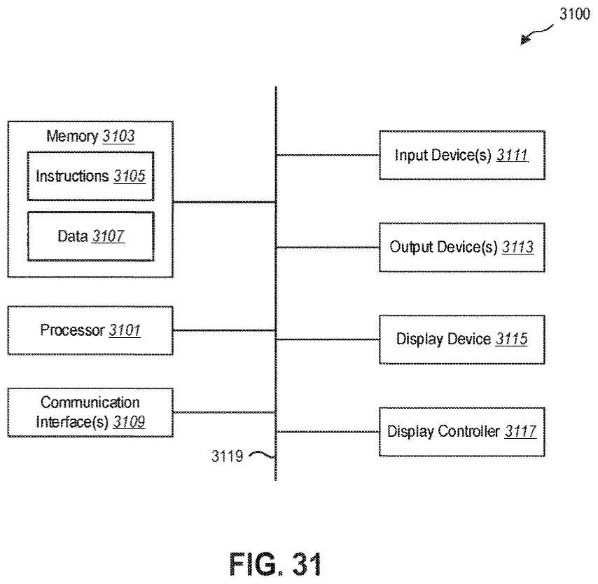

FIG. 31 illustrates certain components that may be included within a computer system 3100. One or more computer systems 3100 may be used to implement the various devices, components, and systems described herein.

The computer system 3100 includes a processor 3101. The processor 3101 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 3101 may be referred to as a central processing unit (CPU). Although just a single processor 3101 is shown in the computer system 3100 of FIG. 31, in an alternative configuration, a combination of one or multiple processors (e.g., an ARM and DSP) could be used.

The computer system 3100 also includes memory 3103 in electronic communication with the processor 3101. The memory 3103 may be any electronic component capable of storing electronic information. For example, the memory 3103 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 3105 and data 3107 may be stored in the memory 3103. The instructions 3105 may be executable by the processor 3101 to implement some or all of the functionality disclosed herein. Executing the instructions 3105 may involve the use of the data 3107 that is stored in the memory 3103. Any of the various examples of modules and components described herein may be implemented, partially or wholly, as instructions 3105 stored in memory 3103 and executed by the processor 3101. Any of the various examples of data described herein may be among the data 3107 that is stored in memory 3103 and used during execution of the instructions 3105 by the processor 3101.

A computer system 3100 may also include one or more communication interfaces 3109 for communicating with other electronic devices. The communication interface(s) 3109 may be based on wired communication technology, wireless communication technology, or both. Some examples of communication interfaces 3109 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 3100 may also include one or more input devices 3111 and one or more output devices 3113. Some examples of input devices 3111 include a keyboard, mouse, microphone, remote control device, button, joystick, trackball, touchpad, and lightpen. Some examples of output devices 3113 include a speaker and a printer. One specific type of output device that is typically included in a computer system 3100 is a display device 3115. Display devices 3115 used with embodiments disclosed herein may utilize any suitable image projection technology, such as liquid crystal display (LCD), light-emitting diode (LED), gas plasma, electroluminescence, or the like. A display controller 3117 may also be provided, for converting data 3107 stored in the memory 3103 into text, graphics, and/or moving images (as appropriate) shown on the display device 3115.

The various components of the computer system 3100 may be coupled together by one or more buses, which may include a power bus, a control signal bus, a status signal bus, a data bus, etc. For the sake of clarity, the various buses are illustrated in FIG. 31 as a bus system 3119.

### INDUSTRIAL APPLICABILITY

This disclosure generally relates to devices, systems, and methods for utilizing one or more foundation models, to prepare improved exercise recommendations for a user. The techniques of the present disclosure receive exercise information and user interactions with an exercise system to prepare natural language summaries of various information sets, generate prompts for the foundation models, train foundation models, select appropriate foundation models, generate user incentives, and so forth. This may, in at least one embodiment, facilitate improved accuracy, relevance, and reproducibility of the results of the foundation models.

In accordance with at least one embodiment of the present disclosure, an exercise program natural language description system (also described and used herein as the “exercise program description system”) may generate a plain language description of an exercise program and/or an exercise activity. The plain language description may include a description of the various elements of the exercise program, including changes in speed, incline, flywheel resistance, weight amount, activity type, exercise equipment type, activity set count, activity repetition count, any other element of an exercise program, and combinations thereof. In some embodiments, the plain language description may integrate portions of an audiovisual program associated and/or synchronized with the exercise program. In some embodiments, the plain language description may integrate qualitative descriptions of the exercise program.

In some embodiments, the exercise program description system may prepare a text description of each portion of the exercise program. For example, the text descriptions may be prepared based on a pre-determined formula, such as “at time [t], the [feature] changes from [state 1] to [state 2],” with the bracketed elements being pulled from the control stream of the exercise program. The exercise program description system may prepare a prompt for an exercise summary LLM to prepare the natural language description. The exercise summary LLM may prepare the natural language description, generating a paragraph description of the exercise program. The natural language description may then be used for various text input and analysis. For example, the natural language description may be used to train other foundation models or inputted into text or vector search algorithms. In this manner, and in accordance with at least one embodiment of the present disclosure, the natural language description may facilitate improved indexing, searching, and selection processes of one or more natural language models.

In accordance with at least one embodiment of the present disclosure, a fitness reward system may generate personalized rewards for a user based, at least in part, on user information. Users often desire a reward system to encourage or motivate the user to perform additional exercise activities. Rewards may take any form, such as messages, achievements, virtual currency, a skin for a virtual avatar, clothing, exercise equipment, exercise accessories, financial discounts (e.g., shopping discounts, subscription discounts), digital environment features (e.g., avatars, skins, stickers, videos, soundtracks), limited-access programming, exclusive programming, contact with one or more trainers, contact with one or more other athletes, any other reward, and combinations thereof. In some embodiments, the rewards may be unique and/or tailored to the user. For example, a user preference LLM may receive user preference information in a user preference prompt. The user preference LLM may be trained to generate a user preference profile that identifies user preferences and motivations. A reward model may utilize the user preference profile to generate a reward that is tailored for the user. In some embodiments, the reward may be unique to the user. Generating a reward for the user in this manner may, in accordance with at least one embodiment, improve the accuracy and/or representativeness of the reward for the user, thereby improving user engagement and utilization of an exercise or fitness program or schedule.

In accordance with at least one embodiment of the present disclosure, an exercise information system may utilize question-and-answer sets generated from text-based exercise information to train an exercise model (e.g., an exercise LLM). For example, the text information from the exercise information may be inputted into a detextualization model. The detextualization model may generate multiple question-and-answer pairs from the text information. The question-and-answer pairs may be generated with natural language or may be generated to simulate the questions a user may ask about the subject matter of the text information. In some embodiments, the question-and-answer pairs may be directed to the same facts or information from the text information while asked and/or answered using different language or syntax. The question-and-answer pairs may be used to train the exercise model. In accordance with at least one embodiment, training the model in this manner, may improve the responsiveness and/or representativeness of the exercise model to user input related to the exercise information.

In accordance with at least one embodiment of the present disclosure, a fitness program generator may generate a customized fitness program for a user. The fitness program may be a representation of multiple distinct exercise activities performed over an extended period of time. For example, the fitness program may be a representation of exercise activities to be performed on particular days over multiple days, weeks, months, or years. The fitness program may be generated based, at least in part, on a specific user goal. For example, the fitness program may be generated to facilitate the user achieving a particular exercise target, such as a distance for an endurance race, a strength goal, a weight loss goal, a VO2 max goal, a resting heart rate goal, any other goal, and combinations thereof.

The fitness program generator may include multiple agents or LLM models. Each agent may be optimized to a particular task. For example, a first agent may be optimized to generate an overall strategic schedule that outlines the overall structure of the fitness program over a time period. A second agent may be optimized to generate a weekly exercise program schedule that outlines the structure of exercises for a week based on the overall strategic schedule. A third agent may be optimized to generate specific exercise programs based on the weekly schedule. The fitness program may generate a prompt specific to each agent and input the prompt to the agents. In accordance with at least one embodiment, utilizing multiple agents may improve the accuracy and/or relevance of the resulting fitness program, including the associated exercise programs that make up the fitness program.

In accordance with at least one embodiment of the present disclosure, a user story generator may generate a natural language story of the user using user information. For example, a prompt generator may generate a prompt for a story LLM. The prompt may include structured and unstructured data, including user exercise information, demographic information, and so forth. The prompt may be input to the story LLM, and the story LLM may generate the natural language story for the user. The natural language story may then be used as input for other LLMs. In this manner, and in accordance with at least one embodiment, the natural language story may facilitate increased accuracy and/or relevance of any resulting outputs from the relevant LLMs.

In accordance with at least one embodiment of the present disclosure, an agent router may receive input for an exercise recommendation and route the input to the most relevant agent. The input may include any type of input. For example, the input may include a request from a user, an output from an LLM, a prompt generated from an LLM, any other input, and combinations thereof. The agent router may vectorize the input and search a vector space based on the vectorized input. The vector space may include vectorized representations of multiple agents. The agent router may identify a closest match of the search. The agent router may select the agent having the closest match and route the input to the selected agent. In this manner, and in accordance with at least one embodiment, the agent router may route the input to the most relevant agent, thereby improving the accuracy and/or relevance of the response to the input.

One or more embodiments of the present disclosure provide benefits and/or solve one or more of the foregoing or other problems in the art with systems, non-transitory computer-readable media, and methods for foundation models related to exercise systems. For example, foundation models are trained on text-based and/or unstructured data. Indeed, structured data, tables, lists, and so forth may not be easily and/or accurately processed by a foundation model. One or more techniques of the present disclosure may be utilized to transform structured exercise information to a natural language description of the exercise information. This may facilitate improved training, fine-tuning, indexing, searching, and processing of the natural language descriptions by one or more foundation models, thereby, in one or more embodiments, improving the accuracy and/or relevance of foundation model outputs.

In some examples, in accordance with one or more embodiments, generating natural language summaries of users and/or exercise programs may reduce a size of the stored natural language documents. For example, a natural language summary of a user profile that summarizes structured exercise data with unstructured goal and demographic information may be a smaller input to a foundation model than both the structured data and the unstructured data. Further, a natural language summary of an exercise program may be smaller and easier to search than the entire exercise program and associated metadata. In this manner, and in accordance with one or more embodiments, natural language summaries may reduce the data and searching resources used in conjunction with foundation model processing.

In some examples, foundation models of one or more embodiments of the present disclosure may be fine-tuned to generate more accurate and/or relevant exercise rewards that are tailored to a user. Such rewards may be based, at least in part, on a user profile generated by a foundation model. The foundation model may receive a prompt to generate the user profile, and generate the user profile to include user preferences, motivations, reward-cycle mechanisms, and so forth. The resulting profile may improve the speed and/or relevance of generating the rewards for the user. In this manner, and in accordance with one or more embodiments, the relevance of the output of the foundation model may be increased, thereby improving operation of the foundation model.

In some examples, one or more embodiments of the present disclosure may be used to finetune a foundation model. A training document may include text information that is separated into information subsets. The information subsets may be used to generate detextualized question-and-answer pairs related to the subject matter. The question-and-answer pairs may include overlapping subject matter that is phrased with different language and/or syntax. This may increase the number of datapoints used to fine-tune the model based, at least in part, on the same input text information. In accordance with one or more embodiments, fine-tuning the foundation model in this manner may facilitate improved accuracy and/or relevance of the resulting outputs.

In accordance with at least one embodiment of the present disclosure, an emotional response agent may provide emotionally responsive interactions with the user. For example, the emotional response agent may identify emotions or sentiment in a user input. The emotional response agent may further incorporate user profile information, such as user preference information. Based on the emotions or sentiment within the user input, the emotional response agent may identify an emotional response to the user input. The emotional response may induce an emotional response to the user based on the input emotions. The emotional response may include exercise information. For example, the emotional response may include one or more exercise activities that may be responsive to the input emotion. In this manner, emotional response agent may provide exercise recommendations that have improved accuracy and improved relevance to the user input.

As illustrated by the foregoing discussion, the present disclosure utilizes a variety of terms to describe features and advantages of the exercise recommendation system. Additional detail is now provided regarding the meaning of such terms. For example, as used herein, the term “exercise information” (e.g., health information) refers to information related to health and/or exercise. In particular, the term exercise information may include information related to one or more exercise activities (e.g., workouts). For example, exercise information may include information related to the performance of the exercise activity, such as fitness assessment information, exercise activity type, exercise activity day (e.g., date, day of the week), exercise activity time of day, exercise device used, exercise device operating parameters (e.g., resistance, speed, incline level, weight setting), location of exercise device, exercise program duration, training plan information, any other information related to the performance of the exercise activity, and combinations thereof. In some embodiments, exercise information includes user exercise information. For example, the exercise information may include heartrate information, electrocardiogram (EKG) information, blood sugar information, blood oxygen information, any other user exercise information, and combinations thereof. In some embodiments, exercise information includes user lifestyle or habit information. For example, user lifestyle or habit information may include sleep information (e.g., duration, time, quality), diet and nutrition information (e.g., food eaten, supplements taken, time of meals), work details, any other user lifestyle or habit information, goal information, and combinations thereof. In some embodiments, exercise information includes qualitative user exercise information. For example, qualitative user exercise information may include stress levels, pain levels, fatigue levels, attitude levels, motivation levels, any other qualitative user exercise information, and combinations thereof.

As used herein, a “foundation model” refers to an artificial intelligence (AI) or machine learning (ML) model that is trained to generate an output in response to an input based on a large dataset. The present disclosure may interchangeably refer to foundation models as AI models or ML models. A foundation model may be formed using a neural network having a significant number of parameters (e.g., billions of parameters). The foundation model may utilize the parameters to perform a task or otherwise generate an output based on an input. In one or more embodiments described herein, a foundation model is trained to generate a response to a query. In some implementations, a foundation model refers to an LLM. The foundation model be trained in any manner. For example, the foundation model may be trained on pattern recognition and text prediction. For example, the foundation model may be trained to predict the next word of a particular sentence or phrase. In one or more implementations described herein, the foundation model refers specifically to an LLM, though other types of foundation models may be used in generating responses to input queries.

The foundation models of the present disclosure may utilize one or more mechanisms to incorporate information that is external to the training dataset used to train the associated model. For example, the foundation models of the present disclosure may utilize RAG to incorporate external knowledge sources. RAG may provide a way for a foundation model to incorporate new information without extensive retraining of the foundation model. The RAG may include an external database. When a query or prompt is received, the foundation model may retrieve associated information. In some embodiments, the associated information may be identified by context in the prompt to the foundation model. In some embodiments, when the information is retrieved, the foundation model may augment the information using the foundation model's processes. This may help to ensure that the foundation model does not solely rely on the knowledge from the training database. In some embodiments, the foundation model may generate the resulting output based on the foundation, resulting a more reliable, contextually appropriate, and trustworthy response.

As used herein, a chatbot may be a foundation model or an ML model that is trained in natural language algorithms to provide queries to a user and receive responses to the queries. The chatbot may be trained in natural language algorithms that may simulate a human interaction. For example, the chatbot may be trained to generate and present a query using syntax, verbs, nouns, and other grammatical elements to provide information and request information as a human being would. The chatbot may be trained to collect information based on an input dataset, such as the exercise information discussed herein. In some embodiments, the chatbot analyzes the input dataset, identify initial patterns in the input dataset, and request additional information to complete the pattern analysis. In some embodiments, the chatbot receives the pattern analysis from a different ML model, such as an exercise analysis model, health habit model, or other ML model. The chatbot may be interactive. For example, the chatbot may be trained to analyze the received response and generate additional content to provide the user. Such content may include recommendations, additional queries, motivational information, any other content, and combinations thereof.

As used herein, an agent of a foundation model may be a particular implementation of a foundation model trained and fine-tuned to perform a particular task. For example, an agent may receive prompts or queries and generate responses based on the specific fine-tuning of the agent. Utilizing an agent may facilitate improved accuracy and/or relevance of responses from a general foundation model Agents may be trained to perform any particular task. For example, and in accordance with one or more embodiments of the present disclosure, agents may be trained to generate prompts, generate user-specific rewards, create natural language summaries of users, create natural language summaries of exercise programs, create exercise programs, create fitness programs, create schedules of exercise programs and/or fitness programs, create question-and-answer sets, generate health and/or exercise recommendations, perform any other task, and combinations thereof.

As used herein, a recommendation model may refer to a foundation model that is trained to generate health or exercise recommendations based on an input dataset. The input dataset may include exercise information and/or historical exercise information. Historical exercise information may include any exercise information previously collected. In some embodiments, historical exercise information includes exercise information related to exercise activities prior to the most recent exercise activities. In some embodiments, historical exercise information includes daily exercise information for a period of time (e.g., one day, one week, one month, one year, multiple years). The recommendation model may be trained on a recommendation training dataset. The recommendation training dataset may include exercise information from people that exhibit positive exercise habits and/or have met previously set exercise goals or health habit goals. The recommendation model may receive the exercise information for a user and compare the user's exercise information, exercise goals, and health habit goals to the patterns identified by the recommendation model. The recommendation model may provide behavioral changes for the user to implement to meet his or her goals.

As used herein, an exercise recommendation may be used to refer to any recommendation to improve a user's health, including a recommendation to improve health habits and/or exercise consistency. For example, the exercise recommendation may include a change in behavior that may be associated with a user's health habits. In some examples, the exercise recommendation may include a change in environment. In some examples, the exercise recommendation may include any change in time of day for exercise, a change in exercise activity duration, a change in exercise activity intensity, a change in trainer, a change in exercise activity location, any other change in behavior or environment, and combinations thereof.

In some embodiments, the exercise recommendation is an informational recommendation and/or a motivational recommendation. For example, the exercise recommendation may include environmental information, habit stacking, a reward cycle, educational material, a diet and nutrition recommendation, any other information, motivational messages, and combinations thereof. The motivational recommendation may be any type of motivation for a user, such as an exercise program type, a fitness goal, a motivational message, a reward, an incentive, any other motivational recommendation, and combinations thereof. The environmental information may include any type of environmental information, such as locations for exercise, exercise apparel, people to exercise with, music type, music playlists, trainer ID, any other environmental information, and combinations thereof. In some examples, the educational material may include process-oriented education (e.g., changes in a series of activities leading to and/or during an exercise activity). In some examples, the educational material may include consistency education.

As used herein, an exercise program may be a representation of an exercise activity that a user is to perform. The exercise activity may be any type of exercise activity. For example, the exercise activity may be performed in conjunction with exercise equipment. In some examples, the exercise activity may be performed without exercise equipment, such as a body-weight exercise, yoga, running, plyometrics, calisthenics, and so forth. The exercise program may include instructions to perform the exercise activity. The instructions may be any type of instructions. For example, the instructions may include instructions to adjust one or more settings of an exercise device for a period of time. The instructions to adjust the settings of the exercise device may be stored on a control layer having a plurality of exercise device controls. The control layer may be separate from any audiovisual layers in the exercise program. In some examples, the instructions may include instructions, or exercise device controls, to perform the activity without an exercise device, such as number of repetitions, number of sets, distance, speed, route, positions, exercises, any other instructions, and combinations thereof. The control layer may include any number or type of exercise device controls, including exercise device controls related to speed, resistance, incline, and so forth. The exercise device controls may be executable by the exercise device to adjust operation of the exercise device. The exercise program may include audio and/or video information. For example, the exercise program may include audio and/or video of a trainer performing the exercise activity, verbal, video, or pictorial instructional information, music, third-party media (e.g., movies, television shows, streaming audio and/or visual media), any other audio and/or video information, and combinations thereof. The exercise program may synchronize the audio and/or video information with the exercise instructions. In some embodiments, the exercise program may include any combination of settings, exercise devices, exercise activities, and so forth, for any duration of time.

As used herein, a fitness program may be a combination of exercise programs scheduled to be performed at different times and/or different days. For example, a fitness program may include a different exercise program to be performed on different days, different exercise programs to be performed on the same day, the same exercise program to be performed on different days, the same exercise program to be performed multiple times on the same day, and combinations thereof. In some examples, a fitness program may be directed toward a particular fitness goal. The fitness goal may be any fitness goal. For example, the fitness goal may be performance-based, such as performing to a particular performance standard (e.g., speed, time, pace, weight), participating in a particular event (e.g., a race, competition, travel), performing a particular feat (e.g., hiking a mountain, biking a particular route, swimming an open-water swim, yoga poses), any other performance standard, and combinations thereof. In some examples, the fitness goal may be image or body based, such as a clothing size goal, a body-part size goal, muscle definition goal, fat loss goal, fat distribution goal, any other personal image or body-based goal, and combinations thereof. In some examples, the fitness goal may be a physiological goal, such as a particular VO2 max, resting heartrate, blood cholesterol level, blood sugar levels, other blood chemistry, a weight loss goal, a weight gain goal, any other physiological goal, and combinations thereof. The fitness program may include any other health and fitness information. For example, the fitness program may include dietary information, stretching information, meditation information, wellness information, mindfulness information, any other health and fitness information, and combinations thereof.

As used herein, fine-tuning a foundation model may be a process of training a pre-existing model to perform a specific task. In the context of a foundation model, fine-tuning may include training the foundation model based on particular language processing tasks. Examples of fine-tuning include sentiment analysis, question answering, text classification, and so forth. Fine-tuning may include multiple steps or actions. For example, fine-tuning may include pre-training. Pre-training is typically performed by a large company, resulting in generic foundation model that may be utilized by multiple groups or in multiple situations. However, it should be understood that any company may pre-train a foundation model. Fine-tuning may be based on task-specific information, such as subject-matter specific information, labeled information, pre-categorized information, and so forth. The pre-trained model may then be fine-tuned by inputting the task-specific information. The foundation model may adjust the weights of the various parameters.

As used herein, a “prompt” is an input to a foundation model to achieve a requested outcome. A prompt may include a request for information, a request for analysis, context information, a direction to a particular agent of a foundation model, and so forth. A prompt may be generated in any manner. For example, a prompt may be generated by a user asking a question. In some examples, a prompt may be generated by a computing system requesting information from a foundation model or an agent of a foundation model. In some examples, the foundation model identifies the context of the query using the prompt.

As used herein, vectorizing (also called text embedding) is a process that includes converting or transforming text data to numerical vectors. In natural language processing, vectorizing text may be performed to generate numerical representations of words, sentences, paragraphs, sections, chapters, or other groupings of text. The vectorized input may be stored in a vector space, which may be a storage or a database that included the vectorized input and is searchable by foundation models or other AI or ML models. Vectorizing may be applied to any input. For example, any type of text input may be vectorized, including user input, natural language summaries, the output of another foundation model, and so forth.

An exercise system may interact with, generate and provide exercise and health recommendations, prepare summaries of information, prepare rewards, and otherwise interact with the user based on exercise information collected by and from the user. The exercise system may collect exercise and health information from the user using one or more user devices. The user devices may include any type of user device. For example, the user devices may include one or more mobile devices, such as mobile phones or tablets. In some examples, the user devices may include one or more wearable devices. The wearable devices may be any type of wearable device, such as a smartwatch, a smart ring, a sleep monitor, a heartrate monitor, any other type of wearable device, and combinations thereof. In some examples, the user devices may include a computing device, such as a laptop computer, a desktop computer, a server computer, any other computing device, and combinations thereof. In some embodiments, the user devices include any other type of device, such as medical devices, GPS trackers, pedometers, any other user devices, and combinations thereof.

In some embodiments, the exercise system collects exercise and health information from one or more exercise devices. The exercise devices may include any type of exercise device. For example, the exercise devices may include a treadmill, elliptical machines, stationary bicycles, rowers, cable exercise devices, weight devices, any other exercise device, and combinations thereof. The exercise devices may implement exercise programs. For example, the exercise devices may include a display that displays a video and adjust one or more operating parameters of the exercise device that are synchronized with the video. In some embodiments, the exercise devices integrate or include one or more user devices. For example, the exercise devices may be in communication with the user devices to receive exercise programs. In some examples, the user devices may implement a portion of the exercise program, such as a display of a user device providing the display for the exercise device.

The user devices may be in communication with the exercise devices, an exercise database, and one or more foundation models over an exercise network. The exercise network may be any type of network. For example, the exercise network may be a local area network (LAN), a wide area network (WAN), a Wi-Fi network, a cellular network, any other network, and combinations thereof. The exercise network may include any type of connection between the various devices and elements of the exercise system, including Wi-Fi connections, Bluetooth connections, Zigbee protocol connections, near field communication (NFC) connections, any other type of wireless connection, and combinations thereof.

The exercise system may include an exercise database. The exercise database may include information related to various aspects of the exercise system. For example, the exercise database may include exercise programs, including the audiovisual content of the exercise programs, control stream information of the exercise programs, summaries of the exercise programs, titles of the exercise programs, descriptions of the exercise programs, and so forth.

The exercise database may further include user profiles of one or more users. The user profile may include any user information. For example, the user profiles may include an exercise history of the user. The exercise history may include exercise information related to the user, including historical exercise activities performed, historical exercise activities started but not completed (e.g., completion information for the user), physiological parameters of the user, including physiological parameters related to the previously performed exercise activities (e.g., heart rate, VO2 max), any other exercise information, and combinations thereof. The user profiles may further include text data related to the user. The text data may include any type of text data. For example, the text data may include historical interactions with a chatbot, a chat history, questions asked and answered from a trainer, user goal information, demographic information for the user, user profile information, physical information, any other user information, and combinations thereof. In some embodiments, the user profiles may include any other user information, including image information, exercise program rating information, correlations between exercise program ratings and exercise program features, correlations between completed exercise programs and exercise program features, friend information, social media information, marketing information, user recommendations to other users, any other user information, and combinations thereof.

The exercise database may include other exercise information. For example, the exercise database may include exercise literature. The exercise literature may include information related to the performance of exercise activities or exercise programs. For example, the exercise literature may include instructional information on how to perform a particular exercise activity. In some examples, the exercise literature may include nutrition information. In some examples, the exercise literature may include training strategies. In some examples, the exercise literature may include academic literature, such as academic articles from peer-reviewed academic journals. In some examples, the exercise literature may include digital representations of print publications (e.g., books, magazines). In some examples, the exercise literature may include internet publications, such as blog posts (text, image, and video), websites, social media accounts, exercise schedules, trainer information, trainer identity, any other exercise literature, and combinations thereof.

The exercise system may include one or more foundation models. The foundation models may include any type of foundation model, LLM, AI model, ML model, or any other model discussed herein. The foundation models may receive and/or retrieve information from any source. For example, the foundation models may receive and/or retrieve information from the exercise database. In some examples, the foundation models may receive and/or retrieve information from the user devices. In some examples, the foundation models may receive and/or retrieve information from the exercise devices.

As discussed herein, the foundation models may include one or more agents. The agents may be fine-tuned or specialized to perform a particular function or to generate a particular output. As discussed in further detail herein, the foundation models and/or agents may include any type of model trained, optimized, and/or fine-tuned to perform any function. In particular, the foundation models and/or agent discussed herein may be trained and/or fine-tuned to provide an output related to exercise, health, and fitness. For example, at least one foundation model and/or agent of the present disclosure may be trained and/or fine-tuned to generate natural language descriptions of a user profile and/or exercise programs. In some examples, at least one foundation model and/or agent of the present disclosure may generate unique or customized rewards for the user. In some examples, at least one foundation model and/or agent may generate detextualized question-and-answer pairs from text information associated with exercise information, such as the exercise literature. In some examples, at least one foundation model may generate a fitness program for the user.

Each of the components of the systems described herein can include software, hardware, or both. For example, the components can include one or more instructions stored on a computer-readable storage medium and executable by one or more processors of one or more computing devices, such as a client device or server device. When executed by the one or more processors, the computer-executable instructions of the systems described herein can cause the computing device(s) to perform the methods described herein. Alternatively, the components can include hardware, such as a special-purpose processing device to perform a certain function or group of functions. Alternatively, the components can include a combination of computer-executable instructions and hardware.

Furthermore, the components of the systems described herein may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

An exercise program description system may include an exercise program database. The exercise program database may include a storage of one or more exercise programs. The exercise program database may include audiovisual data. The audiovisual data may be a representation of video stream of the exercise program, including the trainer video, trainer instructions, music, media, and so forth.

The exercise program database may further include control data. The control data may be located in a separate control stream from the audiovisual data. The control data may include exercise controls for the exercise program, including adjustments to one or more operating parameters of an exercise device. Such exercise controls may include changes to a motor speed, flywheel resistance, deck incline, weight, any other operating parameter, and combinations thereof. As discussed herein, the exercise controls may be synchronized with the audiovisual data.

In some embodiments, the exercise program database may include metadata. The metadata may include other information associated with the exercise program. For example, the metadata may include a title, a brief description, a trainer identification, an exercise type, an exercise device type, a simulated location, a simulated event, an exercise program intensity, any other exercise information, and combinations thereof.

Conventionally, an exercise program from the exercise program database is selected based on the metadata. But such selections may not identify all the desired features that the user would like in an exercise program. In accordance with at least one embodiment of the present disclosure, the exercise program description system may generate a natural language description of the exercise program. The natural language description may be accessed by one or more searching algorithms to more readily identify exercise program features desired by the user.

To generate the natural language description, a text description engine may generate text descriptions of the features of the exercise program. For example, the text description engine may generate text descriptions of the control data and/or the metadata. Such descriptions may be based on a pre-determined template. The pre-determined template may generate a sentence for each change in operating parameters from the control layer. For example, the pre-determined template may take the form of “at time [t], the [feature] changes from [state 1] to [state 2].” In this pre-determined template, [t] may be a time component or representation of the time location within the exercise program of the change in the operating parameter, [feature] may be a control component or representation of the operating parameter, and [state 1] and [state 2] may be control component representations of the state from which the operating parameter may be changed and to which the operating parameter may change. The text description engine may prepare a text description for each operating parameter in the control layer. In some embodiments, the text description engine may prepare a text description for various portions of the metadata. For example, the text description engine may extract the workout metadata from the exercise program. The text descriptions may form unstructured data from structured data. Put another way, the text descriptions may be a word-based description of structured data; as discussed herein, text-based data may be more easily and accurately processed by a foundation model.

A prompt generator may generate a prompt for an exercise summary LLM to prepare a natural language description of an exercise program based on the information in the exercise program database and the text descriptions. For example, the prompt generator may generate a prompt including the metadata and the text descriptions. The resulting prompt may be formed in natural language for input into the exercise summary LLM. The prompt may provide context for the exercise summary LLM, including information about the point of view of the exercise summary LLM and the desired output. An exemplary, non-limiting, prompt may take the form of: “You are an expert personal trainer. You are helping a client select a workout. When telling the user about a workout, give them a summary of the control changes identified in the associated workout text descriptions and use the metadata to tell them about it.” As may be seen, the prompt may incorporate or reference the text descriptions of the control changes and the metadata to request a description of a particular workout.

The prompt may be provided as input to the exercise summary LLM. The exercise summary LLM may then generate a natural language summary of the exercise program. The natural language summary of the exercise program may include a description of a particular workout using familiar language and references. For example, the natural language summary may include qualitative descriptions of the exercise program, such as “the exercise program starts with a moderate intensity,” “the exercise program incorporates a large hill in the middle,” or “the exercise program is well suited to your current marathon training schedule.” The qualitative descriptions may cover multiple exercise program control changes represented by the text descriptions, such as a summary of changes in incline over a period of time (e.g., “the slope of the hill gradually increases,” “the workout takes you through rolling hills”). In some embodiments, the qualitative descriptions may include a scenic description of the scene and/or background illustrated in the audiovisual data of the exercise program. In some embodiments, the qualitative description includes a difficulty description. In some embodiments, the qualitative description may include a summary of user ratings. In some embodiments, the qualitative description may include a summary of user reviews (e.g., “users liked the unique challenge of this program”). In some embodiments, the qualitative description may include a trainer attitude (e.g., “the trainer is motivational,” “the trainer is tough and treats you like recruits in a boot camp”).

In accordance with at least one embodiment of the present disclosure, the exercise program description system may include a vectorizing model. The vectorizing model may vectorize the natural language description of the exercise program for storage in a vector database. The vectorizing model may generate vectors, or numerical representations of one or more elements identified in the natural language description. The vectorizing model may generate, based on the natural language description, vectors that are more representative of the elements of the exercise program that are of interest to the user. The vectorizing model may store the resulting vectors in a vector database, which may be readily searched by recommendation models.

An exercise program description system may generate natural language descriptions of one or more exercise programs stored in an exercise program database. For example, as discussed herein, a text description engine may receive exercise information from the exercise program database, including exercise controls from a control layer of an exercise program, exercise program information from the metadata of the exercise program, and so forth. The text description engine may generate text descriptions of the exercise information. A prompt generator may generate a prompt based on the text descriptions and/or the metadata. An exercise summary LLM may generate a natural language summary of the exercise program.

As discussed herein, in some embodiments, a vectorizing model may optionally vectorize the natural language description of the exercise program. For example, the vectorizing model may generate vectors of the elements of the natural language model. The vectors may include numerical representations of a subject or a concept. The vectors may be stored in a vector database. Vectorizing the natural language description may facilitate improved searching or identifying of various features of a particular exercise program.

A fitness reward system may generate customized rewards and/or incentives for a future reward for a user. For example, the fitness reward system may review user exercise information and generate a user preference profile. The user exercise information may include any type of user information. For example, the user exercise information may include a user's workout history. The workout history may include completion information for the user. For example, the workout history may include a historical record of exercise programs completed and uncompleted exercise programs (e.g., exercise programs that are not completed and/or exercise programs started but not completed), dates of completed and/or uncompleted exercise programs (e.g., when a user misses an exercise activity, based on a user missing an exercise activity), time of day of completed and/or uncompleted exercise programs, any other exercise program information, and combinations thereof. In some examples, the workout history may include physiological information for the user that is associated with the exercise program. Such physiological information may include heartrate information, VO2 max information, breathing information, calories burned, any other physiological information, and combinations thereof. In some examples, the workout history may include a record of the operating parameters of the exercise device, difficulty settings, manual changes to the exercise program, speed information, pace information, any other operating parameters, and combinations thereof.

The user exercise information may include communication information for the user. For example, the user exercise information may include user chat history. The user chat history may include a record of exercise questions asked and associated interactions with an exercise system. For example, an exercise system may include one or chatbots, question and answer services, trainer interactions, frequently asked questions (FAQs), publications, and so forth. The user's interactions with these informational elements, including access to information, questions asked, answers received, information posted, and so forth, may form the user chat history.

The user exercise information may further include user preference information. The user preference information may include a record of user preferences. User preference information may include information related to user likes, dislikes, motivations, incentives, disincentives, and so forth. The user preference information may be collected in any manner. For example, the user preference information may be collected based, at least in part, on user input from direct questions, analysis of the user chat history, tracking trends in the workout history, previous rewards, the user's social media profile(s), user gaming history, user entertainment history, historical user preference information, user media content preference, user entertainment information, preferred workout frequency, preferred workout duration, preferred workout intensity, preferred workout variety, any other user information, user rating information for historical exercise information, and combinations thereof. In some embodiments, the user preference information, including ratings and/or rating information, may be organized based on any parameter, such as exercise program parameters of historical exercise programs, including such exercise program parameters such as exercise device type, trainer identify, visual information, audio information, exercise program length, or exercise program intensity.

The fitness reward system may include a recommendation LLM. The recommendation LLM may generate exercise recommendations for the user. For example, the recommendation LLM may generate exercise recommendations based on any input, including user requests, a request from another LLM, and so forth. In accordance with at least one embodiment of the present disclosure, the recommendation LLM may search exercise programs using a vector database from vectorized natural language descriptions of an exercise program, as discussed herein. The recommended exercise programs maybe generated with an associated reward. The recommendation LLM may receive an exercise recommendation prompt based on the exercise information for the user.

A user preference LLM may generate a user preference profile for the user. For example, a prompt generator may generate a user preference prompt for the user preference LLM based on the user exercise information. The user preference LLM may generate the user preference profile based on the user preference prompt input from the prompt generator. The user preference profile may be a representation of the motivational preferences of the user.

In accordance with at least one embodiment of the present disclosure, a reward model may be applied to the user preference profile. The reward model may generate rewards based on the user preference profile that are tailored or customized to the user. Different users may be motivated by and/or respond to different reward structures. Rewards may include any type of reward, such as messages, achievements, virtual currency, a skin for a virtual avatar, clothing, exercise equipment, exercise accessories, financial discounts (e.g., shopping discounts, subscription discounts), digital environment features (e.g., avatars, skins, stickers, videos, soundtracks), a customized image, a customized video, limited-access programming, exclusive programming, contact with one or more trainers, contact with one or more other athletes, any other reward, and combinations thereof. The particular reward may be based on the user preference profile.

In some examples, the reward model may generate the customized reward for the user by selecting a particular type of reward. In some examples, the reward model may adjust the details of the type of reward to be customized for the user. For example, the reward model may generate an achievement that includes language that is specific or unique to the user. In some examples, the details of any reward from the reward model may be customized to the user.

In some embodiments, the reward model may generate the customized reward for the user based on customized circumstances and/or frequency specific to the user. For example, the reward model may identify the circumstances tied to the administration of the reward (e.g., completion of a particular exercise program, reaching of a target or goal, consistency). In some examples, the reward model may identify the frequency with which rewards are provided to the user. For example, the reward model may identify that a user may prefer regular rewards for completion of exercise activities and provide frequent rewards. In some examples, a different user may prefer milestone rewards based on the completion of milestones. In some examples, the reward model may generate reward frequency that is customized for each user. As may be understood, the reward generated by the reward model may be, at least partially, based on the completion information.

The reward model may be any type of reward model. For example, the reward model may include a direct program optimization (DPO) model. In some examples, the reward model may include a reinforcement learning from human feedback (RLHF) model. In some examples the reward model may include any model that incorporates human feedback and/or psychological principles to identify rewards and reward structures for a particular user.

In accordance with at least one embodiment of the present disclosure, the fitness reward system may update the user preference profile based on updated user preference information and/or updated user exercise information. Over time, the user's health and fitness status may change. For example, the user may complete exercise programs and/or fitness programs and improve his or her health and fitness status, the user may fail to complete exercise and/or fitness programs and reduce his or her health and fitness status, the user may become injured, sick, or otherwise unable to complete one or more exercise activities, or otherwise change his or her health and fitness status. This may result in updated user exercise information representative of the change in the health and fitness status.

In some embodiments, the user preference information may change. For example, the user's interests may change, the user may complete a goal and desire to achieve a new goal, the user may fail to complete a goal and desire to achieve a different goal, the user may try something and decide he or she does not like it, the user may otherwise experience a change in his or her preferences, and combinations thereof. In some embodiments, the updated user preference information and/or updated exercise information may be based, at least in part, on one or more exercise programs performed by the user. The fitness reward system may receive the updated user preference information. The prompt generator may generate an updated user preference prompt based on the updated user preference information. The fitness reward system may provide the updated user preference prompt to the user preference LLM to generate an updated user preference profile. The reward model may generate an updated reward for the user based on the updated user preference profile.

A fitness reward system may include a reward model that generates customized rewards for a particular user. The reward model may receive a prompt from a prompt generator to generate a reward from a user. The reward model may receive a user preference profile and/or reward information from a user preference LLM. Using the prompt and the user preference profile information, the reward model may generate a customized reward for the user. In some embodiments, the prompt generator and/or the user preference LLM may receive information from a user device. For example, the user may enter, into the user device, a request for an exercise program, user preference information, and so forth.

A recommendation LLM may receive a request for an exercise recommendation. For example, the recommendation LLM may receive the request for the exercise recommendation from a user device. The recommendation LLM may generate the exercise recommendation. As discussed herein, the exercise recommendation may include any recommendation, such as a recommendation for an exercise program, a recommendation for a fitness program, a recommendation for health information, dietary information, any other exercise recommendation, and combinations thereof.

In accordance with at least one embodiment of the present disclosure, a reward model may generate a reward based on the exercise recommendation. For example, the reward model may receive the exercise recommendation and generate a reward customized for the user based on the exercise recommendation. The customized reward may be different for different exercise recommendations and/or exercise programs.

As discussed herein, to generate the reward, the reward model may receive a prompt to generate the reward from a prompt generator and a user preference profile for the user from a user preference LLM. The reward model may utilize the prompt and the user preference profile to determine the reward that should be associated with the exercise program.

In some embodiments, the user may implement the exercise program on an exercise device, and upon completion of the exercise program, the fitness reward system may present the user with the reward. In some embodiments, the reward may be presented to the user as a potential reward pending completion of the exercise program from the exercise recommendation and provided to the user after completion. In some embodiments, the reward may be hidden from the user until the user completes the exercise program, making the reward a surprise reward.

While embodiments of the present disclosure have discussed the reward being generated prior to transmission of the exercise activity to the user and/or completion of the exercise activity by the user, it should be understood that the reward may be generated during and/or after completion of the exercise program. For example, when the user completes the exercise program, the reward model may generate the reward for the user based on the completion of the exercise program. In some examples, when the user completes the exercise program, the reward model 664 may generate the reward for the user based on how the user completed the exercise program, such as the speed, heartrate, pace, distance, weight lifted, or other completion parameter of the exercise program.

In a fitness reward system, a user device may send preference information to a user preference LLM. The user preference LLM may generate a user preference profile and transmit the user preference profile to a reward model. The reward model may generate a custom reward. The reward model may transmit the custom reward to the user device.

In some embodiments, a recommendation LLM may send an exercise recommendation to a user device. The user may perform the exercise program or exercise activity associated with the exercise recommendation.

The user device may provide exercise and completion information and user preference information to a user preference LLM. The user preference LLM may generate a user preference profile and transmit the user preference profile to a reward model. The reward model may generate a custom reward. The reward model may transmit the custom reward to the user device.

As discussed herein, in some embodiments, the reward may be generated after the user performs the exercise activity. In some embodiments, the exercise recommendation may include the reward, and the reward model may generate the reward based on confirmation of completion of the exercise recommendation.

In a fitness reward program, and as discussed herein, a user device may send preference information to a user preference LLM. The user preference LLM may generate a user preference profile and transmit the user preference profile to a reward model. The reward model may generate a custom reward system. The custom reward system may include a series of rules or guidelines based on which to generate rewards. For example, the custom reward system may identify the timing and type of reward to be given for a particular exercise activity. In some examples, the custom reward system may include rankings of rewards associated with different exercise programs, which may be an indication of which types of exercise programs may provide better rewards for the user, or rewards that may be more motivating or encouraging for the user. The reward model may transmit the custom reward system to a recommendation LLM.

The recommendation LLM may generate an exercise recommendation for the user. In some embodiments, the recommendation LLM may generate the exercise recommendation based on the custom reward system. For example, the recommendation LLM may identify exercise programs that may provide a better reward and prepare those recommendations for the user. A better reward may be considered a reward that may provide a positive emotion for the user. In some embodiments, a better reward may result in increased user engagement with an exercise system, including returning to perform additional exercise programs.

The recommendation LLM may send the exercise recommendation to the user device. The user may perform the exercise activity. When the user performs the exercise activity, the user device may send exercise and completion information to the reward model. The exercise and completion information may be a representation of the completion status and the exercise metrics measured while performing the exercise activity. The reward model may generate the reward based on the exercise and completion information and send the custom reward system to the user device.

In some embodiments, an exercise information system may include a database of exercise information. The exercise information may include any type of exercise information. In some embodiments, the exercise information includes educational information. For example, the exercise information may include information that may be used to educate or information a user about exercise topics. In some embodiments, the exercise information includes text information, such as text descriptions of exercise information. In some embodiments, the exercise information includes audio and/or visual information. In some embodiments, the text information includes a text description of the audio and/or visual information. The text information may include any type of information, including instruction information on how to perform a particular exercise activity.

The exercise information may include academic literature. The academic literature may include any type of academic literature, such as articles from academic journals and scholarly publications. The academic literature may be a representation of the state of the art for a particular exercise activity or exercise. In some embodiments, the academic literature may include print publications, such as books, magazines, and so forth.

The exercise information may further include informal publications. Informal publications may include non-traditional media, or non-print media. For example, the informal publications may include online publications, such as blog posts, website posts, serial publications, social media posts, and so forth. In some embodiments, the informal publications may be vetted for accuracy, safety, and/or representation of the associated subject matter. In some embodiments, the informal publications may include transcripts of exercise programs, including transcripts of the instructional and/or encouraging words used by the trainer in the exercise program.

In some embodiments, the exercise information may include user chat history. The user chat history may include a record of exercise questions asked and associated interactions with an exercise system. For example, an exercise system may include one or chatbots, question and answer services, trainer interactions, frequently asked questions (FAQs), publications, and so forth. The user's interactions with these informational elements, including access to information, questions asked, answers received, information posted, and so forth, may form the user chat history.

The exercise information system may further include a text separation engine. The text separation engine may separate the text information of the exercise information into discrete text information sets. The text information sets may be chunks or sections of the text information that are related to the same subject matter. In some embodiments, the text information sets may be sections of the text information that are directed to a subset of the text information. As a specific, non-limiting example, the exercise information may include an article related to the proper form to use when performing a squat. The text information may include descriptions sub-actions, the sub-actions including one or more of feet placement, feet orientation, head orientation, knee placement, knee angle at full compression, knee angle at full extension, arm placement, and so forth. The text separation engine may separate the text information into text information related to the descriptions of the sub-actions. For example, the text separation engine may generate a text information set for each of the sub-actions identified in the exercise information. The text separation engine may include any type of model. As a specific, non-limiting example, the text separation engine may include a recursive model.

The text separation engine may generate the text information sets in any manner. For example, the text separation engine may generate the text information sets based on subject matter. In some examples, the text separation engine may generate the text information sets based on a maximum length of the text information set. In some examples, the text separation engine may generate the text information sets based on a word count of the text information set. In some examples, the text separation engine may generate the text information sets based on a sentence count and/or a sentence start and end of the text information set. In some examples, the text separation engine may generate the text information sets based on a paragraph count and/or a paragraph start and end of the text information set. In some examples, the text separation engine may generate the text information set based on a combination of factors discussed herein and other factors.

The exercise information system may further include a detextualization model. The detextualization model may receive the text information sets and generate detextualized question-and-answer sets. The questions of the question-and-answer sets may ask about a particular aspect of the text information set. The answer to the question-and-answer set may provide a response to the question. In some embodiments, the detextualization model may generate multiple question-and-answer sets related to the same text information set. In some embodiments, the multiple questions may be directed to the same sub-action or aspect of the text information set. For example, two different question-and-answer sets may be directed to the same aspect or sub-action of the text information set while using different question and/or answer language, including different vocabulary, syntax, grammatical constructions, synonyms of technical terms, or other differences in questions and answers. In some examples, the question-and-answer sets may be generated using natural language to simulate different question structures that may be utilized by a particular user. For example, the detextualization model may include an analysis of different question structures, language patterns, vocabulary patterns, and so forth for different users from different demographic groups. The detextualization model may generate different question-and-answer sets based on the identified patterns. For example, the different question-and-answer pairs may include different language. The different language may be any type of different language, such as a synonym of a technical term, a different grammatical form, a different syntactical structure, any other different language, and combinations thereof. In some embodiments, the detextualization model may generate question-and-answer pairs using only information from the text information sets. In some embodiments, the detextualization model may generate a plurality of question-and-answer pairs where each question-and-answer pair is related to a different subject.

The detextualization model may be any type of model. For example, the detextualization model may be a foundation model trained or fine-tuned to analyze information and generate a natural language question based on the information. In some examples, the detextualization model may be a foundation model trained or fine-tuned to analyze information and generate an answer to a question based on the information. In some examples, the detextualization model 1096 may include any other type of model.

In some embodiments, to generate the question-and-answer sets, a prompt generator may generate a prompt requesting the question-and-answer sets from the detextualization model. The prompt may include context relevant to the question-and-answer sets. For example, the prompt may include an identification of the particular exercise information, the text information set, the question quantity of desired question-and-answer sets, a particular question and/or answer type, any other context, and combinations thereof. In some embodiments, the prompt may include context information. The context information may include any context information, such as third-party exercise information, third-party databases, and so forth.

In accordance with at least one embodiment of the present disclosure, the exercise information system may use the question-and-answer sets to train or fine-tune a foundation model, such as an exercise model or other foundation model discussed herein. For example, a training manager may input the question-and-answer sets into the foundation model or exercise model during a training or fine-tuning cycle of the foundation model. As discussed herein, generating the question-and-answer sets may increase the amount of training information. In this manner, and in accordance with at least one embodiment, utilizing the question-and-answer sets for training or fine-tuning may increase the amount of information used to train the foundation model. This may increase the number of connections the foundation model may make, thereby increasing the accuracy and/or relevance of the results of the foundation model. In some embodiments, training the foundation model with the question-and-answer sets may facilitate an improved responsiveness to factual questions from a user.

The foundation model trained by the question-and-answer sets may be any type of foundation model. For example, the foundation model may include a recommendation model that prepare recommendation recommendations of exercise activities, exercise programs, and fitness programs. In some examples, the foundation model may include a chatbot that holds conversations with a user, including answering questions. In some examples, the foundation model may include a fitness program or exercise program generator. In some examples, the foundation model may include an exercise information model trained to answer informational questions about the user. In some examples, the foundation model may include an agent router that is trained to identify a user input and route the input to an appropriate agent.

A text separation engine may receive exercise information including text information from an exercise database. As discussed herein, the text separation engine may separate the text information from the exercise database into text information sets.

A detextualization model may receive the text information sets from the text separation engine. The detextualization model may generate a plurality of question-and-answer sets for the text information sets. As discussed herein, the question-and-answer sets may be used to train a foundation model. This may help to improve the accuracy and/or relevance of outputs of the foundation model.

A text separation engine may receive text exercise information from an exercise database. The text separation engine may generate one or more text information sets. The text separation engine may send the text information sets to a detextualization model.

As discussed herein, the detextualization model may be trained to generate question-and-answer pairs. The detextualization model may send the question-and-answer pairs to a foundation model. The foundation model may utilize the pairs to fine-tune the foundation model.

A fitness program generator includes user exercise information. The user exercise information may include any type of user information. For example, the user exercise information may include a user's workout history. The workout history may include completion information for the user. For example, the workout history may include a record of exercise programs completed and/or exercise programs started but not completed, dates of completed and/or uncompleted exercise programs, time of day of completed and/or uncompleted exercise programs, any other exercise program information, and combinations thereof. In some examples, the workout history may include physiological information for the user that is associated with the exercise program. Such physiological information may include heartrate information, VO2 max information, breathing information, calories burned, any other physiological information, and combinations thereof. In some examples, the workout history may include a record of the operating parameters of the exercise device, difficulty settings, manual changes to the exercise program, speed information, pace information, any other operating parameters, and combinations thereof.

The user exercise information may include communication information for the user. For example, the user exercise information may include user chat history. The user chat history may include a record of exercise questions asked and associated interactions with an exercise system. For example, an exercise system may include one or chatbots, question and answer services, trainer interactions, frequently asked questions (FAQs), publications, and so forth. The user's interactions with these informational elements, including access to information, questions asked, answers received, information posted, and so forth, may form the user chat history.

The user exercise information may further include user goals. The user goals may include any goal for the user. For example, the user goals may include explicitly stated user goals. For example, the user may input the user goals into an input field of an application and/or provide the user goals in response to a prompt or from a chatbot or other user system interaction. The user goals may include any type of goal. For example, the user goals may include event-based goals (e.g., participate in a particular event), fitness goals (e.g., weight lifted, speed, pace, distance), health goals, weight loss goals, weight gain goals, body image goals (e.g., waist size, muscle mass), any other user goal, and combinations thereof. In some embodiments, the user goals may include goals related to the completion of a fitness program. For example, the user may input user goals that relate to a particular fitness program he or she would like to complete.

In accordance with at least one embodiment of the present disclosure, the fitness program generator may include one or more prompt generators that may generate prompts for one or more fitness program models. The fitness program models may collectively generate a fitness program for the user. As discussed herein, the fitness program may include a series of exercise programs that may be performed at different times and/or on different days. The fitness program may cover a period of time. The period of time for the fitness program may include any period of time, such as 1 day, 2 days, 3 days, 4 days, 5 days, 6 days, 1 week, 2 weeks, 3 weeks, 1 month, 2 months, 3 months, 4 months, 5 months, 6 months, 7 months, 8 months, 9 months, 10 months, 11 months, 1 year, 2 years, 5 years, or any amount of time therebetween. The fitness program may include exercise programs to be completed during the fitness program. The fitness program may include any number of exercise programs, performed with any frequency, and performed at any time of day.

In some embodiments, each exercise program of the fitness program may be different. For example, different exercise programs may have different durations, exercise activities, intensities, operating parameters, exercise devices, exercise equipment, any other different parameter, and combinations thereof. In some embodiments, two or more of the exercise programs of the fitness program may be the same. For example, two or more of the exercise programs of the fitness program may have the same duration, exercise activity, intensity, operating parameter, exercise device, exercise equipment, any other parameter, and combinations thereof.

Conventional models to generate fitness programs may experience difficulty in generating entire exercise programs. For example, the amount of information used by a foundation model to generate a fitness program may be very large. This may result in the foundation model utilizing large amount of processing resources to generate the fitness program and/or not be trained to perform all tasks of generating the fitness program. The resulting fitness program may not be representative of the user's desired exercise program and/or may include inaccurate details regarding the exercise program.

The fitness program models may include a plurality of fitness agents. The fitness agents may be trained on or fine-tuned on different aspects of a fitness program. For example, the fitness agents may be trained on or fine-tuned to generate different levels of granularity of a fitness program. A first level of the fitness program, covering a first period of time, may include the overall structure or overall schedule of the fitness program. A second level of the fitness program, covering a second period of time, the second period of time shorter than the first period of time, may include a single exercise program. In some embodiments, the second period of time is encompassed by the first period of time. In some embodiments, the first period of time is greater than the second period of time. In this manner, and in accordance with at least one embodiment, the quality of the fitness program may be improved by creating a more representative overall structure while improving the selection of exercise programs in the fitness program. For example, the overall schedule of the fitness program may be better suited to help the user reach his or her goals, with the selected exercise programs more consistent with the generated schedule.

In some embodiments, the fitness agents may generate progress milestones. For example, the overall schedule agent may generate progress milestones that are representative of anticipated progress toward the user's goal. The progress may be any type of progress, including progress directly related to the user's goal, progress unrelated to the user's goal, completion milestones, and so forth.

While two levels of granularity are discussed herein, it should be understood that the fitness program models may generate more than two levels of granularity. The levels of granularity may include any number of levels of granularity pr periods of time. For example, the levels of granularity may include an exercise program level of granularity, a daily level of granularity, a weekly level of granularity, a bi-weekly level of granularity, a monthly level of granularity, a bi-monthly level of granularity, a quarter-annual level of granularity, a bi-annual level of granularity, an annual level of granularity, any other level of granularity, and combinations thereof.

The agents of the fitness program models may be fine-tuned based on any other factor. For example, the agents of the fitness program models may be fine-tuned for particular exercise devices, exercise activities, exercise duration, exercise type, any other factor, and combinations thereof. In some embodiments, a different agent may generate the exercise program for different days. This may further facilitate improved relevance and accuracy of the resulting fitness program.

The agents of the fitness program models may be selected at a particular point in the fitness program process by an agent router. The agent router may receive an input, such as the prompt generated by the prompt generators, and identify to which agent to send the prompt, as discussed in further detail herein. The agent router may then send the input to the selected agent, and the selected agent may process the input.

In some embodiments, a fitness program complier may compile the various aspects of the fitness program into a single fitness program. For example, the fitness program complier may receive the different levels of the fitness program, including the schedule and individual exercise programs, and compile the exercise programs into a complete fitness program. This may result in a complete exercise program generated from multiple agents of the fitness program models.

In accordance with at least one embodiment of the present disclosure, an update manager may update the fitness program based on the user progress. For example, the update manager may receive updated user exercise information from the user. The updated user exercise information may include user information collected while performing the exercise program, user completion information, newly generated user chat history, newly generated and/or updated user goals. Updating the fitness program may facilitate an improved, more accurate, or more relevant fitness program for the user.

To update the fitness program, the update manager may analyze the updated user information. The update manager may determine whether the user's exercise information has varied from the fitness program. Variations from the fitness program may include any type of variation. For example, a variation from the fitness program may include identifying whether the user has met, failed to reach, or exceed a progress milestone. If the user has met the progress milestone, the update manager may determine that the fitness program may not be modified. If the user has not met the progress milestone, the update manager may determine that the fitness program should be modified. For example, if the progress milestone is exceeded, then the update manager may increase a difficulty level or intensity of the fitness program. If the progress milestone is not met, then the update manager may decrease the difficulty level or intensity of the fitness program.

In some examples, the update manager may determine that the fitness program should be updated based on user input. For example, the user may provide input that he or she is not enjoying the exercise programs, and the update manager may update the fitness program to change the exercise program types. In some examples, the user may provide input that he or she is feeling pain that may be a result of injury, and the update manager may update the fitness program based on the user's pain to prevent or reduce the severity of the injury.

The update manager may update the fitness program at any point during the fitness program. For example, the update manager may update the fitness program periodically or episodically. The update manager may update the fitness program periodically with an update period, which may be daily, weekly, bi-weekly, monthly, bi-monthly, any other update period, and combinations thereof. In some examples, the update manager may update the fitness program episodically based on the completion of certain exercise programs, based on the completion of a percentage of the fitness program, based on user input, based on trainer input, any other episodic update, and combinations thereof.

The update manager may update the fitness program in any manner. For example, the update manager may provide the update to the prompt generators, and the prompt generators may generate the associated prompts for the fitness program models. In some examples, the update manager may regenerate the entire remaining fitness program. In some examples, the update manager may update individual portions of the fitness program. For example, the update manager may cause the prompt generator for a particular agent to update that portion of the fitness program, such as an individual exercise program, multiple exercise programs, a period of time in the fitness program, or the entire fitness program. As discussed herein, updating the fitness program may result in a responsive, live fitness program that accurately and with improved relevance responds to the user's situation.

A first prompt generator of a fitness program generator may receive exercise information about a user. The first prompt generator may further receive a user request. The user request may include any request. For example, the user may input the user request into a computing system explicitly requesting the fitness program. In some examples, the user request may be identified in a chat history or other history of the user. In some examples, the user request may be input by a trainer or other third party in communication with the user. In some examples, the user request may be automatically generated by a recommendation system to provide a fitness program recommendation to the user.

The first prompt generator may generate a first prompt for a first fitness program model to generate a first level of the fitness program. As discussed herein, the first level of the fitness program may include a lower level of granularity (e.g., less detail) than other levels of the fitness program. In some examples, the prompt may include and/or reference the exercise information and/or the user request. The first prompt generator may generate the prompt tailored to the first fitness program model. For example, the prompt may be based on the focus of the first fitness program model or the agent associated with the first fitness program model. For example, if the first fitness program model provides a fitness program schedule based on a particular user goal, the first prompt generator may generate the prompt to request that the first fitness program model generates the fitness program schedule based on the exercise information and the user request. The prompt may include context information, such as the point of view of the first fitness program model (e.g., the point of view of a personal trainer).

As discussed herein, the fitness program schedule may include any schedule information. For example, the fitness program schedule may include an outline of exercise activities to perform on particular days. In some embodiments, the fitness program schedule may include outlines of duration, distance, speed, weight, intensity, any other aspect, and combinations thereof. In some embodiments, the fitness program schedule may include daily, weekly, and/or monthly targets of for these factors. By identifying the schedule or outline of exercise activities for the fitness program, the fitness program may generate long-term plans to allow the user to reach his or her goals.

In some embodiments, a second prompt generator may generate a second prompt for a second fitness program model to generate a second level of the fitness program. As discussed herein, the second level of the fitness program may have a higher level of granularity (e.g., more detail) than the first level of the fitness program. The second prompt may include and/or reference the exercise information and/or the user request. The first prompt generator may generate the second prompt tailored to the second fitness program model. For example, the prompt may be based on the focus of the second fitness program model or the agent associated with the second fitness program model. For example, if the second fitness program model provides exercise activities, the second prompt generator may generate the second prompt to request that the second fitness program model generates exercise activities based on the exercise information and the user request. In some embodiments, the second prompt may include schedule information from the fitness program schedule generated by the first fitness program model. For example, as discussed herein, the second prompt may include the schedule guidelines for particular days or weeks, including exercise activity type, duration, intensity, and so forth. Using these high-level details (e.g., lower granularity details) from the first level of the fitness program, the second fitness program model may generate exercise programs that fit or match the exercise program.

As may be understood, the first fitness program model and the second fitness program model may be trained or fine-tuned on different datasets. The different datasets may be focused on the particular aspect of the fitness program model. In some embodiments, the different datasets may include at least some overlapping material. For example, a first dataset may be related to training schedules, and a second dataset may be related to a type of exercise activities. The first dataset may include information related to different types of exercise activities, including the type of exercise activity from the second dataset. In this manner, the different datasets may include at least some overlapping material.

The exercise programs from the second fitness program model may be compiled into the first level of the fitness program to form the completed fitness program. The fitness program generator may send the completed fitness program to the user. The user may implement the various exercise programs from the fitness program, such as by implementing the exercise programs on one or more exercise devices.

A first prompt generator of a fitness program generator may receive exercise information about a user. The first prompt generator may further receive a user request. The first prompt generator may generate a first prompt for a first fitness program model to generate a first level of the fitness program using the exercise information and the user request. A second prompt generator may generate a prompt for one or more second fitness program models.

In the embodiment shown, the fitness program generator includes multiple fitness program models. The different multiple fitness program models may be fine-tuned to generate exercise programs based on the schedule outlined in the first level of the fitness program. For example, a primary second fitness model may generate exercise programs for a first exercise activity, a secondary second fitness model may generate exercise programs for a second exercise activity, and a tertiary second fitness model may generate exercise programs for a third exercise activity. In some embodiments, the second fitness models may generate different exercise programs that are directed to different exercise programs, such as different exercise types, different activity types, different informational types, any other different exercise, and combinations thereof. The resulting exercise programs may be compiled into the first layer of the fitness program to generate the completed fitness program.

A total prompt generator of a fitness prompt generator may receive exercise information about a user. The first prompt generator may further receive a user request. The total prompt generator may generate a total prompt for a total fitness program model to generate a first level of the fitness program using the exercise information and the user request. The first level of the fitness program may be a representation of the overall schedule or total schedule of the fitness program.

A weekly prompt generator may generate a weekly prompt for a weekly fitness program model. The weekly fitness program model may utilize the first level of the fitness program to generate second level representing a weekly outline or a weekly schedule for each week of the fitness program.

An activity prompt generator may generate an activity prompt for an activity fitness program model. The activity fitness program model may generate exercise programs based on the exercise activities identified in the weekly schedule generated by the weekly fitness program model. The exercise programs may be compiled into the weekly schedules, and the weekly schedules may be compiled into the total schedule, resulting in the completed fitness program.

In this manner, and in accordance with at least one embodiment of the present disclosure, the different fitness program models may generate different portions of the fitness program. For example, the total prompt generator may generate overall schedule over a training period to reach the user goal, including an outline of exercise goals for the training period. The weekly prompt generator may generate the weekly schedules within the training period, and the activity fitness program model may generate the daily exercise programs for each day for each weekly schedule of the plurality of weekly schedules. This may result in a fitness program including multiple exercise programs scheduled over a period of time.

While the embodiment described herein is described with respect to three levels of the fitness program, with each level generated by a single fitness program, it should be understood that the techniques of the present disclosure may be applied to any number of levels of a fitness program. Each level of the fitness program may include any number of fitness models or agents, as may be see with respect to the embodiment described herein. This may result in a fitness program that is customized for a user and tailored to his or her circumstances.

A first prompt generator of a fitness program generator may receive exercise information about a user. The first prompt generator may further receive a user request. The first prompt generator may generate a first prompt for a first fitness program model to generate a first level of the fitness program using the exercise information and the user request.

A second prompt generator may generate a prompt for a second fitness program model. The second fitness program model may generate the second level of the fitness program. The second level of the fitness program may be compiled into the first level of the fitness program, resulting in a completed fitness program. The fitness program generator may transmit the fitness program to a user device.

As discussed herein, the user may implement the fitness program. In some embodiments, the user device may collect information related to the implementation of the fitness program. In some embodiments, based on the information associated with implementation of the fitness program, the fitness program generator may generate an updated fitness program. For example, the user device may request a new fitness program from the second prompt generator. In some examples, the user device may transmit the updated or additional exercise information to the exercise information storage. Based on the updated or additional exercise information, the first prompt generator may generate a new or updated first prompt, the first fitness program model may generate a new or updated first level of the fitness program, the second prompt generator may generate a new or updated second prompt, the second fitness program model may generate a new or updated second level of the fitness program, and the levels of the fitness program may be compiled to form a new completed fitness program. In this manner, the fitness program may be updated based on completion information from the user device.

A user story generator may include user exercise information. As discussed herein, the user exercise information may include any type of user information. For example, the user exercise information may include a user's workout history. The workout history may include completion information for the user. For example, the workout history may include a record of exercise programs completed and/or exercise programs started but not completed, dates of completed and/or uncompleted exercise programs, time of day of completed and/or uncompleted exercise programs, any other exercise program information, and combinations thereof. In some examples, the workout history may include physiological information for the user that is associated with the exercise program. Such physiological information may include heartrate information, VO2 max information, breathing information, calories burned, any other physiological information, and combinations thereof. In some examples, the workout history may include a record of the operating parameters of the exercise device, difficulty settings, manual changes to the exercise program, speed information, pace information, any other operating parameters, and combinations thereof.

The user exercise information may include communication information for the user. For example, the user exercise information may include user chat history. The user chat history may include a record of exercise questions asked and associated interactions with an exercise system. For example, an exercise system may include one or chatbots, question and answer services, trainer interactions, frequently asked questions (FAQs), publications, and so forth. The user's interactions with these informational elements, including access to information, questions asked, answers received, information posted, and so forth, may form the user chat history.

The user exercise information may further include user goals. The user goals may include any goal for the user. For example, the user goals may include explicitly stated user goals. For example, the user may input the user goals into an input field of an application and/or provide the user goals in response to a prompt or from a chatbot or other user system interaction. The user goals may include any type of goal. For example, the user goals may include event-based goals (e.g., participate in a particular event), fitness goals (e.g., weight lifted, speed, pace, distance), health goals, weight loss goals, weight gain goals, body image goals (e.g., waist size, muscle mass), any other user goal, and combinations thereof. In some embodiments, the user goals may include goals related to the completion of a fitness program. For example, the user may input user goals that relate to a particular fitness program he or she would like to complete.

As discussed herein, the user exercise information may include structured data and unstructured data. The structured data may be data that is organized and/or quantitative data. Organized data has definable attributes for all values. Structured data may have relationships between datapoints. The user exercise information may further include unstructured data. Unstructured data may include unorganized or qualitative data. Unstructured data may include facts or other elements that may be organized in a structured data file, but the facts may not be organized as in structured data. Unstructured data may include text, videos, reports, email, images, or other unstructured data. Foundation models are often trained in text analysis, and therefore are trained on unstructured data. Based on the training on text analysis, foundation models may not be optimized to analyze structured data.

The user story generator may utilize the user exercise information to generate a natural language story for the user. The natural language story may be a natural language representation of the user exercise information. Generating a natural language description of the story of the user may increase the accuracy and/or representation of foundation model analysis of a user. For example, many of the foundation models discussed herein may utilize user information to generate outputs. Foundation models are trained and optimized to process text-based information. Preparing a natural language summary of the user may provide the foundation models with text-based information for analysis and processing. In this manner, the foundation models may produce results that are more accurate and/or more relevant based on the user input.

The user story generator may generate the natural language story to incorporate structured and unstructured data. For example, the natural language story may include a natural language description of structured data. As a specific, non-limiting example, the natural language story may include a description of user heart rate (e.g., structured data) over the course of an exercise program. Other examples of structured data may include at least one of exercise frequency, exercise intensity, exercise duration, user heartrate, user VO2 max, user biometric data, completed exercise programs, uncompleted exercise programs, demographic information, age, weight, height, gender, neighborhood, employment, or household income. The natural language description may describe the user heart rate using natural language, such as “the user's heart rate was in zone 3 for over half of the exercise program.” In some embodiments, the natural language description may summarize structured data. In some embodiments, the natural language description may describe structured data.

In some embodiments, the natural language description may include unstructured data, including data that was originally unstructured in the user exercise information. In some embodiments, unstructured data may include at least one of user goals, user updates, user questions, healthcare provider notes, or fitness level.

To generate the natural language story, a story prompt generator may generate a story prompt. The story prompt may request a natural language story based on the user exercise information. The story prompt may be input into a story LLM. The story LLM may receive the prompt and, based on the user exercise information generate the natural language user story. In some embodiments, the natural language story may be vectorized to provide vector elements for searching.

A recommendation model may receive the natural language story and prepare recommendations based on the natural language story. For example, the recommendation model may prepare exercise recommendations based on the information in the natural language story. As discussed herein, the recommendation model may be trained or optimized in language processing. As a specific, non-limiting example, the recommendation model may identify the vectorized elements from the natural language story. The recommendation model may then search for the vectorized elements in a vector database including vectorized descriptions of exercise programs. This may result in an exercise program that is more representative of the user's interests and/or goals.

In accordance with at least one embodiment of the present disclosure, the user story generator may receive additional user exercise information. The additional user exercise information may include updates to the user exercise information discussed herein. In some embodiments, the additional user exercise information may include new user exercise information not previously collected. In some embodiments, the additional user exercise information may include user feedback. The user feedback may be based on presenting the natural language story to the user. For example, the user may read the natural language story and provide the user feedback based on new information, inaccuracies, clarifications, or other information the user would like added or changed to the natural language story. In some embodiments, based on the additional user exercise information, the story prompt generator may generate an updated story prompt. The updated story prompt may be applied to the story LLM to generate an updated natural language story. This cycle or loop may be repeated any number of times.

A user story generator may generate a user story for user exercise information. A story prompt generator may receive the user exercise information and generate a story prompt. The story prompt may be input to a story LLM. The story LLM may generate the natural language story based on the story prompt and the user exercise information.

A recommendation model may receive the natural language story to prepare an exercise recommendation. As discussed herein, the recommendation model may be trained in natural language processing, resulting in improved analysis of the natural language story. The recommendation model may further receive natural language descriptions of exercise programs. In some embodiments, at least a portion of the natural language descriptions of the exercise programs may be stored or vectorized and stored in a text embedding database. The recommendation model may reference the exercise programs and search the database based on the natural language story to generate an exercise program recommendation. As discussed herein, the resulting exercise program recommendation may be more representative of the user exercise information.

A fitness agent router may include user exercise information. As discussed in further detail herein, the user exercise information may include any exercise information, including a workout history, a user chat history, and user goals.

The fitness agent router may include or be in communication with a plurality of different foundation models or exercise agents. The exercise agents may be agents of a foundation model or LLM that are trained or fine-tuned based on a particular focus or task, as discussed in further detail herein. Each of the exercise agents may include a model description. The model description may be a description of which aspect the agent is specialized in or fine-tuned for. In some embodiments, the model description may be man-made. For example, a human operator may prepare and input the model description for the exercise agent. In some examples, the model description may be prepared by a natural language summary agent or LLM, as discussed herein. The exercise agent may include a vector embeddings database. The vector embeddings may be vector representations of the focus or fine-tuned aspect of the exercise agent. In some embodiments, the exercise agent may include a description of the outputs of the agent. For example, the exercise agents may include a description of the output, a sample of the output, or any other aspect or portion of the output.

The fitness agent router may include a selection engine. The selection engine may receive a request for an output from an agent of an LLM. The selection engine may search the exercise agents for a relevant agent. As a specific, non-limiting example, the selection engine may perform a vector similarity search. The vector similarity search may search the vector embeddings of the exercise agents for similarities to the desired results. The selection engine may select a best match from the vector similarity search. In some embodiments, the selection engine may select a plurality of agents based on the vector similarity search. In some embodiments, the selection engine may provide the agent selections to the user and allow the user to select the desired agent.

In some embodiments, the vector embeddings may be generated by the fitness agent router. For example, the fitness agent router may include a vectorization engine. The vectorization engine may vectorize, or generate text representations of the text, from the model description and/or the output. The vectorization engine may then store the resulting vector embeddings in a vector space. The vector space may include vectorized information for each of the exercise agents.

In some embodiments, the vector similarity search may receive the vectorized input from the vectorization engine. The vector similarity search may search the vector space, including the vectorized representations of the exercise agents, for a closest match to the vectorized input. For example, the vector similarity search may search the vector space for which vectorized representations are closest to the vectorized input. Finding the closest match from the vectorized representations may facilitate improved accuracy and/or representation of the exercise agents associated with the closest match vectorized representations.

The vector similarity search may and select the exercise agent based on the closest match and provide the user input to the selected exercise agent. In some embodiments, the vector similarity search may identify a plurality of closest matches. In some embodiments, the plurality of closest matches may all have the same search score. In some embodiments, the plurality of closest matches may have a search score that is within a search threshold.

In some embodiments, each of the exercise agents associated with the plurality of closest matches may be applied to the input. In some embodiments, the fitness agent router may present the plurality of exercise agents associated with the closest matches to the user. The user may provide a user selection of a selected exercise agent from the present exercise agents. The fitness agent router may then provide the input to the selected exercise agent.

In some embodiments, when the vector similarity search receives a request for an exercise agent, the vectorization engine may vectorize the request and any associated user exercise information into a vectorized input.

The fitness agent router may facilitate the selection of an agent that is trained or fine-tuned to prepare the best response based on the user input. This may help to improve the accuracy and/or relevance of the provided outputs and recommendations.

An agent router may receive exercise information and a user request. The exercise information may be exercise information that is relevant to the requested outcome from the LLM, based on the user request. As discussed herein, the user request may include a request submitted directly by a user and/or may include requests submitted by other systems that may request an output from an agent of an LLM.

The agent router may select one or more of a plurality of LLM agents. The exercise agents may be fine-tuned based on an aspect to produce a particular result or outcome. For example, in the embodiment shown, a first exercise agent may be fine-tuned based on a first aspect to generate a first result, a second exercise agent may be fine-tuned based on a second aspect to generate a second result, and a third exercise agent may be fine-tuned based on a third aspect to generate a third result. While three exercise agents are described herein, it should be understood that they may identify and select an agent from any number of agents, including 2, 3, 4, 5, 6, 7, 8, 9, 10, 15, 20, 30, 40, 50, 100, 200, 500, 1,000, 5,000, or any number therebetween.

The agent router may select one of the exercise agents, resulting in a selected agent. When the agent router selects the selected agent, the agent router may forward a prompt and/or the exercise information and the user request to the selected agent. In this manner, the selected agent may generate an output that is more accurate and/or more relevant to the user's request.

An emotional response agent may receive user input, identify emotional content and/or sentiment in the user input, and provide an output that is emotionally responsive to the user's input emotions. In this manner, the emotional response agent may generate improved accuracy and/or responsiveness to the user's input.

The user may enter an input to an input device. The input may be any type of input. For example, the input may include text input, video input, image input, exercise information, any other type of input, and combinations thereof. In some embodiments, the input device may include any type of input device, such as a user device (e.g., a mobile device, computing device), a wearable device, an exercise device, any other input device, and combinations thereof.

In some embodiments, the user may enter the input to a user interaction engine. The user interaction engine may interact with the user. For example, the user interaction engine may include a chatbot that may engage in a natural language conversation with the user. The user may input text input and the user interaction engine may provide an output in the chatbot. The text input may include any type of text input, including written words, emojis, sentences, paragraphs, images, gifs, videos, speech-to-text text input, any other text input, and combinations thereof.

A sentiment analysis engine may analyze the text input and identify emotional content in the text input. The emotional content may include an input emotion. The sentiment analysis engine may include any system to identify the emotional content or sentiment of the text input. For example, the sentiment analysis engine may identify the emotional content and/or the input emotion using an emotional trigger. The emotional trigger may include any emotional trigger, such as a word, an emoji, an image, a word combination, a user picture, a user video, user dialog, any other emotional trigger, and combinations thereof. In some embodiments, the sentiment analysis engine may include a foundation model trained in emotional content recognition. In some embodiments, the sentiment analysis engine may vectorize the text input to a vectorized text input and identify the emotional content based on the vectorized text input.

The sentiment analysis engine may provide the emotional content, including the input emotion, to an emotional response LLM. The emotional response LLM analyze the text input, the emotional content, and the input emotion, and generate an exercise recommendation based on the emotional content and the input emotion.

In some embodiments, the emotional response LLM may receive and/or retrieve context information to prepare the exercise recommendation. The context information may include any context information. For example, the context information may include user exercise information. As discussed in further detail herein, the user exercise information may include any type of user exercise information, include user workout history, user chat history, user preference information, any other user information, and combinations thereof. Receiving context information at the emotional response LLM may facilitate more accurate and/or more representative exercise recommendations tailored to the user by the emotional response LLM.

In some embodiments, the emotional response LLM may reference exercise activities for the exercise recommendation. The exercise activities may include exercise activity information. For example, the exercise activities may include an emotional impact of the exercise activity. The emotional impact may be based on any information. For example, the emotional impact may be based on content of the exercise activities. The content of the exercise activities may be any type of content, including exercise type, exercise intensity, trainer identify, exercise program transcript, any other content, and combinations thereof. In some embodiments, the emotional impact may be at least partially based on user reviews of the exercise activities. In some embodiments, the emotional impact may be based on the language from other users from the user reviews. For example, emotional impact of the user reviews may be based on how users reported the exercise program made them feel.

The emotional response LLM may identify complementary emotions for the exercise activity. The exercise recommendation may be selected based on the complementary emotions. For example, the exercise recommendation may be selected to incorporate an output emotion that is complementary to the identified input emotion. The output emotion may be the emotion that is induced by the exercise activity in the exercise recommendation. In some embodiments, the output emotion may be identified based on the emotions that people typically experience and/or the emotions that are intentionally induced in the exercise activities.

The emotional response LLM may provide the exercise recommendation having the output emotion that is complementary to the input emotion. In some embodiments, the output emotion may be responsive to the input emotion. For example, if the sentiment analysis engine identifies the input emotion as sad or depressed, the output emotion may be uplifting, happy, or upbeat. In some examples, if the sentiment analysis engine identifies the input emotion as unmotivated, the output emotion may be motivating. In some examples, if the sentiment analysis engine identifies the input emotion as angry, the output emotion may be energetic. In some embodiments, the output emotion may be an emotion inducing activity. For example, the emotion inducing activity include a topic of conversation by the trainer in the exercise activity.

While specific complementary emotions have been discussed herein, it should be understood that any output emotion or emotion inducing activity may be paired with any input emotion. For example, different users may have different emotional reactions to different content, desire different emotional pairings, or have otherwise different emotional experiences. Using the context gained from the user exercise information, the emotional response LLM may identify complementary emotions that are tailored to the user.

In an emotional response system, a user may enter, into a user interface, user input and exercise information. As discussed herein, the user input may include text input. A sentiment analysis engine may identify emotional content, including an input emotion, in the text input.

An emotional response LLM may receive the text input and the input emotion and prepare an emotional response based on the user input. The emotional response may include a complementary emotion to the input emotion. The emotional response may be based on one or more exercise activities. In some embodiments, the emotional response may be based on pre-determined emotional pairings. The pre-determined emotional pairings may include complementary emotions and/or complementary emotional responses. Using the emotional response, the emotional response LLM may generate the exercise recommendation to send to the user, with the exercise recommendation including and/or inducing the emotional response in the user.

Described herein are a number of different methods, systems, devices, and computer-readable media of the systems discussed herein. The methods described herein may be performed with more or fewer acts. Further, the acts may be performed in differing orders. Additionally, the acts described herein may be repeated or performed in parallel with one another or parallel with different instances of the same or similar acts.

A foundation model may receive an exercise program. The exercise program may include a control layer including a plurality of exercise device controls configured to adjust at least one operating parameter of an exercise device. The foundation model may prepare text descriptions of the plurality of exercise device controls. The foundation model may generate a prompt to prepare a natural language description of the exercise program based on the text descriptions. The foundation model may input the prompt into an exercise summary LLM to prepare a natural language summary of the exercise program. As discussed in further detail herein, generating the natural language summaries of the exercise programs may facilitate the vectorization of the natural language summary to improve searchability and applicability of the exercise programs by other large language models.

A prompt generator may generate an exercise recommendation prompt based on exercise information for a user. The exercise recommendation prompt may be provided as an input to a recommendation LLM to generate an exercise recommendation. A prompt generator may generate a user preference prompt based on user preference information for the user. The user preference prompt may be proved as an input to a user preference LLM to generate a user preference profile. A reward model may generate a reward for the user based on the user preference profile and the exercise recommendation. As discussed herein, this may improve the engagement of the user in exercise programs.

An exercise information system may receive exercise information. The exercise information may include text information related to an exercise activity. A text separation engine may generate a plurality of text information sets from the text information. A detextualization model may be applied to the text information sets. The detextualization model may generate a plurality of question-and-answer pairs associated with the exercise information. A training manager may train the exercise model by inputting the plurality of question-and-answer pairs into the exercise model. This fine-tuning of the exercise model may increase the accuracy and/or relevance of the exercise model.

A fitness program generator may retrieve exercise information for a user. Based on a user goal and the fitness information, a first prompt generator may generate a first prompt for a first fitness program. The first prompt may be input to the first fitness program model to generate a first level of the fitness program. The first level covers a first period of time. Based on the user goal, the exercise information, and the first level of the fitness program, a second prompt generator may generate a second prompt for a second fitness program model. The prompt generator may input the second prompt to the second fitness program model to generate a second level of the fitness program. The second level may cover a second period of time. The second period of time may at least partially overlap the first period of time. The resulting fitness program may be customized to the user and the user's goals.

A prompt generator may generate a story prompt based on user exercise information for a user. The user exercise information may include structured and unstructured data. The prompt generator may provide the story prompt as input to a story LLM. The story LLM may generate a natural language story. The natural language story includes the structured and unstructured data. A second prompt generator may generate a recommendation prompt based on the natural language story. The second prompt generator may provide the recommendation prompt as input to a recommendation model to generate an exercise recommendation.

An agent router may receive an input for an exercise recommendation. The agent router may vectorize the input to a vectorized input. The agent router may search a vector space including vectorized representations of a plurality of agents for a closest match to the vectorized input. The agent router may select an exercise agent based on the closest match. The agent router may provide the input to the selected exercise agent to generate the exercise recommendation.

An emotional response agent may receive a text input from a user. The text input is related to exercise information for the user. The emotional response agent may identify emotional content in the text input. The emotional content includes an input emotion. The emotional response agent may generate an emotional response to the emotional content and the exercise input. The emotional response is based on complementary emotions of the input emotion and an output emotion. The output emotion is based on exercise information for the user. The emotional response agent may present the emotional response to the user.

One or more computer systems may be used to implement the various devices, components, and systems described herein.

The computer system includes a processor. The processor may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor may be referred to as a central processing unit (CPU). Although just a single processor is described herein, in an alternative configuration, a combination of processors (e.g., an ARM and DSP) could be used.

The computer system also includes memory in electronic communication with the processor. The memory may be any electronic component capable of storing electronic information. For example, the memory may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions and data may be stored in the memory. The instructions may be executable by the processor to implement some or all of the functionality disclosed herein. Executing the instructions may involve the use of the data that is stored in the memory. Any of the various examples of modules and components described herein may be implemented, partially or wholly, as instructions stored in memory and executed by one or more processors. Any of the various examples of data described herein may be among the data that is stored in memory and used during execution of the instructions by the one or more processors.

A computer system may also include one or more communication interfaces for communicating with other electronic devices. The communication interface(s) may be based on wired communication technology, wireless communication technology, or both. Some examples of communication interfaces include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system may also include one or more input devices and one or more output devices. Some examples of input devices include a keyboard, mouse, microphone, remote control device, button, joystick, trackball, touchpad, and lightpen. Some examples of output devices include a speaker and a printer. One specific type of output device that is typically included in a computer system is a display device. Display devices used with embodiments disclosed herein may utilize any suitable image projection technology, such as liquid crystal display (LCD), light-emitting diode (LED), gas plasma, electroluminescence, or the like. A display controller may also be provided, for converting data stored in the memory into text, graphics, and/or moving images (as appropriate) shown on the display device.

The various components of the computer system may be coupled together by one or more buses, which may include a power bus, a control signal bus, a status signal bus, a data bus, etc. For the sake of clarity, the various buses are described herein as a bus system.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

Implementation examples are described in the following numbered aspects:

1. A method, comprising:
receiving an exercise program, the exercise program including a control layer including a plurality of exercise device controls configured to adjust at least one operating parameter of an exercise device;
preparing text descriptions of the plurality of exercise device controls;
generating a prompt to prepare a natural language description of the exercise program based on the text descriptions; and
inputting the prompt into an exercise summary large language model (LLM) to prepare a natural language summary of the exercise program.

2. The method of aspect 1, further comprising extracting workout metadata from the exercise program, and wherein generating the prompt includes generating the prompt based on the workout metadata and the text descriptions.

3. The method of aspect 2, wherein the workout metadata includes at least one of exercise type, exercise device type, simulated location, simulated event, trainer identification, exercise program duration, or exercise program intensity.

4. The method of any of aspects 1-3, further comprising vectorizing the natural language summary of the exercise program.

5. The method of any of aspects 1-4, wherein the natural language summary includes a qualitative description of the exercise program.

6. The method of aspect 5, wherein the qualitative description of the exercise program includes a description over multiple text descriptions of the plurality of exercise device controls.

7. The method of any of aspects 5 or 6, wherein the qualitative description includes a difficulty description.

8. The method of any of aspects 5-7, wherein the qualitative description includes a scenic description.

9. The method of any of aspects 5-8, wherein the qualitative description includes a summary of user ratings.

10. The method of any of aspects 5-9, wherein the qualitative description includes a summary of user reviews.

11. The method of any of aspects 5-10, wherein the qualitative description includes a trainer attitude.

12. The method of any of aspects 1-11, wherein the text descriptions are based on a pre-determined template.

13. The method of aspect 12, wherein the pre-determined template includes a time component and a control component.

14. A method for generating exercise rewards, the method comprising:
generating an exercise recommendation prompt based on exercise information for a user; providing the exercise recommendation prompt as an input to a recommendation large
language model (LLM) to generate an exercise recommendation;
generating a user preference prompt based on user preference information for the user; providing the user preference prompt as an input to a user preference LLM to generate a
user preference profile; and
generating a reward for the user based on the user preference profile and the exercise recommendation.

15. The method of aspect 14, wherein generating the reward is at least partially based on completion of the exercise recommendation.

16. The method of any of aspects 14 or 15, wherein the reward is a customized reward unique to the user.

17. The method of any of aspects 14-16, wherein generating the reward includes applying a reward model to the user preference profile and the exercise information.

18. The method of aspect 17, wherein the reward model includes a direct program optimization (DPO) model.

19. The method of any of aspects 17 or 18, wherein the reward model includes a reinforcement learning from human feedback (RLHF) model.

20. The method of any of aspects 17-19, wherein the reward model is trained on historical user preference information for a plurality of users.

21. The method of any of aspects 14-20, wherein the reward is a first reward, and further comprising:
generating an updated user preference prompt based on updated user preference information, the updated user preference information based at least in part on exercise program performed by the user;
providing the updated user preference prompt to the user preference LLM to generate an updated user preference profile; and
generating a second reward for the user based on the updated user preference profile, the second reward different from the first reward.

22. The method of aspect 21, wherein the first reward and the second reward are unique to the user.

23. The method of any of aspects 14-22, further comprising, based on the user preference profile and the exercise recommendation, generating an incentive for a future reward, the incentive including a goal and the future reward associated with achieving the goal.

24. The method of any of aspects 14-23, wherein the user preference information includes text information.

25. The method of any of aspects 14-24, wherein the user preference profile includes demographic information for the user.

26. The method of any of aspects 14-25, wherein the user preference profile includes a historical record of completed and uncompleted exercise programs.

27. The method of aspect 26, wherein the historical record of completed and uncompleted exercise programs includes a count of each implementation of the completed and uncompleted exercise programs.

28. The method of any of aspects 14-27, wherein the user preference profile includes correlations between exercise program ratings and exercise program features.

29. The method of any of aspects 14-28, wherein the user preference profile includes correlations between completed exercise programs and exercise program features.

30. The method of any of aspects 14-29, wherein the user preference profile includes media content preferences for the user.

31. The method of any of aspects 14-30, wherein the user preference profile includes entertainment information for the user.

32. The method of any of aspects 14-31, wherein the exercise recommendation includes an exercise program.

33. The method of any of aspect 32, wherein the user preference information includes completion information for the exercise program.

34. The method of aspect 33, wherein the reward is based on the completion information for the exercise program.

35. The method of any of aspects 14-34, wherein the user preference information includes at least one of workout frequency, workout duration, workout intensity, or workout variety.

36. The method of any of aspects 14-35, wherein the user preference information includes rating information for historical exercise programs.

37. The method of aspect 36, wherein the rating information is organized based on exercise program parameters of the historical exercise programs.

38. The method of aspect 37, wherein the exercise program parameters include at least one of exercise device type, trainer identity, visual information, audio information, exercise program length, or exercise program intensity.

39. The method of any of aspects 14-38, wherein generating the reward for the user includes generating at least one of an achievement, virtual currency, a skin for a virtual avatar, a shopping discount, a customized image, or a customized video.

40. A method for training an exercise model, the method comprising:
receiving exercise information, the exercise information including text information related to an exercise activity;
generating a plurality of text information sets from the text information;
applying a detextualization model to the plurality of text information sets, the detextualization model generating a plurality of question-and-answer pairs associated with the exercise information; and
training the exercise model by inputting the plurality of question-and-answer pairs into the exercise model.

41. The method of aspect 40, wherein generating the plurality of text information sets includes generating the plurality of text information sets based on content within the text information.

42. The method of any of aspects 40 or 41, wherein the detextualization model includes a large language model (LLM).

43. The method of aspect 42, further comprising generating a prompt instructing the detextualization model to generate the plurality of question-and-answer pairs.

44. The method of aspect 43, wherein the prompt includes instructions to generate a question quantity of the plurality of question-and-answer pairs.

45. The method of aspect 44, wherein the question quantity is based on a length of a text information set of the plurality of text information sets.

46. The method of any of aspects 40-45, wherein the exercise model includes a large language model (LLM).

47. The method of any of aspects 40-46, wherein separating the text information includes separating the text information with a recursive model.

48. The method of any of aspects 40-47, wherein each of the plurality of text information sets has a length that is approximately the same.

49. The method of any of aspects 40-48, wherein separating the text information includes separating the text information based on length.

50. The method of any of aspects 40-49, wherein separating the text information includes separating the text information based on content.

51. The method of any of aspects 40-50, wherein plurality of question-and-answer pairs are generated in natural language.

52. The method of any of aspects 40-51, wherein the text information includes instruction information on how to perform the exercise activity.

53. The method of any of aspects 40-52, wherein the text information includes user input related to the exercise activity.

54. The method of any of aspects 40-53, wherein each question-and-answer pair of the plurality of question-and-answer pairs is related to a different subject.

55. The method of any of aspects 40-54, wherein at least two of the plurality of question-and-answer pairs are related to the same subject.

56. The method of any of aspects 40-55, wherein a question-and-answer pair of the plurality of question-and-answer pairs includes different language than the text information.

57. The method of aspect 56, wherein the different language includes a synonym of a technical term in the text information.

58. The method of any of aspects 56 or 57, wherein the different language includes a different grammatical form.

59. The method of any of aspects 40-58, wherein the detextualization model generates the plurality of question-and-answer pairs for a text information set of the plurality of text information sets.

60. The method of any of aspects 40-59, wherein the detextualization model generates the plurality of question-and-answer pairs using only information in the plurality of text information sets.

61. The method of any of aspects 40-60, wherein the detextualization model generates the plurality of question-and-answer pairs using context from the plurality of text information sets.

62. The method of any of aspects 40-61, wherein the detextualization model generates the plurality of question-and-answer pairs using context from third-party exercise information.

63. A method for generating a fitness program, the method comprising: retrieving exercise information for a user;
based on a user goal and the exercise information, generating a first prompt for a first fitness program model;
inputting the first prompt to the first fitness program model to generate a first level of the fitness program, the first level covering a first period of time;
based on the user goal, the exercise information, and the first level of the fitness program, generating a second prompt for a second fitness program model; and
inputting the second prompt to the second fitness program model to generate a second level of the fitness program, the second level covering a second period of time, the second period of time at least partially overlapping the first period of time.

64. The method of aspect 63, wherein retrieving the exercise information includes retrieving the exercise information based at least in part on a user goal for a user.

65. The method of any of aspects 63 or 64, wherein the second period of time is shorter than the first period of time.

66. The method of any of aspects 63-65, wherein the second period of time is encompassed by the first period of time.

67. The method of any of aspects 63-66, wherein second level of the fitness program includes a higher level of granularity than the first level of the fitness program.

68. The method of any of aspects 63-67, wherein the first level of the fitness program includes a weekly schedule.

69. The method of aspect 68, wherein the second level of the fitness program includes an exercise program for a day in the weekly schedule.

70. The method of aspect 69, wherein the exercise program includes a plurality of exercise programs, each exercise program of the plurality of exercise programs associated with a different day in the weekly schedule.

71. The method of aspect 70, wherein at least two of the plurality of exercise programs are different from each other.

72. The method of any of aspects 69-71, wherein the second fitness program model includes a plurality of second fitness program models, each second fitness program model of the plurality of second fitness program models generating an exercise program associated with a different exercise type.

73. The method of any of aspects 68-72, wherein the weekly schedule includes an outline of exercise activities for each day in the weekly schedule.

74. The method of any of aspects 63-73, wherein the second level of the fitness program includes an exercise program.

75. The method of any of aspects 63-74, further comprising:
based on the user goal and the exercise information, generating a third prompt for a third fitness program model; and
inputting the third prompt to the third fitness program model to generate a third level of the fitness program, the third level covering a third period of time, the first period of time and the second period of time at least partially overlapping the third period of time.

76. The method of aspect 75, wherein the third period of time is greater than the first period of time and the second period of time.

77. The method of any of aspects 75 or 76, wherein the first period of time and the second period of time are encompassed by the third period of time.

78. The method of any of aspects 75-77, wherein the first level and the second level of the fitness program include a higher level of granularity than the third level of the fitness program.

79. The method of any of aspects 75-78, wherein the third period is a training period to reach the user goal, and wherein the third level includes an outline of exercise goals for a training period, the first level includes a plurality of weekly schedules within the training period, and the second level includes a plurality of daily exercise programs for each day each weekly schedule of the plurality of weekly schedules.

80. The method of aspect 79, wherein at least two of the plurality of weekly schedules are different from each other.

81. The method of any of aspects 63-80, wherein the first fitness program model and the second fitness program model are trained on different datasets.

82. The method of aspect 81, wherein the different datasets include at least some overlapping material.

83. The method of any of aspects 63-82, wherein the first prompt includes unstructured data.

84. The method of aspect 83, wherein the first prompt includes a combination of structured data and the unstructured data.

85. The method of any of aspects 63-84, wherein the second prompt includes unstructured data.

86. The method of aspect 85, wherein the second prompt includes a combination of structured data and the unstructured data.

87. The method of any of aspects 63-86, wherein the exercise information includes unstructured data.

88. The method of aspect 87, wherein the exercise information includes a combination of structured data and the unstructured data.

89. The method of any of aspects 63-88, further comprising retrieving additional exercise information for the user, and wherein generating the second prompt includes generating the second prompt based at least in part on the additional exercise information.

90. The method of any of aspects 63-89, further comprising: receiving additional exercise information;
based on the user goal and the additional exercise information, generating an updated first prompt for the first fitness program model;
inputting the updated first prompt to the first fitness program model to generate an updated first level of the fitness program;
based on the user goal, the additional exercise information, and the updated first level of the fitness program, generating an updated second prompt for the second fitness program model; and
inputting the updated second prompt to the second fitness program model to generate an updated second level of the fitness program.

91. The method of aspect 90, wherein receiving the additional exercise information includes receiving the additional exercise information during the first period.

92. The method of aspect 91, wherein receiving the additional exercise information includes receiving the additional exercise information during the first period and the second period.

93. The method of any of aspects 63-92, wherein the exercise information includes at least one of user profile information, demographic information, physical information, chat history, workout history, fitness assessment information, or goal information.

94. A method, comprising:
generating a story prompt based on user exercise information for a user, the user exercise information including structured data and unstructured data;
providing the story prompt as input to a story large language model (LLM), the story LLM generating a natural language story, the natural language story including the structured data and the unstructured data;
generating a recommendation prompt based on the natural language story; and
providing the recommendation prompt as input to a recommendation model to generate an exercise recommendation.

95. The method of aspect 94, wherein the user exercise information includes a workout history.

96. The method of aspect 95, wherein the structured data includes at least a portion of the workout history.

97. The method of aspect 96, wherein the structured data includes at least one of exercise frequency, exercise intensity, exercise duration, user heartrate, user VO2 max, user biometric data, completed exercise programs, uncompleted exercise programs, demographic information, age, weight, height, gender, neighborhood, employment, or household income.

98. The method of any of aspects 95-97, wherein the unstructured data includes at least a portion of the exercise information.

99. The method of aspect 98, wherein the unstructured data includes user goals, user updates, user questions, healthcare provider notes, or fitness level.

100. The method of any of aspects 94-99, wherein the natural language story includes a natural language summary of the structured data and the unstructured data.

101. The method of any of aspects 94-100, wherein the exercise recommendation includes an exercise program recommendation.

102. The method of any of aspects 94-101, wherein the exercise recommendation includes a fitness program recommendation, the fitness program recommendation including a plurality of exercise programs to be implemented over a time period.

103. The method of any of aspects 94-102, wherein the exercise recommendation includes a motivational recommendation for the user.

104. The method of aspect 103, wherein the motivational recommendation includes a motivational message.

105. The method of any of aspects 103-105, wherein the motivational recommendation includes an exercise program type.

106. The method of any of aspects 103-105, wherein the motivational recommendation includes a fitness goal for the user.

107. The method of any of aspects 94-106, wherein the exercise recommendation includes a diet and nutrition recommendation.

108. The method of any of aspects 94-107, further comprising:
generating an updated story prompt based on additional user exercise information; and applying the updated story prompt to the story LLM to generate and updated natural
language story.

109. The method of aspect 108, wherein the additional user exercise information includes user feedback.

110. The method of aspect 109, further comprising presenting the natural language story to the user, and wherein the user feedback is received based on presenting the natural language story to the user.

111. A method for generating an exercise recommendation, the method comprising:
receiving an input for the exercise recommendation; vectorizing the input to a vectorized input;
searching a vector space including vectorized representations of a plurality of exercise agents for a closest match to the vectorized input;
selecting an exercise agent based on the closest match; and
providing the input to the exercise agent to generate the exercise recommendation.

112. The method of aspect 111, wherein receiving the input includes receiving a user input.

113. The method of aspect 112, wherein receiving the user input includes receiving a user request for the exercise recommendation.

114. The method of any of aspects 112 or 113, wherein receiving the user input includes receiving the user input from a chatbot.

115. The method of any of aspects 111-114, wherein receiving the input includes receiving the input based on an exercise activity.

116. The method of aspect 115, wherein receiving the input includes receiving the input based on a user missing the exercise activity.

117. The method of any of aspects 115 or 116, wherein receiving the input includes receiving the input based on a user rating of the exercise activity.

118. The method of any of aspects 115-117, wherein receiving the input includes receiving the input from a fitness program model.

119. The method of aspect 118, wherein receiving the input from the fitness program model includes receiving the input to recommend an exercise program for a portion of a fitness program.

120. The method of any of aspects 111-119, wherein the closest match includes a plurality of closest matches associated with a plurality of exercise agents.

121. The method of aspect 120, wherein providing the input to the exercise agent includes providing the input to the plurality of exercise agents.

122. The method of any of aspects 120 or 121, further comprising: providing the plurality of exercise agents to a user; and
receiving a user selection of a selected exercise agent from the plurality of agents, and wherein providing the input to the exercise agent includes providing the input to the selected exercise agent.

123. A method, comprising:
receiving a text input from a user, the text input related to exercise information of the user; identifying emotional content in the text input, the emotional content including an input
emotion;
generating an emotional response to the emotional content and the exercise information, the emotional response based on complementary emotions of the input emotion and an output emotion, the output emotion based on the exercise information for the user; and
presenting the emotional response to the user.

124. The method of aspect 123, wherein generating the emotional response includes generating an exercise recommendation including an exercise activity.

125. The method of aspect 124, wherein the exercise activity is configured to, when implemented by the user, induce the output emotion in the user.

126. The method of any of aspects 124 or 125, wherein generating the exercise recommendation includes generating the exercise recommendation based on a content of the exercise activity.

127. The method of aspect 126, wherein the content of the exercise activity includes an exercise type.

128. The method of any of aspects 126 or 127, wherein the content of the exercise activity includes an exercise intensity.

129. The method of any of aspects 126-128, wherein the content of the exercise activity includes a trainer identity.

130. The method of any of aspects 126-129, wherein the content of the exercise activity includes a transcript of the exercise activity.

131. The method of any of aspects 123-130, wherein the output emotion is based on user reviews.

132. The method of aspect 131, wherein the output emotion is based on language from the user reviews.

133. The method of any of aspects 124-132, wherein the output emotion is based on a transcript of dialog from the exercise activity.

134. The method of any of aspects 123-133, wherein identifying the emotional content includes identifying one or more emotional triggers in the text input.

135. The method of aspect 134, wherein the one or more emotional triggers includes at least one of a word, an emoji, an image, a word combination, a user picture, a user video, or user dialog.

136. The method of any of aspects 134 or 136, wherein identifying the emotional content includes performing a sentiment analysis of the text input.

137. The method of any of aspects 123-136, wherein identifying the emotional content includes vectorizing the text input to a vectorized text input and identifying the emotional content based on the vectorized text input.

138. The method of any of aspects 123-137, wherein receiving the text input includes receiving context information for the user, the context information including the exercise information.

139. The method of aspect 138, wherein the context information includes user preference information.

140. A method having any or each permutation of features recited in aspects 1-139.

141. An assembly/system/device having any or each permutation of features recited in aspects 1-140.

142. A computing system including one or more processors and memory, the memory including instructions that cause the one or more processors to implement, or that include instructions executable by the one or more processors to cause the system or a device to implement, the method of any of aspects 1-140.

143. Any device, apparatus, system, kit, component, or subcomponent as illustrated or described, or method of manufacture or use thereof.

144. Any system, assembly, component, subcomponent, process, element, or portion thereof, as described or illustrated.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving an exercise program, the exercise program including a control layer including a plurality of exercise device controls configured to adjust at least one operating parameter of an exercise device;
preparing text descriptions of the plurality of exercise device controls;
generating a prompt to prepare a natural language description of the exercise program based on the text descriptions; and
inputting the prompt into an exercise summary large language model (LLM) to prepare a natural language summary of the exercise program.

2. The method of claim 1, further comprising extracting workout metadata from the exercise program, and wherein generating the prompt includes generating the prompt based on the workout metadata and the text descriptions.

3. The method of claim 2, wherein the workout metadata includes at least one of exercise type, exercise device type, simulated location, simulated event, trainer identification, exercise program duration, or exercise program intensity.

4. The method of claim 1, further comprising vectorizing the natural language summary of the exercise program.

5. The method of claim 1, wherein the natural language summary includes a qualitative description of the exercise program, and wherein the qualitative description of the exercise program includes at least one of a set including:
a description over multiple text descriptions of the plurality of exercise device controls;
a difficulty description;
a scenic description;
a summary of user ratings;
a summary of user reviews; and
a trainer attitude.

6. The method of claim 1, wherein the text descriptions are based on a pre-determined template, and wherein the pre-determined template includes a time component and a control component.

7. A method for generating exercise rewards, the method comprising:
generating an exercise recommendation prompt based on exercise information for a user;
providing the exercise recommendation prompt as an input to a recommendation large language model (LLM) to generate an exercise recommendation;
generating a user preference prompt based on user preference information for the user;
providing the user preference prompt as an input to a user preference LLM to generate a user preference profile; and
generating a reward for the user based on the user preference profile and the exercise recommendation.

8. The method of claim 7, wherein generating the reward is at least partially based on completion of the exercise recommendation.

9. The method of claim 7, wherein the reward is a customized reward unique to the user.

10. The method of claim 7, wherein generating the reward includes applying a reward model to the user preference profile and the exercise information, and wherein:
the reward model includes a direct program optimization (DPO) model,
the reward model includes a reinforcement learning from human feedback (RLHF) model, or
the reward model is trained on historical user preference information for a plurality of users.

11. The method of claim 7, wherein the reward is a first reward, and further comprising:
generating an updated user preference prompt based on updated user preference information, the updated user preference information based at least in part on exercise program performed by the user;
providing the updated user preference prompt to the user preference LLM to generate an updated user preference profile; and
generating a second reward for the user based on the updated user preference profile, the second reward different from the first reward.

12. The method of claim 7, further comprising, based on the user preference profile and the exercise recommendation, generating an incentive for a future reward, the incentive including a goal and the future reward associated with achieving the goal.

13. The method of claim 7, wherein the exercise recommendation includes an exercise program, wherein the user preference information includes completion information for the exercise program, and wherein the reward is based on the completion information for the exercise program.

14. A method for training an exercise model, the method comprising:
receiving exercise information, the exercise information including text information related to an exercise activity;
generating a plurality of text information sets from the text information;
applying a detextualization model to the plurality of text information sets, the detextualization model generating a plurality of question-and-answer pairs associated with the exercise information; and
training the exercise model by inputting the plurality of question-and-answer pairs into the exercise model.

15. The method of claim 14, wherein generating the plurality of text information sets includes generating the plurality of text information sets based on content within the text information.

16. The method of claim 14, wherein the detextualization model includes a large language model (LLM).

17. The method of claim 14, further comprising generating a prompt instructing the detextualization model to generate the plurality of question-and-answer pairs.

18. The method of claim 17, wherein the prompt includes instructions to generate a question quantity of the plurality of question-and-answer pairs, and wherein the question quantity is based on a length of a text information set of the plurality of text information sets.

19. The method of claim 14, wherein the detextualization model generates the plurality of question-and-answer pairs using only information in the plurality of text information sets.

20. The method of claim 14, wherein the detextualization model generates the plurality of question-and-answer pairs using context from third-party exercise information.
